(19) United States
(12) Patent Application Publication
(10) Pub. No.: US 2025/0271727 A1
(43) Pub. Date: Aug. 28, 2025

(54) NONLINEAR OPTICAL MG-IV-V 2 CRYSTALS, METHODS OF MAKING THE SAME AND DEVICES COMPRISING THE SAME

(71) Applicant: THE PENN STATE RESEARCH FOUNDATION, University Park, PA (US)

(72) Inventors: Jingyang HE, University Park, PA (US); Yingdong GUAN, University Park, PA (US); Yanglin ZHU, University Park, PA (US); Yu WANG, University Park, PA (US); Seng Huat LEE, University Park, PA (US); Zhiqiang MAO, University Park, PA (US); Venkatraman GOPALAN, University Park, PA (US); Yasuyuki IWABUCHI, University Park, PA (US)

(21) Appl. No.: 19/055,988

(22) Filed: Feb. 18, 2025

Related U.S. Application Data
(63) Continuation of application No. PCT/US2023/030434, filed on Aug. 17, 2023.
(60) Provisional application No. 63/398,993, filed on Aug. 18, 2022.
(60) Provisional application No. 63/492,080, filed on Mar. 24, 2023.

(51) Int. Cl. G02F 1/377; C30B 9/12; C30B 13/02; C30B 13/34; C30B 29/10; C30B 29/66; G02F 1/35; G02F 1/355; H01S 3/109

(52) U.S. Cl. CPC G02F 1/3775; C30B 9/12; C30B 13/02; C30B 13/34; C30B 29/10; C30B 29/66; G02F 1/3548; G02F 1/3551; H01S 3/109

(57) ABSTRACT

Disclosed herein is a single nonlinear optical crystal having a chemical formula of Mg—IV—V2, wherein IV is selected from Si, Ge, or Sn, and V is selected from P or As, wherein the single nonlinear optical crystal has a chalcopyrite and non-centrosymmetric crystal structure, with a space group of, wherein the non-centrosymmetric crystal structure is defined by unit cell parameters: a between about 5.5 to about 6 Å, c between about 9.5 to about 12.5 Å, and a unit cell volume of about 287 to about 450 Å³, wherein the single nonlinear optical crystal exhibits a refractive index of about 2.770 to about 2.780 and from about 2.800 to about 2.810 for no and ne respectively at a wavelength of 1,550 nm, and a nonlinear coefficient of d_{eff} of SHG from about 80 to about 95 pm/V, wherein the single crystal Mg—IV—V₂ is substantially free of impurities.

### CROSS-REFERENCE TO THE RELATED APPLICATIONS

This application is a bypass continuation in part of PCT Application No. PCT/US2023/030434, which claims the benefit of U.S. Provisional Application No. 63/398,993, filed Aug. 18, 2022, and U.S. Provisional Application No. 63/492,080, filed Mar. 24, 2023, the contents of which are incorporated herein by reference in their entireties.

### STATEMENT OF GOVERNMENT SUPPORT

This invention was made with government support under Grant Nos. DMR2210933 and DMR2039351, awarded by the National Science Foundation under Grant No. DE-SC0019068, awarded by the Department of Energy and under Grant No. FA9550-19-1-0243 awarded by the U.S. Air Force/AFOSR. The Government has certain rights in the invention.

### TECHNICAL FIELD

This application relates generally to single crystals with nonlinear optical (NLO) properties, including large second-order NLO characteristics, Type I and Type II phase-matchability, and low absorption in a wide infrared spectral range, allowing for the application of the NLO crystals in high-power laser systems.

### BACKGROUND

The 1961 experimental discovery of optical second harmonic generation (SHG) by Franken et al. and the 1965 theory by Bloembergen (Nobel prize in physics, 1981) launched the field of nonlinear optics (NLO). This discovery of the ability to combine and split photons using nonlinear optical interactions has had a dramatic impact on generating a continuously tunable electromagnetic spectrum towards furthering both fundamental sciences as well as technological applications.

Infrared lasers with wide tunability and high efficiency are becoming increasingly vital because of their broad applications for many civilian and military applications, including environmental monitoring, countermeasure, and laser surgery. Nonlinear optical crystals are the essential components of the high-power lasers for frequency conversion through nonlinear optical phenomena such as second harmonic generation (SHG), sum frequency and difference frequency. The traditional NLO materials such as β-BaB₂O₄ (BBO), KH₂PO₄ (KDP) and LiNbO₃ are not suitable for broadband infrared applications because of the relatively low conversion efficiency and infrared absorption beyond 4.5-5 μm wavelength. The current state of art infrared NLO crystals includes AgGaS₂, AgGaSe₂, and ZnGeP₂. Though these crystals exhibit high optical nonlinearity and wide transparency in IR spectral range, their low laser damage threshold (LDT) values or two-phonon absorption limits their applications. Clearly, the development of infrared laser systems demands novel infrared NLO crystals with superior optical properties.

These needs and other needs are at least partially satisfied by the present disclosure.

### SUMMARY

The present disclosure is directed to a single nonlinear optical crystal having a chemical formula of Mg—IV—V₂, wherein IV is selected from Si, Ge, or Sn, and V is selected from P or As, wherein the single nonlinear optical crystal has a chalcopyrite and a non-centrosymmetric crystal structure, with a space group of 14̅2d; wherein the non-centrosymmetric crystal structure is defined by unit cell parameters: a between about 5.5 to about 6 Å, c between about 9.5 to about 12.5 Å, and a unit cell volume of about 287 to about 450 Å³, wherein the single nonlinear optical crystal exhibits a refractive index of about 2.770 to about 2.780 and from about 2.800 to about 2.810 for nₒ and nₑ respectively at a wavelength of 1,550 nm, and a nonlinear coefficient of d_{eff} of SHG from about 80 to about 95 pm/V, wherein the single nonlinear optical crystal Mg—IV—V₂ is substantially free of impurities.

In yet still, further aspects, the nonlinear optical crystal disclosed herein can exhibit a transmittance from about 60% to less than 100% in a wavelength range from about 0.55 μm to about at least 20 μm.

In yet still further aspects, single crystal Mg—IV—V₂ is uniaxial.

Also disclosed herein is a method of forming any of the disclosed herein single nonlinear optical crystals, wherein the method comprises: a) providing a solution comprising a solute comprising a mixture of Mg, IV and V in a molar ratio from about 0.95:0.95:2 to about 1.05:1.05:2 and a solvent; wherein a mass ratio between the solvent and solute is from about 10:1 to about 4:1; b) growing a crystalline composition comprising Mg—IV—V₂ at a first temperature from about 950° C. to about 1,200° C. for a first predetermined time; c) centrifugally separating the solvent to form a single nonlinear optical crystal of Mg—IV—V₂ having a size from about 0.01 mm to about 10 mm in length, wherein the single nonlinear optical crystal is substantially free of a solvent residue.

In yet still further aspects, disclosed herein is a method of forming any of the disclosed herein single nonlinear optical crystals, wherein the method comprises: a) sealing a polycrystalline material, comprising the Mg—IV—V₂ in a temperature resistant container; b) placing the temperature resistant container in a rocking furnace; c) heating the polycrystalline material to a first temperature at a rate of about 45° C./h to about 120° C./h and keeping the mixture at this heating temperature for a first predetermined time; d) placing the temperature-resistant container in a three-zone furnace, wherein the three-zone furnace exhibits a temperature profile defined by an upper/melt zone temperature, a middle/crystallization zone temperature; and a lower/annealing zone temperature; e) translating the temperature-resistant container vertically or horizontally, thereby allowing the temperature-resistant container to arrive at a nucleating temperature to form a self-seeding crystal; f) growing an ingot material from the self-seeding crystal; g) annealing the polycrystalline material to a temperature of about 700° C. to about 850° C. for a second predetermined time; and h) forming the single nonlinear optical crystal Mg—IV—V₂, wherein the crystal is substantially free of impurities, defined by a single phase and has a size from about 0.1 mm to about 10 cm in length.

In still further aspects, the polycrystalline material comprising the Mg—IV—V₂ compound used in the disclosed methods is formed by the steps comprising: a) mixing Mg, IV, and V in a molar ratio of about 0.95:0.95:2 to about 1.05:1.05:2 to form a mixture; b) placing the mixture into a sealed container in a furnace; c) bringing the mixture to a first heating temperature of about 450° C. to about 550° C. at a rate of about 1° C./h to 55° C./h and keeping the mixture at the first heating temperature for about 60 to about 100 hours; d) bringing the mixture to a second heating temperature of about 780° C. to about 850° C. at a rate of about 1° C./h to about 40° C./h and keeping the mixture at the second heating temperature for about 50 to about 100 hours; e) bringing the mixture to a third heating temperature of about 1,100° C. to about 1,250° C. at a rate of about 20° C./h to about 40° C./h and keeping the mixture at the third heating temperature for about 50 to about 100 hours; f) cooling the mixture to a room temperature at a rate of about 50° C./h to about 150° C./h; and g) recovering the polycrystalline material comprising Mg—IV—V₂, wherein the polycrystalline material is substantially free of impurities and has a substantially single phase.

Also disclosed herein is an optical parametric oscillator comprising any of the disclosed herein single nonlinear optical crystals.

In yet still further aspects, disclosed herein is a laser comprising any of the disclosed herein single nonlinear optical crystals.

Also disclosed herein is a method of forming the single nonlinear optical crystal of claim 1, wherein the method comprises: providing a solution comprising a solute comprising a mixture of Mg, IV and V in a molar ratio from about 0.95:0.95:2 to about 1.05:1.05:2 and a solvent; wherein a mass ratio between the solvent and solute is from about 10:1 to about 4:1; sealing the solution in a temperature-resistant container; placing the temperature-resistant container in a three-zone furnace, wherein the three-zone furnace exhibits a temperature profile defined by an upper/melt zone temperature, a middle/crystallization zone temperature; and a lower/annealing zone temperature; translating the temperature-resistant container vertically, thereby allowing the temperature-resistant container to arrive at a nucleating temperature to form a seeding crystal; growing an ingot material from the seeding crystal; and forming the single nonlinear optical crystal Mg—IV—V₂, wherein the single nonlinear optical crystal is substantially free of impurities, defined by a single phase and has a size from about 0.1 mm to about 10 cm in length.

In yet still further aspects, the solvent comprises Sb, Sn or a combination thereof.

In yet still further aspects, the upper/melt-zone temperature is from about 1,000° C. to about 1,200° C.; and the temperature profile is achieved with the required gradient temperature of about 10° C. to about 30° C.

In yet still further aspects, the temperature-resistant container is vertically translated at a rate of from about 0.1 mm/h to about 1.0 mm/h.

Additional advantages will be set forth in part in the description which follows, and in part will be obvious from the description or can be learned by practice of the aspects described below. The advantages described below will be realized and attained by means of the chemical compositions, methods, and combinations thereof, particularly pointed out in the appended claims. It is to be understood that both the foregoing general description and the following detailed description are exemplary and explanatory only and are not restrictive of the invention, as claimed.

### BRIEF DESCRIPTION OF DRAWINGS

FIGS. 1A-1E show the state of the art in Nonlinear and Quantum Optics: FIG. 1A shows the inverse relationship (grey band) between the second-order optical nonlinearity, dᵢⱼₖ, versus the electronic bandgap of various NLO crystals. The red stars (*) indicate data obtained in one aspect of the present disclosure, the remaining data is obtained from the literature (Ref. 9, 30-39). Open symbols are theoretical predictions. FIG. 1B shows a single photon nonlinearity (defined in the main text) versus effective d_{eff} for optical cavity mode volume of 0.1 (red), 1 (green) and 10(blue) times (λ/nₒ)³, where λ is the wavelength and nₒ is the mode index. This indicates that the larger the optical mode volume, the larger the d_{eff} desired for single-photon nonlinear frequency conversion for quantum optics. FIG. 1C depicts a schematic of Second Order Nonlinear Processes. An NLO medium denoted by χ⁽²⁾ can combine two photons of frequencies ω₁ and ω₂, to generate ω₁+ω₂ called sum frequency generation or SFG, as well as ω₁−ω₂ called the difference frequency generation or DFG. FIGS. 1D and 1E show NLO crystal design considerations. FIG. 1D shows the requirements for NLO crystals. FIG. 1E depicts transparency windows for design in mid-IR (between λ_{gap} and λₚₕₘᵢₙ), and in the THz (between λₚₕₘᵢₙ and λₚₗₐₛₘₐ).

FIGS. 2A-2B depict MgSiP₂ in one aspect. FIG. 2A shows the lattice structure of MgSiP₂ in one aspect. FIG. 2B shows photographs of MgSiP₂ in one aspect.

FIGS. 3A-3D compare CVT-treated crystals and exemplary crystals according to some aspects of the disclosure.

FIG. 4 shows an XRD comparison of CVT-treated crystals and exemplary crystals according to some aspects of the disclosure

FIG. 5 depicts the crystal structure of MgSiP₂, showing the (101) plane and the [111̅] direction.

FIG. 6 shows a schematic view of the SHG polarimetry geometry.

FIGS. 7A-7C show the Crystal structure of MgSiP₂ viewed from the axis (FIG. 7A) and from the (112) plane, which is highlighted in red (FIG. 7B). The [111̅] and [11̅0] and axes are marked in grey arrows. FIG. 7C shows an image of a MgSiP₂ crystal aligned in the same orientation as in FIG. 7B, showing the (112) plane. The other facet corresponds to the (101) plane, and the growth direction is along the [111̅] axis.

FIGS. 8A-8B depict the MgSiP₂ crystal structure. FIG. 8A shows the XRD pattern collected on the two facets of the MgSiP₂ single crystals, confirming the chalcopyrite structure, high crystallinity and plane orientation. Inset: a schematic (top) and an SEM image (bottom) of the crystal showing the (112) and (101) facets. FIG. 8B depicts a STEM image taken from the [110] axis. Inset: A magnified HAADF-STEM image superimposed with a simulated crystal structure.

FIG. 9 shows the real (solid line) and imaginary (dash line) refractive indices of MgSiP₂. The blue and red curves represent the ordinary and extraordinary components, respectively.

FIGS. 10A-10B depict polar plots of p-polarized (FIG. 10A) and s-polarized (FIG. 10B) SHG intensities. The black curves are the theoretical fit based on a point group 4̅2m.

FIGS. 11A-11E depict SHG polarimetry and intensities. FIG. 11A shows the experimental geometry of the SHG polarimetry. FIG. 11B shows polar plots of p-polarized (blue) and s-polarized (pink) SHG intensities of MgSiP₂ and the theoretical fit (black lines). FIG. 11C shows SHG intensities of MgSiP₂ crystal versus incident power. The good quadratic fit confirmed the measured signal was from the SHG process. Inset: SHG intensities versus incident power in logarithmic scale. FIG. 11D shows a comparison of SHG coefficients and bandgaps among MgSiP₂ (red star) and various NLO materials. The highest non-resonant dᵢⱼₖ coefficients of the NLO materials are shown. The LDTs of MgSiP₂, CdSiP₂ and ZnGeP₂ are illustrated in the inset. FIG. 11E shows the energy-dependent complex d₃₆ coefficient calculated by DFT with internal relaxation and scissor shift (labeled as “full”). The experimental value is shown as a pink star. In the inset, the curve obtained in the anti-resonant approximation (i.e., neglecting the anti-resonant contribution) is also displayed as a dashed line labeled AA.

FIG. 12 depicts the definition of the phase matching angle θₘ and azimuthal angle φ.

FIGS. 13A-13B depict schematics of the crystal wafer cut at the Type I phase matching direction when |d_{eff,I}| is at its maximum.

FIGS. 14A-14B depict the Type I and Type II phase-matching angle of MgSiP₂ versus the fundamental wavelength.

FIG. 15 shows the d_{eff} for Type I and Type II phase-matching conditions of MgSiP₂ versus the azimuthal angle q.

FIG. 16 shows the Band structure of MgSiP₂ with internal relaxation and without scissor shift. All bands are shifted to set the valence band maximum (VBM) at 0 eV.

FIGS. 17A-17C depict transmittance and refractive indices of MgSiP₂. FIG. 17A shows the transmittance spectrum of a single crystal MgSiP₂ with a thickness of ˜225 μm. FIG. 17B shows the experimental complex ordinary (top) and extraordinary (bottom) refractive indices of MgSiP₂ compared with results from DFT calculations with internal relaxation and scissor shift. FIG. 17C shows the ordinary and extraordinary refractive indices of MgSiP₂ and the theoretical Sellmeier fit. The inset enlarges the data in 0.45-1.0 μm to show the good fit.

FIGS. 18A-18B depict energy dependence and SHG response. FIG. 18A shows the energy dependence of the imaginary SHG “intra” 1 and 2 terms and of the xx (ordinary) and zz (extraordinary) components of the linear optical response. The 2ω curve was shifted in accordance with its resonance. FIG. 18B shows the contributions of the different bands to the main peak of the imaginary SHG response for the main terms. Only the 3-bands interactions were considered. The bands are shifted to set the valence band maximum (VBM) at 0 eV.

FIG. 19 shows the definition of the phase matching angle θₘ and azimuthal angle φ.

FIG. 20 shows the crystal structure of MgSiP₂ viewed from the [111] axis, showing the MgP₄ and SiP₄ tetrahedra are aligned in one direction. P atoms are omitted from the figure for clarity.

FIG. 21 shows an image of MgSiP₂ single crystals.

FIG. 22 shows a crystal image of MgSiP₂ after being left in air for two days, showing the beginning of surface degradation.

FIG. 23 shows the band structure of MgSiP₂ with internal relaxation and scissor shift. All bands are shifted to set the valence band maximum (VBM) at 0 eV.

FIGS. 24A-24B show the complex dielectric constants of MgSiP₂ extracted from ellipsometry, showing each oscillator.

FIG. 25 shows the birefringence curve (nₑ−nₒ) of MgSiP₂.

FIG. 26 shows a comparison of the SHG intensities of MgSiP₂ and x-cut LiNbO₃, normalized to the same incident power.

FIG. 27 shows three different contributions to the SHG coefficient of MgSiP₂. Only the resonant terms have been considered here.

FIG. 28 shows the projected density of states (PDOS) of MgSiP₂.

FIGS. 29A-29F show crystal images of (FIG. 29A) MgSiP₂, (FIG. 29C) CdSiP₂ and (FIG. 29E) ZnGeP₂ before the laser damage measurements and (FIG. 29B) MgSiP₂, (FIG. 29D) CdSiP₂ and (FIG. 29F) ZnGeP₂ after the laser damage measurements.

FIG. 30 shows the temperature-dependent thermal conductivity of MgSiP₂.

FIG. 31 shows an SEM-EDS image of a crystal grown by flux-vertical Bridgman growth.

### DETAILED DESCRIPTION

The present invention can be understood more readily by reference to the following detailed description, examples, drawings, and claims, and their previous and following description. However, before the present articles, systems, and/or methods are disclosed and described, it is to be understood that this invention is not limited to the specific or exemplary aspects of articles, systems, and/or methods disclosed unless otherwise specified, as such can, of course, vary. It is also to be understood that the terminology used herein is for the purpose of describing particular aspects only and is not intended to be limiting.

The following description of the invention is provided as an enabling teaching of the invention in its best, currently known aspect. To this end, those skilled in the relevant art will recognize and appreciate that many changes can be made to the various aspects of the invention described herein while still obtaining the beneficial results of the present invention. It will also be apparent that some of the desired benefits of the present invention can be obtained by selecting some of the features of the present invention without utilizing other features. Accordingly, those of ordinary skill in the pertinent art will recognize that many modifications and adaptations to the present invention are possible and may even be desirable in certain circumstances and are a part of the present invention. Thus, the following description is again provided as illustrative of the principles of the present invention and not in limitation thereof.

### Definitions

As used herein, the terms “optional” or “optionally” mean that the subsequently described event or circumstance can or cannot occur and that the description includes instances where said event or circumstance occurs and instances where it does not.

It is appreciated that certain features of the disclosure, which are, for clarity, described in the context of separate aspects, can also be provided in combination in a single aspect. Conversely, various features of the disclosure, which are, for brevity, described in the context of a single aspect, can also be provided separately or in any suitable subcombination.

As used in the description and the appended claims, the singular forms “a,” “an,” and “the” include plural referents unless the context clearly dictates otherwise. Thus, for example, a reference to “a crystal” includes two or more such crystals, and a reference to “a laser” includes two or more such lasers and the like.

It is also to be understood that the terminology used herein is for the purpose of describing particular aspects only and is not intended to be limiting. As used in the specification and in the claims, the term “comprising” can include the aspects “consisting of” and “consisting essentially of.” Unless defined otherwise, all technical and scientific terms used herein have the same meaning as commonly understood by one of ordinary skill in the art to which this invention belongs. In this specification and in the claims which follow, reference will be made to a number of terms that shall be defined herein.

For the terms “for example” and “such as,” and grammatical equivalences thereof, the phrase “and without limitation” is understood to follow unless explicitly stated otherwise.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements. Furthermore, when numerical ranges of varying scope are set forth herein, it is contemplated that any combination of these values, inclusive of the recited values, may be used. Further, ranges can be expressed herein as from “about” one particular value and/or to “about” another particular value. When such a range is expressed, another aspect includes from the one particular value and/or to the other particular value.

Similarly, when values are expressed as approximations, by use of the antecedent “about,” it will be understood that the particular value forms another aspect. It will be further understood that the endpoints of each of the ranges are significant both in relation to the other endpoint and independently of the other endpoint. Unless stated otherwise, the term “about” means within 5% (e.g., within 2% or 1%) of the particular value modified by the term “about.”

Throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, a description of a range such as from 1 to 6 should be considered to have specifically disclosed subranges such as from 1 to 3, from 1 to 4, from 1 to 5, from 2 to 4, from 2 to 6, from 3 to 6, etc., as well as individual numbers within that range, for example, 1, 2, 2.7, 3, 4, 5, 5.3, 6 and any whole and partial increments therebetween. This applies regardless of the breadth of the range.

As used herein, the term “composition” is intended to encompass a product comprising the specified ingredients in the specified amounts, as well as any product which results, directly or indirectly, from a combination of the specified ingredients in the specified amounts.

References in the specification and concluding claims to parts by weight of a particular element or component in a composition denotes the weight relationship between the element or component and any other elements or components in the composition or article for which a part by weight is expressed. Thus, in a mixture containing 2 parts by weight of component X and 5 parts by weight, components Y, X, and Y are present at a weight ratio of 2:5 and are present in such a ratio regardless of whether additional components are contained in the mixture.

A weight percent (wt. %) of a component, unless specifically stated to the contrary, is based on the total weight of the formulation or composition in which the component is included.

It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present. Other words used to describe the relationship between elements or layers should be interpreted in a like fashion (e.g., “between” versus “directly between,” “adjacent” versus “directly adjacent,” “on” versus “directly on”).

As used herein, the term “and/or” includes any and all combinations of one or more of the associated listed items.

It will be understood that although the terms “first,” “second,” etc., may be used herein to describe various elements, components, regions, layers, and/or sections. These elements, components, regions, layers, and/or sections should not be limited by these terms. These terms are only used to distinguish one element, component, region, layer, or section from another element, component, region, layer, or section. Thus, a first element, component, region, layer, or section discussed below could be termed a second element, component, region, layer, or section without departing from the teachings of example embodiments.

As used herein, the term “substantially” means that the subsequently described event or circumstance completely occurs or that the subsequently described event or circumstance generally, typically, or approximately occurs.

Still further, the term “substantially” can, in some aspects, refer to at least about 80%, at least about 85%, at least about 90%, at least about 91%, at least about 92%, at least about 93%, at least about 94%, at least about 95%, at least about 96%, at least about 97%, at least about 98%, at least about 99%, or about 100% of the stated property, component, composition, or other condition for which substantially is used to characterize or otherwise quantify an amount.

In other aspects, as used herein, the term “substantially free,” when used in the context of a composition or component of a composition that is substantially absent, is intended to refer to an amount that is then about 1% by weight, e.g., less than about 0.5% by weight, less than about 0.1% by weight, less than about 0.05% by weight, or less than about 0.01% by weight of the stated material, based on the total weight of the composition.

As used herein, the terms “substantially identical reference composition,” “substantially identical reference article,” or “substantially identical reference electrochemical cell” refer to a reference composition, article, or electrochemical cell comprising substantially identical components in the absence of an inventive component. In another exemplary aspect, the term “substantially,” in, for example, the context “substantially identical reference composition,” or “substantially identical reference article,” or “substantially identical reference electrochemical cell,” refers to a reference composition, article, or an electrochemical cell comprising substantially identical components and wherein an inventive component is substituted with a common in the art component.

While aspects of the present invention can be described and claimed in a particular statutory class, such as the system statutory class, this is for convenience only and one of ordinary skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is in no way intended that an order be inferred in any respect. This holds for any possible non-express basis for interpretation, including matters of logic with respect to the arrangement of steps or operational flow, plain meaning derived from grammatical organization or punctuation, or the number or type of aspects described in the specification.

The present invention may be understood more readily by reference to the following detailed description of various aspects of the invention and the examples included therein and to the Figures and their previous and following description.

As described herein, a component “IV” refers to an element of group IV (e.g., Si, Ge, Sn), and a component “V” refers to an element of group V (e.g., P, As).

### Non-Linear Optical Crystals and Devices

As disclosed herein, the current disclosure is directed to a single nonlinear optical crystal having a chemical formula of Mg—IV—V₂. In such aspects, a component IV is selected from Si, Ge, or Sn. In other aspects, a component V is selected from P or As. In certain aspects, the disclosed herein single nonlinear optical crystal has a chemical formula of MgSiP₂. In yet other aspects, the single nonlinear optical crystal has a chemical formula of MgGeP₂. In still further aspects, the single nonlinear optical crystal has a chemical formula of MgSnP₂. In yet other aspects, the single nonlinear optical crystal has a chemical formula of MgSiAs₂. In yet other aspects, the single nonlinear optical crystal has a chemical formula of MgGeAs₂. In still further aspects, the single nonlinear optical crystal has a chemical formula of MgSnAs₂. In yet other aspects, In yet still further aspects, the disclosed herein single nonlinear optical crystal has a chalcopyrite and non-centrosymmetric crystal structure. For example, in some aspects, the disclosed herein single nonlinear optical crystal has a non-centrosymmetric crystal structure with a space group of 14̅2d. In yet still further aspects, the disclosed herein single nonlinear optical crystal has a point group symmetry 4̅2m.

In still further aspects, the crystal structure is defined by unit cell parameters a from about 5.5 Å to about 6 Å; c between about 9.5 Å to about 12.5 Å; and a unit cell volume of about 287 Å³ to about 450 Å³.

As one example, in some aspects, the crystal structure is defined by unit cell parameter a of about 5 Å or more (e.g., about 5.6 Å or more, about 5.7 Å or more, about 5.8 Å or more, about 5.9 Å or more, about 6 Å or more). In some aspects, the crystal structure is defined by unit cell parameter a of about 6 Å or less (e.g., about 5.9 Å or less, about 5.8 Å or less, about 5.7 Å or less, about 5.6 Å or less, about 5.5 Å or less). The crystal structure can be defined by unit cell parameter a ranging from any of the minimum values described above to any of the maximum values described above. For example, in some aspects, the crystal structure is defined by unit cell parameter a of from about 5.5 Å to about 6 Å (e.g., from about 5.6 Å to about 5.9 Å, from about 5.7 Å to about 5.8 Å, from about 5.5 Å to about 5.8 Å, from about 5.6 Å to about 5.7 Å, from about 5.7 Å to about 6 Å, from about 5.8 Å to about 5.9 Å).

As another example, in some aspects, the crystal structure is defined by unit cell parameter c of about 9.5 Å or more (e.g., about 9.6 Å or more, about 9.7 Å or more, about 9.8 Å or more, about 9.9 Å or more, about 10 Å or more, about 10.1 Å or more, about 10.2 Å or more, about 10.3 Å or more, about 10.4 Å or more, about 10.5 Å or more, about 10.6 Å or more, about 10.7 Å or more, about 10.8 Å or more, about 10.9 Å or more, about 11 Å or more, about 11.1 Å or more, about 11.2 Å or more, about 11.3 Å or more, about 11.4 Å or more, about 11.5 Å or more, about 11.6 Å or more, about 11.7 Å or more, about 11.8 Å or more, about 11.9 Å or more, about 12 Å or more, about 12.1 Å or more, about 12.2 Å or more, about 12.3 Å or more, about 12.4 Å or more, about 12.5 Å or more). In some aspects, the crystal structure is defined by unit cell parameter c of 12.5 Å or less (e.g., about 12.4 Å or less, about 12.3 Å or less, about 12.2 Å or less, about 12.1 Å or less, about 12 Å or less, about 11.9 Å or less, about 11.8 Å or less, about 11.7 Å or less, about 11.6 Å or less, about 11.5 Å or less, about 11.4 Å or less, about 11.3 Å or less, about 11.2 Å or less, about 11.1 Å or less, about 11 Å or less, about 10.9 Å or less, about 10.8 Å or less, about 10.7 Å or less, about 10.6 Å or less, about 10.5 Å or less, about 10.4 Å or less, about 10.3 Å or less, about 10.2 Å or less, about 10.1 Å or less, about 10 Å or less, about 9.9 Å or less, about 9.8 Å or less, about 9.7 Å or less, about 9.6 Å or less, about 9.5 Å or less). The crystal structure can be defined by unit cell parameter c ranging from any of the minimum values described above to any of the maximum values described above. For example, in some aspects, the crystal structure is defined by unit cell parameter c of from about 9.5 Å to about 12.5 Å (e.g., from about 9.6 Å to about 12.4 Å, from about 9.7 Å to about 12.3 Å, from about 9.8 Å to about 12.2 Å, from about 9.9 Å to about 12.1 Å, from about 10 Å to about 12 Å, from about 10.1 Å to about 11.9 Å, from about 10.2 Å to about 11.8 Å, from about 10.3 Å to about 11.7 Å, from about 10.4 Å to about 11.6 Å, from about 10.5 Å to about 11.5 Å, from about 10.6 Å to about 11.4 Å, from about 10.7 Å to about 11.3 Å, from about 10.8 Å to about 11.2 Å, from about 10.9 Å to about 11.1 Å, from about 9.5 Å to about 11 Å, from about 9.6 Å to about 10.9 Å, from about 9.7 Å to about 10.8 Å, from about 9.8 Å to about 10.7 Å, from about 9.9 Å to about 10.6 Å, from about 10 Å to about 10.5 Å, from about 10.1 Å to about 10.4 Å, from about 10.2 Å to about 10.3 Å, from about 11 Å to about 12.5 Å, from about 11.1 Å to about 12.4 Å, from about 11.2 Å to about 12.3 Å, from about 11.3 Å to about 12.2 Å, from about 11.4 Å to about 12.1 Å, from about 11.5 Å to about 12 Å, from about 11.6 Å to about 11.9 Å, from about 11.7 Å to about 11.8 Å).

As yet another example, in some aspects, the crystal structure is defined by a unit cell volume of about 287 Å³ or more (e.g., about 288 Å³ or more, about 289 Å³ or more, about 290 Å³ or more, about 291 Å³ or more, about 292 Å³ or more, about 293 Å³ or more, about 294 Å³ or more, about 295 Å³ or more, about 296 Å³ or more, about 297 Å³ or more, about 298 Å³ or more, about 299 Å³ or more, about 300 Å³ or more, about 301 Å³ or more, about 302 Å³ or more, about 303 Å³ or more, about 304 Å³ or more, about 305 Å³ or more, about 306 Å³ or more, about 307 Å³ or more, about 308 Å³ or more, about 309 Å³ or more, about 310 Å³ or more, about 311 Å³ or more, about 312 Å³ or more, about 313 Å³ or more, about 314 Å³ or more, about 315 Å³ or more, about 316 Å³ or more, about 317 Å³ or more, about 318 Å³ or more, about 319 Å³ or more, about 320 Å³ or more, about 321 Å³ or more, about 322 Å³ or more, about 323 Å³ or more, about 324 Å³ or more, about 325 Å³ or more, about 326 Å³ or more, about 327 Å³ or more, about 328 Å³ or more, about 329 Å³ or more, about 330 Å³ or more, about 331 Å³ or more, about 332 Å³ or more, about 333 Å³ or more, about 334 Å³ or more, about 335 Å³ or more, about 336 Å³ or more, about 337 Å³ or more, about 338 Å³ or more, about 339 Å³ or more, about 340 Å³ or more, about 341 Å³ or more, about 342 Å³ or more, about 343 Å³ or more, about 344 Å³ or more, about 345 Å³ or more, about 346 Å³ or more, about 347 Å³ or more, about 348 Å³ or more, about 349 Å³ or more, about 350 Å³ or more, about 351 Å³ or more, about 352 Å³ or more, about 353 Å³ or more, about 354 Å³ or more, about 355 Å³ or more, about 356 Å³ or more, about 357 Å³ or more, about 358 Å³ or more, about 359 Å³ or more, about 360 Å³ or more, about 361 Å³ or more, about 362 Å³ or more, about 363 Å³ or more, about 364 Å³ or more, about 365 Å³ or more, about 366 Å³ or more, about 367 Å³ or more, about 368 Å³ or more, about 369 Å³ or more, about 370 Å³ or more, about 371 Å³ or more, about 372 Å³ or more, about 373 Å³ or more, about 374 Å³ or more, about 375 Å³ or more, about 376 Å³ or more, about 377 Å³ or more, about 378 Å³ or more, about 379 Å³ or more, about 380 Å³ or more, about 381 Å³ or more, about 382 Å³ or more, about 383 Å³ or more, about 384 Å³ or more, about 385 Å³ or more, about 386 Å³ or more, about 387 Å³ or more, about 388 Å³ or more, about 389 Å³ or more, about 390 Å³ or more, about 391 Å³ or more, about 392 Å³ or more, about 393 Å³ or more, about 394 Å³ or more, about 395 Å³ or more, about 396 Å³ or more, about 397 Å³ or more, about 398 Å³ or more, about 399 Å³ or more, about 400 Å³ or more, about 401 Å³ or more, about 402 Å³ or more, about 403 Å³ or more, about 404 Å³ or more, about 405 Å³ or more, about 406 Å³ or more, about 407 Å³ or more, about 408 Å³ or more, about 409 Å³ or more, about 410 Å³ or more, about 411 Å³ or more, about 412 Å³ or more, about 413 Å³ or more, about 414 Å³ or more, about 415 Å³ or more, about 416 Å³ or more, about 417 Å³ or more, about 418 Å³ or more, about 419 Å³ or more, about 420 Å³ or more, about 421 Å³ or more, about 422 Å³ or more, about 423 Å³ or more, about 424 Å³ or more, about 425 Å³ or more, about 426 Å³ or more, about 427 Å³ or more, about 428 Å³ or more, about 429 Å³ or more, about 430 Å³ or more, about 431 Å³ or more, about 432 Å³ or more, about 433 Å³ or more, about 434 Å³ or more, about 435 Å³ or more, about 436 Å³ or more, about 437 Å³ or more, about 438 Å³ or more, about 439 Å³ or more, about 440 Å³ or more, about 441 Å³ or more, about 442 Å³ or more, about 443 Å³ or more, about 444 Å³ or more, about 445 Å³ or more, about 446 Å³ or more, about 447 Å³ or more, about 448 Å³ or more, about 449 Å³ or more, about 450 Å³ or more). In some aspects, the crystal structure is defined by a unit cell volume of about 450 or less (e.g., about 449 Å³ or less, about 448 Å³ or less, about 447 Å³ or less, about 446 Å³ or less, about 445 Å³ or less, about 444 Å³ or less, about 443 Å³ or less, about 442 Å³ or less, about 441 Å³ or less, about 440 Å³ or less, about 439 Å³ or less, about 438 Å³ or less, about 437 Å³ or less, about 436 Å³ or less, about 435 Å³ or less, about 434 Å³ or less, about 433 Å³ or less, about 432 Å³ or less, about 431 Å³ or less, about 430 Å³ or less, about 429 Å³ or less, about 428 Å³ or less, about 427 Å³ or less, about 426 Å³ or less, about 425 Å³ or less, about 424 Å³ or less, about 423 Å³ or less, about 422 Å³ or less, about 421 Å³ or less, about 420 Å³ or less, about 419 Å³ or less, about 418 Å³ or less, about 417 Å³ or less, about 416 Å³ or less, about 415 Å³ or less, about 414 Å³ or less, about 413 Å³ or less, about 412 Å³ or less, about 411 Å³ or less, about 410 Å³ or less, about 409 Å³ or less, about 408 Å³ or less, about 407 Å³ or less, about 406 Å³ or less, about 405 Å³ or less, about 404 Å³ or less, about 403 Å³ or less, about 402 Å³ or less, about 401 Å³ or less, about 400 Å³ or less, about 399 Å³ or less, about 398 Å³ or less, about 397 Å³ or less, about 396 Å³ or less, about 395 Å³ or less, about 394 Å³ or less, about 393 Å³ or less, about 392 Å³ or less, about 391 Å³ or less, about 390 Å³ or less, about 389 Å³ or less, about 388 Å³ or less, about 387 Å³ or less, about 386 Å³ or less, about 385 Å³ or less, about 384 Å³ or less, about 383 Å³ or less, about 382 Å³ or less, about 381 Å³ or less, about 380 Å³ or less, about 379 Å³ or less, about 378 Å³ or less, about 377 Å³ or less, about 376 Å³ or less, about 375 Å³ or less, about 374 Å³ or less, about 373 Å³ or less, about 372 Å³ or less, about 371 Å³ or less, about 370 Å³ or less, about 369 Å³ or less, about 368 Å³ or less, about 367 Å³ or less, about 366 Å³ or less, about 365 Å³ or less, about 364 Å³ or less, about 363 Å³ or less, about 362 Å³ or less, about 361 Å³ or less, about 360 Å³ or less, about 359 Å³ or less, about 358 Å³ or less, about 357 Å³ or less, about 356 Å³ or less, about 355 Å³ or less, about 354 Å³ or less, about 353 Å³ or less, about 352 Å³ or less, about 351 Å³ or less, about 350 Å³ or less, about 349 Å³ or less, about 348 Å³ or less, about 347 Å³ or less, about 346 Å³ or less, about 345 Å³ or less, about 344 Å³ or less, about 343 Å³ or less, about 342 Å³ or less, about 341 Å³ or less, about 340 Å³ or less, about 339 Å³ or less, about 338 Å³ or less, about 337 Å³ or less, about 336 Å³ or less, about 335 Å³ or less, about 334 Å³ or less, about 333 Å³ or less, about 332 Å³ or less, about 331 Å³ or less, about 330 Å³ or less, about 329 Å³ or less, about 328 Å³ or less, about 327 Å³ or less, about 326 Å³ or less, about 325 Å³ or less, about 324 Å³ or less, about 323 Å³ or less, about 322 Å³ or less, about 321 Å³ or less, about 320 Å³ or less, about 319 Å³ or less, about 318 Å³ or less, about 317 Å³ or less, about 316 Å³ or less, about 315 Å³ or less, about 314 Å³ or less, about 313 Å³ or less, about 312 Å³ or less, about 311 Å³ or less, about 310 Å³ or less, about 309 Å³ or less, about 308 Å³ or less, about 307 Å³ or less, about 306 Å³ or less, about 305 Å³ or less, about 304 Å³ or less, about 303 Å³ or less, about 302 Å³ or less, about 301 Å³ or less, about 300 Å³ or less, about 299 Å³ or less, about 298 Å³ or less, about 297 Å³ or less, about 296 Å³ or less, about 295 Å³ or less, about 294 Å³ or less, about 293 Å³ or less, about 292 Å³ or less, about 291 Å³ or less, about 290 Å³ or less, about 289 Å³ or less, about 288 Å³ or less, about 287 Å³ or less).

The crystal structure can be defined by a unit cell volume ranging from any of the minimum values described above to any of the maximum values described above. For example, in some aspects, the crystal structure is defined by a unit cell volume of from about 287 Å³ to about 450 Å³ (e.g., from about 288 Å³ to about 449 Å³, from about 289 Å³ to about 448 Å³, from about 290 Å³ to about 447 Å³, from about 291 Å³ to about 446 Å³, from about 292 Å³ to about 445 Å³, from about 293 Å³ to about 444 Å³, from about 294 Å³ to about 443 Å³, from about 295 Å³ to about 442 Å³, from about 296 Å³ to about 441 Å³, from about 297 Å³ to about 440 Å³, from about 298 Å³ to about 439 Å³, from about 299 Å³ to about 438 Å³, from about 300 Å³ to about 437 Å³, from about 301 Å³ to about 436 Å³, from about 302 Å³ to about 435 Å³, from about 303 Å³ to about 434 Å³, from about 304 Å³ to about 433 Å³, from about 305 Å³ to about 432 Å³, from about 306 Å³ to about 431 Å³, from about 307 Å³ to about 430 Å³, from about 308 Å³ to about 429 Å³, from about 309 Å³ to about 428 Å³, from about 310 Å³ to about 427 Å³, from about 311 Å³ to about 426 Å³, from about 312 Å³ to about 425 Å³, from about 313 Å³ to about 424 Å³, from about 314 Å³ to about 423 Å³, from about 315 Å³ to about 422 Å³, from about 316 Å³ to about 421 Å³, from about 317 Å³ to about 420 Å³, from about 318 Å³ to about 419 Å³, from about 319 Å³ to about 418 Å³, from about 320 Å³ to about 417 Å³, from about 321 Å³ to about 416 Å³, from about 322 Å³ to about 415 Å³, from about 323 Å³ to about 414 Å³, from about 324 Å³ to about 413 Å³, from about 325 Å³ to about 412 Å³, from about 326 Å³ to about 411 Å³, from about 327 Å³ to about 410 Å³, from about 328 Å³ to about 409 Å³, from about 329 Å³ to about 408 Å³, from about 330 Å³ to about 407 Å³, from about 331 Å³ to about 406 Å³, from about 332 Å³ to about 405 Å³, from about 333 Å³ to about 404 Å³, from about 334 Å³ to about 403 Å³, from about 335 Å³ to about 402 Å³, from about 336 Å³ to about 401 Å³, from about 337 Å³ to about 400 Å³, from about 338 Å³ to about 399 Å³, from about 339 Å³ to about 398 Å³, from about 340 Å³ to about 397 Å³, from about 341 Å³ to about 396 Å³, from about 342 Å³ to about 395 Å³, from about 343 Å³ to about 394 Å³, from about 344 Å³ to about 393 Å³, from about 345 Å³ to about 392 Å³, from about 346 Å³ to about 391 Å³, from about 347 Å³ to about 390 Å³, from about 348 Å³ to about 389 Å³, from about 349 Å³ to about 388 Å³, from about 350 Å³ to about 387 Å³, from about 351 Å³ to about 386 Å³, from about 352 Å³ to about 385 Å³, from about 353 Å³ to about 384 Å³, from about 354 Å³ to about 383 Å³, from about 355 Å³ to about 382 Å³, from about 356 Å³ to about 381 Å³, from about 357 Å³ to about 380 Å³, from about 358 Å³ to about 379 Å³, from about 359 Å³ to about 378 Å³, from about 360 Å³ to about 377 Å³, from about 361 Å³ to about 376 Å³, from about 362 Å³ to about 375 Å³, from about 363 Å³ to about 374 Å³, from about 364 Å³ to about 373 Å³, from about 365 Å³ to about 372 Å³, from about 366 Å³ to about 371 Å³, from about 367 Å³ to about 370 Å³, from about 368 Å³ to about 369 Å³, from about 287 Å³ to about 369 Å³, from about 288 Å³ to about 368 Å³, from about 289 Å³ to about 367 Å³, from about 290 Å³ to about 366 Å³, from about 291 Å³ to about 365 Å³, from about 292 Å³ to about 364 Å³, from about 293 Å³ to about 363 Å³, from about 294 Å³ to about 362 Å³, from about 295 Å³ to about 361 Å³, from about 296 Å³ to about 360 Å³, from about 297 Å³ to about 359 Å³, from about 298 Å³ to about 358 Å³, from about 299 Å³ to about 357 Å³, from about 300 Å³ to about 356 Å³, from about 301 Å³ to about 355 Å³, from about 302 Å³ to about 354 Å³, from about 303 Å³ to about 353 Å³, from about 304 Å³ to about 352 Å³, from about 305 Å³ to about 351 Å³, from about 306 Å³ to about 350 Å³, from about 307 Å³ to about 349 Å³, from about 308 Å³ to about 348 Å³, from about 309 Å³ to about 347 Å³, from about 310 Å³ to about 346 Å³, from about 311 Å³ to about 345 Å³, from about 312 Å³ to about 344 Å³, from about 313 Å³ to about 343 Å³, from about 314 Å³ to about 342 Å³, from about 315 Å³ to about 341 Å³, from about 316 Å³ to about 340 Å³, from about 317 Å³ to about 339 Å³, from about 318 Å³ to about 338 Å³, from about 319 Å³ to about 337 Å³, from about 320 Å³ to about 336 Å³, from about 321 Å³ to about 335 Å³, from about 322 Å³ to about 334 Å³, from about 323 Å³ to about 333 Å³, from about 324 Å³ to about 332 Å³, from about 325 Å³ to about 331 Å³, from about 326 Å³ to about 330 Å³, from about 327 Å³ to about 329 Å³, from about 368 Å³ to about 450 Å³, from about 369 Å³ to about 449 Å³, from about 370 Å³ to about 448 Å³, from about 371 Å³ to about 447 Å³, from about 372 Å³ to about 446 Å³, from about 373 Å³ to about 445 Å³, from about 374 Å³ to about 444 Å³, from about 375 Å³ to about 443 Å³, from about 376 Å³ to about 442 Å³, from about 377 Å³ to about 441 Å³, from about 378 Å³ to about 440 Å³, from about 379 Å³ to about 439 Å³, from about 380 Å³ to about 438 Å³, from about 381 Å³ to about 437 Å³, from about 382 Å³ to about 436 Å³, from about 383 Å³ to about 435 Å³, from about 384 Å³ to about 434 Å³, from about 385 Å³ to about 433 Å³, from about 386 Å³ to about 432 Å³, from about 387 Å³ to about 431 Å³, from about 388 Å³ to about 430 Å³, from about 389 Å³ to about 429 Å³, from about 390 Å³ to about 428 Å³, from about 391 Å³ to about 427 Å³, from about 392 Å³ to about 426 Å³, from about 393 Å³ to about 425 Å³, from about 394 Å³ to about 424 Å³, from about 395 Å³ to about 423 Å³, from about 396 Å³ to about 422 Å³, from about 397 Å³ to about 421 Å³, from about 398 Å³ to about 420 Å³, from about 399 Å³ to about 419 Å³, from about 400 Å³ to about 418 Å³, from about 401 Å³ to about 417 Å³, from about 402 Å³ to about 416 Å³, from about 403 Å³ to about 415 Å³, from about 404 Å³ to about 414 Å³, from about 405 Å³ to about 413 Å³, from about 406 Å³ to about 412 Å³, from about 407 Å³ to about 411 Å³, from about 408 Å³ to about 410 Å³).

In some aspects, the single nonlinear optical crystal disclosed herein exhibits a refractive index of about 2.770 or more (e.g., about 2.771 or more, about 2.772 or more, about 2.773 or more, about 2.774 or more, about 2.775 or more, about 2.776 or more, about 2.777 or more, about 2.778 or more, about 2.779 or more, about 2.780 or more) for nₒ at a wavelength of 1550 nm. In some aspects, the single nonlinear optical crystal disclosed herein exhibits a refractive index of about 2.780 or less (e.g., about 2.779 or less, about 2.778 or less, about 2.777 or less, about 2.776 or less, about 2.775 or less, about 2.774 or less, about 2.773 or less, about 2.772 or less, about 2.771 or less, about 2.770 or less) for nₒ at a wavelength of 1550 nm. The single nonlinear optical crystal disclosed herein can exhibit a refractive index ranging from any of the minimum values described above to any of the maximum values described above. For example, in some aspects, the single nonlinear optical crystal disclosed herein exhibits a refractive index of from about 2.770 to about 2.780 (e.g., from about 2.771 to about 2.779, from about 2.772 to about 2.778, from about 2.773 to about 2.777, from about 2.774 to about 2.776, from about 2.770 to about 2.775, from about 2.771 to about 2.774, from about 2.772 to about 2.773, from about 2.775 to about 2.780, from about 2.776 to about 2.779, from about 2.777 to about 2.778) for nₒ at a wavelength of 1550 nm.

In some aspects, the single nonlinear optical crystal disclosed herein exhibits a refractive index of about 2.800 or more (e.g., about 2.801 or more, about 2.802 or more, about 2.803 or more, about 2.804 or more, about 2.805 or more, about 2.806 or more, about 2.807 or more, about 2.808 or more, about 2.809 or more, about 2.810 or more) for nₑ at a wavelength of 1550 nm. In some aspects, the single nonlinear optical crystal disclosed herein exhibits a refractive index of about 2.810 or less (e.g., about 2.809 or less, about 2.808 or less, about 2.807 or less, about 2.806 or less, about 2.805 or less, about 2.804 or less, about 2.803 or less, about 2.802 or less, about 2.801 or less, about 2.800 or less) for nₑ at a wavelength of 1550 nm. The single nonlinear optical crystal disclosed herein can exhibit a refractive index ranging from any of the minimum values described above to any of the maximum values described above. For example, in some aspects, the single nonlinear optical crystal disclosed herein exhibits a refractive index of from about 2.800 to about 2.810 (e.g., from about 2.801 to about 2.809, from about 2.802 to about 2.808, from about 2.803 to about 2.807, from about 2.804 to about 2.806, from about 2.800 to about 2.805, from about 2.801 to about 2.804, from about 2.802 to about 2.803, from about 2.805 to about 2.810, from about 2.806 to about 2.809, from about 2.807 to about 2.808) for nₑ at a wavelength of 1550 nm.

In some aspects, the single nonlinear optical crystal exhibits a nonlinear coefficient of d_{eff} of SHG of about 80 pm/V or more (e.g., about 81 pm/V or more, about 82 pm/V or more, about 83 pm/V or more, about 84 pm/V or more, about 85 pm/V or more, about 86 pm/V or more, about 87 pm/V or more, about 88 pm/V or more, about 89 pm/V or more, about 90 pm/V or more, about 91 pm/V or more, about 92 pm/V or more, about 93 pm/V or more, about 94 pm/V or more, about 95 pm/V or more). In some aspects, the single nonlinear optical crystal exhibits a nonlinear coefficient of d_{eff} of SHG of about 95 pm/V or less (e.g., about 94 pm/V or less, about 93 pm/V or less, about 92 pm/V or less, about 91 pm/V or less, about 90 pm/V or less, about 89 pm/V or less, about 88 pm/V or less, about 87 pm/V or less, about 86 pm/V or less, about 85 pm/V or less, about 84 pm/V or less, about 83 pm/V or less, about 82 pm/V or less, about 81 pm/V or less, about 80 pm/V or less). The single nonlinear optical crystal can exhibit a nonlinear coefficient of d_{eff} Of SHG ranging from any of the minimum values described above to any of the maximum values described above. For example, in some aspects, the single nonlinear optical crystal exhibits a nonlinear coefficient of d_{eff} of SHG of from about 80 pm/V to about 95 pm/V (e.g., from about 81 pm/V to about 94 pm/V, from about 82 pm/V to about 93 pm/V, from about 83 pm/V to about 92 pm/V, from about 84 pm/V to about 91 pm/V, from about 85 pm/V to about 90 pm/V, from about 86 pm/V to about 89 pm/V, from about 87 pm/V to about 88 pm/V, from about 80 pm/V to about 88 pm/V, from about 81 pm/V to about 87 pm/V, from about 82 pm/V to about 86 pm/V, from about 83 pm/V to about 85 pm/V, from about 87 pm/V to about 95 pm/V, from about 88 pm/V to about 94 pm/V, from about 89 pm/V to about 93 pm/V, from about 90 pm/V to about 92 pm/V).

In yet still in further aspects, the single nonlinear optical crystal Mg—IV—V₂ is substantially free of impurities.

In still further aspects, the disclosed herein single nonlinear optical crystal exhibits a transmittance from about 60% to less than 100% in a wavelength range from about 0.55 μm to at least about 20 μm.

In some aspects, the disclosed herein single nonlinear optical crystal exhibits a transmittance of about 60% or more (e.g., about 65% or more, about 70% or more, about 75% or more, about 80% or more, about 85% or more, about 90% or more, about 95% or more, about 99% or more) in a wavelength range from about 0.55 μm to at least about 20 μm. In some aspects, the disclosed herein single nonlinear optical crystal exhibits a transmittance of less than 100% (e.g., about 99% or less, about 95% or less, about 90% or less, about 85% or less, about 80% or less, about 75% or less, about 70% or less, about 65% or less, about 60% or less) in a wavelength range from about 0.55 μm to at least about 20 μm. The disclosed herein single nonlinear optical crystal can exhibit a transmittance in a wavelength range from about 0.55 μm to at least about 20 μm ranging from any of the minimum values described above to any of the maximum values described above. For example, in some aspects, the disclosed herein single nonlinear optical crystal exhibits a transmittance of from about 60% to less than 100% (e.g., from about 65% to about 99%, from about 70% to about 95%, from about 75% to about 90%, from about 80% to about 85%, from about 60% to about 80%, from about 65% to about 75%, from about 80% to about 100%, from about 85% to about 99%, from about 90% to about 95%) in a wavelength range from about 0.55 μm to at least about 20 μm.

In some aspects, the disclosed herein single nonlinear optical crystal exhibits a transmittance from about 60% to less than 100% in a wavelength range of about 0.55 μm or more (e.g., about 0.60 μm or more, about 0.70 μm or more, about 0.80 μm or more, about 0.90 μm or more, about 1.0 μm or more, about 2 μm or more, about 5 μm or more, about 10 μm or more, about 11 μm or more, about 12 μm or more, about 13 μm or more, about 14 μm or more, about 15 μm or more, about 16 μm or more, about 17 μm or more, about 18 μm or more, about 19 μm or more, about 20 μm or more). In some aspects, the disclosed herein single nonlinear optical crystal exhibits a transmittance from about 60% to less than 100% in a wavelength range of about 20 μm or less (e.g., about 19 μm or less, about 18 μm or less, about 17 μm or less, about 16 μm or less, about 15 μm or less, about 14 μm or less, about 13 μm or less, about 12 μm or less, about 11 μm or less, about 10 μm or less, about 5 μm or less, about 2 μm or less, about 1.0 μm or less, about 0.90 μm or less, about 0.80 μm or less, about 0.70 μm or less, about 0.60 μm or less, about 0.55 μm or less). The disclosed herein single nonlinear optical crystal can exhibit a transmittance from about 60% to less than 100% in a wavelength ranging from any of the minimum values described above to any of the maximum values described above. For example, in some aspects, the disclosed herein single nonlinear optical crystal exhibits a transmittance from about 60% to less than 100% in a wavelength range of from about 0.55 μm to about 20 μm (e.g., from about 0.6 μm to about 19 μm, from about 0.7 μm to about 18 μm, from about 0.8 μm to about 17 μm, from about 0.9 μm to about 16 μm, from about 1 μm to about 15 μm, from about 2 μm to about 14 μm, from about 5 μm to about 13 μm, from about 10 μm to about 12 μm, from about 0.55 μm to about 12 μm, from about 0.6 μm to about 11 μm, from about 0.7 μm to about 10 μm, from about 0.8 μm to about 5 μm, from about 0.9 μm to about 2 μm, from about 10 μm to about 20 μm, from about 11 μm to about 19 μm, from about 12 μm to about 18 μm, from about 13 μm to about 17 μm, from about 14 μm to about 16 μm).

In yet still further aspects, the disclosed herein single nonlinear optical crystals and their properties are defined by d₁₄ and d₃₆ coefficients. In some aspects, the disclosed herein single nonlinear optical crystal has a d₁₄ coefficient of about 80 pm/V or more (e.g., about 81 pm/V or more, about 82 pm/V or more, about 83 pm/V or more, about 84 pm/V or more, about 85 pm/V or more, about 86 pm/V or more, about 87 pm/V or more, about 88 pm/V or more, about 89 pm/V or more, about 90 pm/V or more, about 91 pm/V or more, about 92 pm/V or more, about 93 pm/V or more, about 94 pm/V or more, about 95 pm/V or more) at a fundamental wavelength of 1550 nm. In some aspects, the disclosed herein single nonlinear optical crystal has a d₁₄ coefficient of about 95 pm/V or less (e.g., about 94 pm/V or less, about 93 pm/V or less, about 92 pm/V or less, about 91 pm/V or less, about 90 pm/V or less, about 89 pm/V or less, about 88 pm/V or less, about 87 pm/V or less, about 86 pm/V or less, about 85 pm/V or less, about 84 pm/V or less, about 83 pm/V or less, about 82 pm/V or less, about 81 pm/V or less, about 80 pm/V or less) at a fundamental wavelength of 1550 nm. The disclosed herein single nonlinear optical crystal can have a d₁₄ coefficient at a fundamental wavelength of 1550 nm ranging from any of the minimum values described above to any of the maximum values described above. For example, in some aspects, the disclosed herein single nonlinear optical crystal has a d₁₄ coefficient of from about 80 pm/V to about 95 pm/V (e.g., from about 81 pm/V to about 94 pm/V, from about 82 pm/V to about 93 pm/V, from about 83 pm/V to about 92 pm/V, from about 84 pm/V to about 91 pm/V, from about 85 pm/V to about 90 pm/V, from about 86 pm/V to about 89 pm/V, from about 87 pm/V to about 88 pm/V, from about 80 pm/V to about 88 pm/V, from about 81 pm/V to about 87 pm/V, from about 82 pm/V to about 86 pm/V, from about 83 pm/V to about 85 pm/V, from about 87 pm/V to about 95 pm/V, from about 88 pm/V to about 94 pm/V, from about 89 pm/V to about 93 pm/V, from about 90 pm/V to about 92 pm/V) at a fundamental wavelength of 1550 nm.

In some aspects, the disclosed herein single nonlinear optical crystal has a d₃₆ coefficient of about 80 pm/V or more (e.g., about 81 pm/V or more, about 82 pm/V or more, about 83 pm/V or more, about 84 pm/V or more, about 85 pm/V or more, about 86 pm/V or more, about 87 pm/V or more, about 88 pm/V or more, about 89 pm/V or more, about 90 pm/V or more, about 91 pm/V or more, about 92 pm/V or more, about 93 pm/V or more, about 94 pm/V or more, about 95 pm/V or more) at a fundamental wavelength of 1550 nm. In some aspects, the disclosed herein single nonlinear optical crystal has a d₃₆ coefficient of about 95 pm/V or less (e.g., about 94 pm/V or less, about 93 pm/V or less, about 92 pm/V or less, about 91 pm/V or less, about 90 pm/V or less, about 89 pm/V or less, about 88 pm/V or less, about 87 pm/V or less, about 86 pm/V or less, about 85 pm/V or less, about 84 pm/V or less, about 83 pm/V or less, about 82 pm/V or less, about 81 pm/V or less, about 80 pm/V or less) at a fundamental wavelength of 1550 nm. The disclosed herein single nonlinear optical crystal can have a d₃₆ coefficient at a fundamental wavelength of 1550 nm ranging from any of the minimum values described above to any of the maximum values described above. For example, in some aspects, the disclosed herein single nonlinear optical crystal has a d₃₆ coefficient of from about 80 pm/V to about 95 pm/V (e.g., from about 81 pm/V to about 94 pm/V, from about 82 pm/V to about 93 pm/V, from about 83 pm/V to about 92 pm/V, from about 84 pm/V to about 91 pm/V, from about 85 pm/V to about 90 pm/V, from about 86 pm/V to about 89 pm/V, from about 87 pm/V to about 88 pm/V, from about 80 pm/V to about 88 pm/V, from about 81 pm/V to about 87 pm/V, from about 82 pm/V to about 86 pm/V, from about 83 pm/V to about 85 pm/V, from about 87 pm/V to about 95 pm/V, from about 88 pm/V to about 94 pm/V, from about 89 pm/V to about 93 pm/V, from about 90 pm/V to about 92 pm/V) at a fundamental wavelength of 1550 nm.

In still further aspects, the disclosed herein single nonlinear optical crystals exhibit type I and type II phase matching. In some aspects, the disclosed herein single nonlinear optical crystal exhibits |d_{eff,I}| at φ=0° of greater than about 75 pm/V (e.g., about 76 pm/V or more, about 77 pm/V or more, about 78 pm/V or more, about 79 pm/V or more, about 80 pm/V or more, about 81 pm/V or more, about 82 pm/V or more, about 83 pm/V or more, about 84 pm/V or more, about 85 pm/V or more, about 86 pm/V or more, about 87 pm/V or more, about 88 pm/V or more, about 89 pm/V or more, about 90 pm/V or more) at a fundamental wavelength of about 3.5 μm. In some aspects, the disclosed herein single nonlinear optical crystal exhibits |d_{eff,I}| at φ=0° of about 90 pm/V or less (e.g., about 89 pm/V or less, about 88 pm/V or less, about 87 pm/V or less, about 86 pm/V or less, about 85 pm/V or less, about 84 pm/V or less, about 83 pm/V or less, about 82 pm/V or less, about 81 pm/V or less, about 80 pm/V or less, about 79 pm/V or less, about 78 pm/V or less, about 77 pm/V or less, about 76 pm/V or less) at a fundamental wavelength of about 3.5 μm. The disclosed herein single nonlinear optical crystal can exhibit |d_{eff,I}| at φ=0° at a fundamental wavelength of about 3.5 μm ranging from any of the minimum values described above to any of the maximum values described above. For example, in some aspects, the disclosed herein single nonlinear optical crystal exhibits |d_{eff,I}| at φ=0° of greater than about 75 pm/V to about 90 pm/V (e.g., from about 76 pm/V to about 89 pm/V, from about 77 pm/V to about 88 pm/V, from about 78 pm/V to about 87 pm/V, from about 79 pm/V to about 86 pm/V, from about 80 pm/V to about 85 pm/V, from about 81 pm/V to about 84 pm/V, from about 82 pm/V to about 83 pm/V, from about 75 pm/V to about 83 pm/V, from about 76 pm/V to about 82 pm/V, from about 77 pm/V to about 81 pm/V, from about 78 pm/V to about 80 pm/V, from about 82 pm/V to about 90 pm/V, from about 83 pm/V to about 89 pm/V, from about 84 pm/V to about 88 pm/V, from about 85 pm/V to about 87 pm/V) at a fundamental wavelength of about 3.5 μm.

In some aspects, the disclosed herein single nonlinear optical crystal exhibits |d_{eff,II}|=at ω=45° of greater than about 70 pm/V (e.g., about 71 pm/V or more, about 72 pm/V or more, about 73 pm/V or more, about 74 pm/V or more, about 75 pm/V or more, about 76 pm/V or more, about 77 pm/V or more, about 78 pm/V or more, about 79 pm/V or more, about 80 pm/V or more) at a fundamental wavelength of 3.5 μm. In some aspects, the disclosed herein single nonlinear optical crystal exhibits |d_{eff,II}|=at ω=45° of about 80 pm/V or less (e.g., about 79 pm/V or less, about 78 pm/V or less, about 77 pm/V or less, about 76 pm/V or less, about 75 pm/V or less, about 74 pm/V or less, about 73 pm/V or less, about 72 pm/V or less, about 71 pm/V or less) at a fundamental wavelength of 3.5 μm. In some aspects, the disclosed herein single nonlinear optical crystal can exhibit |d_{eff,II}|=at φ=45° at a fundamental wavelength of 3.5 μm ranging from any of the minimum values described above to any of the maximum values described above. For example, in some aspects, the disclosed herein single nonlinear optical crystal exhibits |d_{eff,II}|=at φ=45° of greater than about 70 pm/V to about 80 pm/V (e.g., from about 71 pm/V to about 79 pm/V, from about 72 pm/V to about 78 pm/V, from about 73 pm/V to about 77 pm/V, from about 74 pm/V to about 76 pm/V, from about 70 pm/V to about 75 pm/V, from about 71 pm/V to about 74 pm/V, from about 72 pm/V to about 73 pm/V, from about 75 pm/V to about 80 pm/V, from about 76 pm/V to about 79 pm/V, from about 77 pm/V to about 78 pm/V) at a fundamental wavelength of 3.5 μm.

In still further aspects, the single nonlinear optical crystal Mg—IV—V₂ is uniaxial. In still further aspects, the single nonlinear optical crystal of Mg—IV—V₂ exhibits a substantially single phase. In such aspects, the single nonlinear optical crystal is substantially free of impurities. It is understood that if impurities are present, they can be defined as Mg—P phase impurity, Si—P phase impurity Mg—Si phase impurity, Mg phase impurity or Si phase impurity. In yet still further aspects, the impurity can comprise Mg₃P₂ phase impurity. In yet still further aspects, the impurity can comprise SiP phase impurity.

In some aspects, if the impurities are present, they can be present in an amount of about 10 wt % or less (e.g., about 9 wt % or less, about 8 wt % or less, about 7 wt % or less, about 6 wt % or less, about 5 wt % or less, about 4 wt % or less, about 3 wt % or less, about 2 wt % or less, about 1 wt % or less, about 0.5 wt % or less, about 0.1 wt % or less, about 0.05 wt % or less, about 0.01 wt % or less). In some aspects, if the impurities are present, they can be present in an amount of about 0.01 wt % or more (e.g., about 0.05 wt % or more, about 0.1 wt % or more, about 0.5 wt % or more, about 1 wt % or more, about 2 wt % or more, about 3 wt % or more, about 4 wt % or more, about 5 wt % or more, about 6 wt % or more, about 7 wt % or more, about 8 wt % or more, about 9 wt % or more, about 10 wt % or more). If the impurities are present, they can be present in an amount ranging from any of the minimum values described above to any of the maximum values described above. For example, in some aspects, if the impurities are present, they can be present in an amount of from about 0.01 wt % to about 10 wt % (e.g., from about 0.05 wt % to about 9 wt %, from about 0.1 wt % to about 8 wt %, from about 0.5 wt % to about 7 wt %, from about 1 wt % to about 6 wt %, from about 2 wt % to about 5 wt %, from about 3 wt % to about 4 wt %, from about 0.01 wt % to about 4 wt %, from about 0.05 wt % to about 3 wt %, from about 0.1 wt % to about 2 wt %, from about 0.5 wt % to about 1 wt %, from about 3 wt % to about 10 wt %, from about 4 wt % to about 9 wt %, from about 5 wt % to about 8 wt %, from about 6 wt % to about 7 wt %).

In still further aspects disclosed herein is an optical parametric oscillator comprising any of the disclosed herein single nonlinear optical crystals. The optical parametric oscillators (OPO) are light sources that use the optical gain in a nonlinear optical medium. The OPOs have two key components: a nonlinear optical crystal and an optical resonator. Any of the disclosed herein nonlinear optical crystals can be present. When traveling through the nonlinear optical crystals of the present disclosure, a pump laser light of frequency ωp can be converted into two waves-signal and idler with lower frequency of ωs and ωi via the second-order NLO effect such that ωp=ωs+ωi. The frequencies of these two waves are dependent on the phase-matching conditions of disclosed herein nonlinear optical crystals and, therefore, can be tuned in a broad spectral range by changing the phase-matching conditions through changing the temperature or orientation of the disclosed herein nonlinear optical crystals.

In certain aspects, the optical parametric oscillator can comprise a pump laser source having a pump beam. In some aspects, the pump beam is about 1.1 μm or more (e.g., about 1.2 μm or more, about 1.5 μm or more, about 1.7 μm or more, about 2 μm or more, about 2.2 μm or more, about 2.5 μm or more, about 2.7 μm or more, about 3 μm or more, about 3.2 μm or more, about 3.5 μm or more, about 3.7 μm or more, about 4 μm or more). In some aspects, the pump beam is about 4 μm or less (e.g., about 3.7 μm or less, about 3.5 μm or less, about 3.2 μm or less, about 3 μm or less, about 2.7 μm or less, about 2.5 μm or less, about 2.2 μm or less, about 2 μm or less, about 1.7 μm or less, about 1.5 μm or less, about 1.2 μm or less, about 1.1 μm or less). The pump beam can range from any of the minimum values described above to any of the maximum values described above. For example, in some aspects, the pump beam is in a range of from about 1.1 μm to about 4 μm (e.g., from about 1.2 μm to about 3.7 μm, from about 1.5 μm to about 3.5 μm, from about 1.7 μm to about 3.2 μm, from about 2 μm to about 3 μm, from about 2.2 μm to about 2.7 μm, from about 1.1 μm to about 2.5 μm, from about 1.2 μm to about 2.2 μm, from about 1.5 μm to about 2 μm, from about 2.5 μm to about 4 μm, from about 2.7 μm to about 3.7 μm, from about 3 μm to about 3.5 μm). In such exemplary aspects, the pump laser source is a liquid laser, gas laser, or semiconductor laser. Yet, in other aspects, the pump laser source can be a pulse laser or a continuous laser.

In still further aspects, the optical parametric oscillator can comprise an optical resonator comprising a plurality of mirrors. In such aspects, the plurality of mirrors can be arranged in a way that a beam can circulate in a closed path. Any of the disclosed herein nonlinear optical crystals can be placed in the optical resonator, which will resonate the signal and/or idler wave(s). This allows the resonating wave(s) to oscillate in the resonator, compensating for any losses the wave(s) experience. The OPOs have many technical applications. For example, they are used in spectroscopy, especially in the mid-infrared and far-infrared wavelengths, which are challenging to produce by lasers.

### Methods

Also disclosed herein are the methods of forming the disclosed herein single nonlinear optical crystals. In such aspects, the method comprises a step of providing a solution comprising a solute comprising a mixture of Mg, IV and V in a molar ratio from about 0.95:0.95:2 to about 1.05:1.05:2 and a solvent.

In some aspects, the solute comprises a mixture of Mg, IV, and V in a molar ratio of about 0.95:0.95:2 or more (e.g., about 0.96:0.96:2 or more, about 0.97:0.97:2 or more, about 0.98:0.98:2 or more, about 0.99:0.99:2 or more, about 1:1:2 or more, about 1.01:1.01:2 or more, about 1.02:1.02:2 or more, about 1.03:1.03:2 or more, about 1.04:1.04:2 or more, about 1.05:1.05:2 or more). In some aspects, the solute comprises a mixture of Mg, IV, and V in a molar ratio of about 1.05:1.05:2 or less (e.g., about 1.04:1.04:2 or less, about 1.03:1.03:2 or less, about 1.02:1.02:2 or less, about 1.01:1.01:2 or less, about 1:1:2 or less, about 0.99:0.99:2 or less, about 0.98:0.98:2 or less, about 0.97:0.97:2 or less, about 0.96:0.96:2 or less, about 0.95:0.95:2 or less). The solute can comprise a mixture of Mg, IV, and V in a molar ratio ranging from any of the minimum values described above to any of the maximum values described above. For example, in some aspects, the solute comprises a mixture of Mg, IV, and V in a molar ratio of from about 0.95:0.95:2 to about 1.05:1.05:2 (e.g., from about 0.96:0.96:2 to about 1.04:1.04:2, from about 0.97:0.97:2 to about 1.03:1.03:2, from about 0.98:0.98:2 to about 1.02:1.02:2, from about 0.99:0.99:2 to about 1.01:1.01:2, from about 1.01:1.01:2 to about 0.99:0.99:2, from about 1.02:1.02:2 to about 0.98:0.98:2, from about 1.03:1.03:2 to about 0.97:0.97:2, from about 1.04:1.04:2 to about 0.96:0.96:2, from about 1.05:1.05:2 to about 0.95:0.95:2, from about 0.95:0.95:2 to about 1:1:2, from about 0.96:0.96:2 to about 0.99:0.99:2, from about 0.97:0.97:2 to about 0.98:0.98:2, from about 1.01:1.01:2 to about 1.04:1.04:2, from about 1.02:1.02:2 to about 1.03:1.03:2, from about 1.05:1.05:2 to about 1:1:2).

In some aspects, a mass ratio between the solvent and solute is about 4:1 or more (e.g., about 5:1 or more, about 6:1 or more, about 7:1 or more, about 8:1 or more, about 9:1 or more, about 10:1 or more). In some aspects, a mass ratio between the solvent and solute is about 10:1 or less (e.g., about 9:1 or less, about 8:1 or less, about 7:1 or less, about 6:1 or less, about 5:1 or less, about 4:1 or less). A mass ratio between the solvent and solute can range from any of the minimum values described above to any of the maximum values described above. For example, in some aspects, a mass ratio between the solvent and solute is from about 4:1 to about 10:1 (e.g., from about 5:1 to about 9:1, from about 6:1 to about 8:1, from about 4:1 to about 7:1, from about 5:1 to about 6:1, from about 7:1 to about 10:1, from about 8:1 to about 9:1).

In still further aspects, the method comprises a step of growing a crystalline composition comprising Mg—IV—V₂ at a first temperature for a first predetermined time. In some aspects, the first temperature is about 950° C. or more (e.g., about 960° C. or more, about 970° C. or more, about 980° C. or more, about 990° C. or more, about 1,000° C. or more, about 1,010° C. or more, about 1,020° C. or more, about 1,030° C. or more, about 1,040° C. or more, about 1,050° C. or more, about 1,060° C. or more, about 1,070° C. or more, about 1,080° C. or more, about 1,090° C. or more, about 1,100° C. or more, about 1,110° C. or more, about 1,120° C. or more, about 1,130° C. or more, about 1,140° C. or more, about 1,150° C. or more, about 1,160° C. or more, about 1,170° C. or more, about 1,180° C. or more, about 1,190° C. or more, about 1,200° C. or more). In some aspects, the first temperature is about 1,200° C. or less (e.g., about 1,190° C. or less, about 1,180° C. or less, about 1,170° C. or less, about 1,160° C. or less, about 1,150° C. or less, about 1,140° C. or less, about 1,130° C. or less, about 1,120° C. or less, about 1,110° C. or less, about 1,100° C. or less, about 1,090° C. or less, about 1,080° C. or less, about 1,070° C. or less, about 1,060° C. or less, about 1,050° C. or less, about 1,040° C. or less, about 1,030° C. or less, about 1,020° C. or less, about 1,010° C. or less, about 1,000° C. or less, about 990° C. or less, about 980° C. or less, about 970° C. or less, about 960° C. or less, about 950° C. or less). The first temperature can range from any of the minimum values described above to any of the maximum values described above. For example, in some aspects, the first temperature is from about 950° C. to about 1,200° C. (e.g., from about 960° C. to about 1,190° C., from about 970° C. to about 1,180° C., from about 980° C. to about 1,170° C., from about 990° C. to about 1,160° C., from about 1,000° C. to about 1,150° C., from about 1,010° C. to about 1,140° C., from about 1,020° C. to about 1,130° C., from about 1,030° C. to about 1,120° C., from about 1,040° C. to about 1,110° C., from about 1,050° C. to about 1,100° C., from about 1,060° C. to about 1,090° C., from about 1,070° C. to about 1,080° C., from about 950° C. to about 1,080° C., from about 960° C. to about 1,070° C., from about 970° C. to about 1,060° C., from about 980° C. to about 1,050° C., from about 990° C. to about 1,040° C., from about 1,000° C. to about 1,030° C., from about 1,010° C. to about 1,020° C., from about 1,070° C. to about 1,200° C., from about 1,080° C. to about 1,190° C., from about 1,090° C. to about 1,180° C., from about 1,100° C. to about 1,170° C., from about 1,110° C. to about 1,160° C., from about 1,120° C. to about 1,150° C., from about 1,130° C. to about 1,140° C.).

In some aspects, the first predetermined time is about 30 hours or more (e.g., about 32 hours or more, about 35 hours or more, about 38 hours or more, about 40 hours or more, about 42 hours or more, about 45 hours or more, about 46 hours or more, about 50 hours or more, about 52 hours or more, about 55 hours or more, about 58 hours or more, about 60 hours or more). In some aspects, the first predetermined time is about 60 hours or less (e.g., about 58 hours or less, about 55 hours or less, about 52 hours or less, about 50 hours or less, about 46 hours or less, about 45 hours or less, about 42 hours or less, about 40 hours or less, about 38 hours or less, about 35 hours or less, about 32 hours or less, about 30 hours or less). The first predetermined time can range from any of the minimum values described above to any of the maximum values described above. For example, in some aspects, the first predetermined time is from about 30 hours to about 60 hours (e.g., from about 32 hours to about 58 hours, from about 35 hours to about 55 hours, from about 38 hours to about 52 hours, from about 40 hours to about 50 hours, from about 42 hours to about 46 hours, from about 30 hours to about 45 hours, from about 32 hours to about 42 hours, from about 35 hours to about 40 hours, from about 45 hours to about 60 hours, from about 46 hours to about 58 hours, from about 50 hours to about 55 hours).

In still further aspects, the methods further comprise centrifugally separating the solvent to form a single nonlinear optical crystal of Mg—IV—V₂. In some aspects, the single nonlinear optical crystal has a size of about 0.01 mm or more (e.g., about 0.05 mm or more, about 0.1 mm or more, about 0.5 mm or more, about 1 mm or more, about 1.5 mm or more, about 2 mm or more, about 2.5 mm or more, about 3 mm or more, about 3.5 mm or more, about 4 mm or more, about 4.5 mm or more, about 5 mm or more, about 5.5 mm or more, about 6 mm or more, about 6.5 mm or more, about 7 mm or more, about 7.5 mm or more, about 8 mm or more, about 8.5 mm or more, about 9 mm or more, about 9.5 mm or more, about 10 mm or more) in length. In some aspects, the single nonlinear optical crystal has a size of about 10 mm or less (e.g., about 9.5 mm or less, about 9 mm or less, about 8.5 mm or less, about 8 mm or less, about 7.5 mm or less, about 7 mm or less, about 6.5 mm or less, about 6 mm or less, about 5.5 mm or less, about 5 mm or less, about 4.5 mm or less, about 4 mm or less, about 3.5 mm or less, about 3 mm or less, about 2.5 mm or less, about 2 mm or less, about 1.5 mm or less, about 1 mm or less, about 0.5 mm or less, about 0.1 mm or less, about 0.05 mm or less, about 0.01 mm or less) in length. The single nonlinear optical crystal can have a size ranging from any of the minimum values described above to any of the maximum values described above. For example, in some aspects, the single nonlinear optical crystal has a size of from about 0.01 mm to about 10 mm (e.g., from about 0.05 mm to about 9.5 mm, from about 0.1 mm to about 9 mm, from about 0.5 mm to about 8.5 mm, from about 1 mm to about 8 mm, from about 1.5 mm to about 7.5 mm, from about 2 mm to about 7 mm, from about 2.5 mm to about 6.5 mm, from about 3 mm to about 6 mm, from about 3.5 mm to about 5.5 mm, from about 4 mm to about 5 mm, from about 0.01 mm to about 4.5 mm, from about 0.05 mm to about 4 mm, from about 0.1 mm to about 3.5 mm, from about 0.5 mm to about 3 mm, from about 1 mm to about 2.5 mm, from about 1.5 mm to about 2 mm, from about 4.5 mm to about 10 mm, from about 5 mm to about 9.5 mm, from about 5.5 mm to about 9 mm, from about 6 mm to about 8.5 mm, from about 6.5 mm to about 8 mm, from about 7 mm to about 7.5 mm) in length.

In some aspects, the single nonlinear optical crystal is substantially free of a solvent residue.

In still further aspects, the solution is cooled down prior to centrifugally separating the solvent. In some aspects, the solution is cooled down to a temperature of about 640° C. or more (e.g., about 650° C. or more, about 660° C. or more, about 670° C. or more, about 680° C. or more, about 690° C. or more, about 700° C. or more, about 710° C. or more, about 720° C. or more, about 730° C. or more, about 740° C. or more, about 750° C. or more, about 760° C. or more, about 770° C. or more, about 780° C. or more, about 790° C. or more, about 800° C. or more, about 810° C. or more, about 820° C. or more, about 830° C. or more, about 840° C. or more, about 850° C. or more, about 860° C. or more, about 870° C. or more, about 880° C. or more, about 890° C. or more, about 900° C. or more, about 910° C. or more, about 920° C. or more, about 930° C. or more, about 940° C. or more, about 950° C. or more, about 960° C. or more, about 970° C. or more, about 980° C. or more, about 990° C. or more, about 1,000° C. or more). In some aspects, the solution is cooled down to a temperature of about 1,000° C. or less (e.g., about 990° C. or less, about 980° C. or less, about 970° C. or less, about 960° C. or less, about 950° C. or less, about 940° C. or less, about 930° C. or less, about 920° C. or less, about 910° C. or less, about 900° C. or less, about 890° C. or less, about 880° C. or less, about 870° C. or less, about 860° C. or less, about 850° C. or less, about 840° C. or less, about 830° C. or less, about 820° C. or less, about 810° C. or less, about 800° C. or less, about 790° C. or less, about 780° C. or less, about 770° C. or less, about 760° C. or less, about 750° C. or less, about 740° C. or less, about 730° C. or less, about 720° C. or less, about 710° C. or less, about 700° C. or less, about 690° C. or less, about 680° C. or less, about 670° C. or less, about 660° C. or less, about 650° C. or less, about 640° C. or less). The solution can be cooled down to a temperature ranging from any of the minimum values described above to any of the maximum values described above. For example, in some aspects, the solution is cooled down to a temperature of from about 640° C. to about 1,000° C. (e.g., from about 650° C. to about 990° C., from about 660° C. to about 980° C., from about 670° C. to about 970° C., from about 680° C. to about 960° C., from about 690° C. to about 950° C., from about 700° C. to about 940° C., from about 710° C. to about 930° C., from about 720° C. to about 920° C., from about 730° C. to about 910° C., from about 740° C. to about 900° C., from about 750° C. to about 890° C., from about 760° C. to about 880° C., from about 770° C. to about 870° C., from about 780° C. to about 860° C., from about 790° C. to about 850° C., from about 800° C. to about 840° C., from about 810° C. to about 830° C., from about 640° C. to about 820° C., from about 650° C. to about 810° C., from about 660° C. to about 800° C., from about 670° C. to about 790° C., from about 680° C. to about 780° C., from about 690° C. to about 770° C., from about 700° C. to about 760° C., from about 710° C. to about 750° C., from about 720° C. to about 740° C., from about 820° C. to about 1000° C., from about 830° C. to about 990° C., from about 840° C. to about 980° C., from about 850° C. to about 970° C., from about 860° C. to about 960° C., from about 870° C. to about 950° C., from about 880° C. to about 940° C., from about 890° C. to about 930° C., from about 900° C. to about 920° C.).

In such aspects, the cool-down process can be done at any acceptable rate. In some aspects, the cool down rate is about 0.5° C./h or more (e.g., about 1° C./h or more, about 2° C./h or more, about 3° C./h or more, about 4° C./h or more, about 5° C./h or more, about 6° C./h or more, about 7° C./h or more, about 8° C./h or more, about 9° C./h or more, about 10° C./h or more, about 11° C./h or more, about 12° C./h or more, about 13° C./h or more, about 14° C./h or more, about 15° C./h or more, about 16° C./h or more, about 17° C./h or more, about 18° C./h or more, about 19° C./h or more, about 20° C./h or more, about 21° C./h or more, about 22° C./h or more, about 23° C./h or more, about 24° C./h or more, about 25° C./h or more, about 26° C./h or more, about 27° C./h or more, about 28° C./h or more, about 29° C./h or more, about 30° C./h or more, about 31° C./h or more, about 32° C./h or more, about 33° C./h or more, about 34° C./h or more, about 35° C./h or more). In some aspects, the cool down rate is about 35° C./h or less (e.g., about 34° C./h or less, about 33° C./h or less, about 32° C./h or less, about 31° C./h or less, about 30° C./h or less, about 29° C./h or less, about 28° C./h or less, about 27° C./h or less, about 26° C./h or less, about 25° C./h or less, about 24° C./h or less, about 23° C./h or less, about 22° C./h or less, about 21° C./h or less, about 20° C./h or less, about 19° C./h or less, about 18° C./h or less, about 17° C./h or less, about 16° C./h or less, about 15° C./h or less, about 14° C./h or less, about 13° C./h or less, about 12° C./h or less, about 11° C./h or less, about 10° C./h or less, about 9° C./h or less, about 8° C./h or less, about 7° C./h or less, about 6° C./h or less, about 5° C./h or less, about 4° C./h or less, about 3° C./h or less, about 2° C./h or less, about 1° C./h or less, about 0.5° C./h or less). The cool down rate can range from any of the minimum values described above to any of the maximum values described above. For example, in some aspects, the cool down rate is from about 0.5° C./h to about 35° C./h (e.g., from about 1° C./h to about 34° C./h, from about 2° C./h to about 33° C./h, from about 3° C./h to about 32° C./h, from about 4° C./h to about 31° C./h, from about 5° C./h to about 30° C./h, from about 6° C./h to about 29° C./h, from about 7° C./h to about 28° C./h, from about 8° C./h to about 27° C./h, from about 9° C./h to about 26° C./h, from about 10° C./h to about 25° C./h, from about 11° C./h to about 24° C./h, from about 12° C./h to about 23° C./h, from about 13° C./h to about 22° C./h, from about 14° C./h to about 21° C./h, from about 15° C./h to about 20° C./h, from about 16° C./h to about 19° C./h, from about 17° C./h to about 18° C./h, from about 0.5° C./h to about 18° C./h, from about 1° C./h to about 17° C./h, from about 2° C./h to about 16° C./h, from about 3° C./h to about 15° C./h, from about 4° C./h to about 14° C./h, from about 5° C./h to about 13° C./h, from about 6° C./h to about 12° C./h, from about 7° C./h to about 11° C./h, from about 8° C./h to about 10° C./h, from about 17° C./h to about 35° C./h, from about 18° C./h to about 34° C./h, from about 19° C./h to about 33° C./h, from about 20° C./h to about 32° C./h, from about 21° C./h to about 31° C./h, from about 22° C./h to about 30° C./h, from about 23° C./h to about 29° C./h, from about 24° C./h to about 28° C./h, from about 25° C./h to about 27° C./h).

In still further aspects, the step of centrifugally separating is performed at a second temperature and a speed of about 1,300 to about 1,500 rpm for a second predetermined time of about 1 min to about 15 min. In some aspects, the second temperature is about 650° C. or more (e.g., about 660° C. or more, about 670° C. or more, about 680° C. or more, about 690° C. or more, about 700° C. or more, about 710° C. or more, about 720° C. or more, about 730° C. or more, about 740° C. or more, about 750° C. or more, about 760° C. or more, about 770° C. or more, about 780° C. or more, about 790° C. or more, about 800° C. or more, about 810° C. or more, about 820° C. or more, about 830° C. or more, about 840° C. or more, about 850° C. or more, about 860° C. or more, about 870° C. or more, about 880° C. or more, about 890° C. or more, about 900° C. or more, about 910° C. or more, about 920° C. or more, about 930° C. or more, about 940° C. or more, about 950° C. or more, about 960° C. or more, about 970° C. or more, about 980° C. or more, about 990° C. or more, about 1000° C. or more). In some aspects, the second temperature is about 1000° C. or less (e.g., about 990° C. or less, about 980° C. or less, about 970° C. or less, about 960° C. or less, about 950° C. or less, about 940° C. or less, about 930° C. or less, about 920° C. or less, about 910° C. or less, about 900° C. or less, about 890° C. or less, about 880° C. or less, about 870° C. or less, about 860° C. or less, about 850° C. or less, about 840° C. or less, about 830° C. or less, about 820° C. or less, about 810° C. or less, about 800° C. or less, about 790° C. or less, about 780° C. or less, about 770° C. or less, about 760° C. or less, about 750° C. or less, about 740° C. or less, about 730° C. or less, about 720° C. or less, about 710° C. or less, about 700° C. or less, about 690° C. or less, about 680° C. or less, about 670° C. or less, about 660° C. or less, about 650° C. or less). The second temperature can range from any of the minimum values described above to any of the maximum values described above. For example, in some aspects, the second temperature is from about 650° C. to about 1000° C. (e.g., from about 660° C. to about 990° C., from about 670° C. to about 980° C., from about 680° C. to about 970° C., from about 690° C. to about 960° C., from about 700° C. to about 950° C., from about 710° C. to about 940° C., from about 720° C. to about 930° C., from about 730° C. to about 920° C., from about 740° C. to about 910° C., from about 750° C. to about 900° C., from about 760° C. to about 890° C., from about 770° C. to about 880° C., from about 780° C. to about 870° C., from about 790° C. to about 860° C., from about 800° C. to about 850° C., from about 810° C. to about 840° C., from about 820° C. to about 830° C., from about 650° C. to about 830° C., from about 660° C. to about 820° C., from about 670° C. to about 810° C., from about 680° C. to about 800° C., from about 690° C. to about 790° C., from about 700° C. to about 780° C., from about 710° C. to about 770° C., from about 720° C. to about 760° C., from about 730° C. to about 750° C., from about 820° C. to about 1000° C., from about 830° C. to about 990° C., from about 840° C. to about 980° C., from about 850° C. to about 970° C., from about 860° C. to about 960° C., from about 870° C. to about 950° C., from about 880° C. to about 940° C., from about 890° C. to about 930° C., from about 900° C. to about 920° C.).

In some aspects, the speed of a centrifuge used to separate the solute from the solution is about 1,300 rpm or more (e.g., about 1,310 rpm or more, about 1,320 rpm or more, about 1,330 rpm or more, about 1,340 rpm or more, about 1,350 rpm or more, about 1,360 rpm or more, about 1,370 rpm or more, about 1,380 rpm or more, about 1,390 rpm or more, about 1,400 rpm or more, about 1,410 rpm or more, about 1,420 rpm or more, about 1,430 rpm or more, about 1,440 rpm or more, about 1,450 rpm or more, about 1,460 rpm or more, about 1,470 rpm or more, about 1,480 rpm or more, about 1,490 rpm or more, about 1,500 rpm or more. In some aspects, the speed of a centrifuge used to separate the solute from the solution is about 1,500 rpm or less (e.g., about 1,490 rpm or less, about 1,480 rpm or less, about 1,470 rpm or less, about 1,460 rpm or less, about 1,450 rpm or less, about 1,440 rpm or less, about 1,430 rpm or less, about 1,420 rpm or less, about 1,410 rpm or less, about 1,400 rpm or less, about 1,390 rpm or less, about 1,380 rpm or less, about 1,370 rpm or less, about 1,360 rpm or less, about 1,350 rpm or less, about 1,340 rpm or less, about 1,330 rpm or less, about 1,320 rpm or less, about 1,310 rpm or less, about 1,300 rpm or less). The speed of a centrifuge used to separate the solute from the solution can range from any of the minimum values described above to any of the maximum values described above. For example, in some aspects, the speed of a centrifuge used to separate the solute from the solution is from about 1,300 rpm to about 1,500 rpm (e.g., from about 1,310 rpm to about 1,490 rpm, from about 1,320 rpm to about 1,480 rpm, from about 1,330 rpm to about 1,470 rpm, from about 1,340 rpm to about 1,460 rpm, from about 1,350 rpm to about 1,450 rpm, from about 1,360 rpm to about 1,440 rpm, from about 1,370 rpm to about 1,430 rpm, from about 1,380 rpm to about 1,420 rpm, from about 1,390 rpm to about 1,410 rpm, from about 1,300 rpm to about 1,400 rpm, from about 1,310 rpm to about 1,390 rpm, from about 1,320 rpm to about 1,380 rpm, from about 1,330 rpm to about 1,370 rpm, from about 1,340 rpm to about 1,360 rpm, from about 1,400 rpm to about 1,500 rpm, from about 1,410 rpm to about 1,490 rpm, from about 1,420 rpm to about 1,480 rpm, from about 1,430 rpm to about 1,470 rpm, from about 1,440 rpm to about 1,460 rpm).

In some aspects, the second predetermined time is about 1 min or more (e.g., about 2 min or more, about 3 min or more, about 4 min or more, about 5 min or more, about 6 min or more, about 7 min or more, about 8 min or more, about 9 min or more, about 10 min or more, about 11 min or more, about 12 min or more, about 13 min or more, about 14 min or more, about 15 min or more). In some aspects, the second predetermined time is about 15 min or less (e.g., about 14 min or less, about 13 min or less, about 12 min or less, about 11 min or less, about 10 min or less, about 9 min or less, about 8 min or less, about 7 min or less, about 6 min or less, about 5 min or less, about 4 min or less, about 3 min or less, about 2 min or less, about 1 min or less). The second predetermined time can range from any of the minimum values described above to any of the maximum values described above. For example, in some aspects, the second predetermined time is from about 1 min to about 15 min (e.g., from about 2 min to about 14 min, from about 3 min to about 13 min, from about 4 min to about 12 min, from about 5 min to about 11 min, from about 6 min to about 10 min, from about 7 min to about 9 min, from about 1 min to about 8 min, from about 2 min to about 7 min, from about 3 min to about 6 min, from about 4 min to about 5 min, from about 8 min to about 15 min, from about 9 min to about 14 min, from about 10 min to about 13 min, from about 11 min to about 12 min). It is understood that if needed, the second predetermined time can be greater than 15 min, for example, and without limitations, it can be about 20 min, about 30 min, about 1 h, or even about 5 hours if needed.

In some aspects, the second predetermined time is about 1 min or more (e.g., about 1.1 min or more, about 1.2 min or more, about 1.3 min or more, about 1.4 min or more, about 1.5 min or more, about 1.6 min or more, about 1.7 min or more, about 1.8 min or more, about 1.9 min or more, about 2 min or more, about 2.1 min or more, about 2.2 min or more, about 2.3 min or more, about 2.4 min or more, about 2.5 min or more, about 2.6 min or more, about 2.7 min or more, about 2.8 min or more, about 2.9 min or more, about 3 min or more, about 3.1 min or more, about 3.2 min or more, about 3.3 min or more, about 3.4 min or more, about 3.5 min or more, about 3.6 min or more, about 3.7 min or more, about 3.8 min or more, about 3.9 min or more, about 4 min or more, about 4.1 min or more, about 4.2 min or more, about 4.3 min or more, about 4.4 min or more, about 4.5 min or more, about 4.6 min or more, about 4.7 min or more, about 4.8 min or more, about 4.9 min or more, about 5 min or more). In some aspects, the second predetermined time is about 5 min or less (e.g., about 4.9 min or less, about 4.8 min or less, about 4.7 min or less, about 4.6 min or less, about 4.5 min or less, about 4.4 min or less, about 4.3 min or less, about 4.2 min or less, about 4.1 min or less, about 4 min or less, about 3.9 min or less, about 3.8 min or less, about 3.7 min or less, about 3.6 min or less, about 3.5 min or less, about 3.4 min or less, about 3.3 min or less, about 3.2 min or less, about 3.1 min or less, about 3 min or less, about 2.9 min or less, about 2.8 min or less, about 2.7 min or less, about 2.6 min or less, about 2.5 min or less, about 2.4 min or less, about 2.3 min or less, about 2.2 min or less, about 2.1 min or less, about 2 min or less, about 1.9 min or less, about 1.8 min or less, about 1.7 min or less, about 1.6 min or less, about 1.5 min or less, about 1.4 min or less, about 1.3 min or less, about 1.2 min or less, about 1.1 min or less, about 1 min or less). The second predetermined time can range from any of the minimum values described above to any of the maximum values described above. For example, in some aspects, the second predetermined time is from about 1 min to about 5 min (e.g., from about 1.1 min to about 4.9 min, from about 1.2 min to about 4.8 min, from about 1.3 min to about 4.7 min, from about 1.4 min to about 4.6 min, from about 1.5 min to about 4.5 min, from about 1.6 min to about 4.4 min, from about 1.7 min to about 4.3 min, from about 1.8 min to about 4.2 min, from about 1.9 min to about 4.1 min, from about 2 min to about 4 min, from about 2.1 min to about 3.9 min, from about 2.2 min to about 3.8 min, from about 2.3 min to about 3.7 min, from about 2.4 min to about 3.6 min, from about 2.5 min to about 3.5 min, from about 2.6 min to about 3.4 min, from about 2.7 min to about 3.3 min, from about 2.8 min to about 3.2 min, from about 2.9 min to about 3.1 min, from about 1 min to about 3 min, from about 1.1 min to about 2.9 min, from about 1.2 min to about 2.8 min, from about 1.3 min to about 2.7 min, from about 1.4 min to about 2.6 min, from about 1.5 min to about 2.5 min, from about 1.6 min to about 2.4 min, from about 1.7 min to about 2.3 min, from about 1.8 min to about 2.2 min, from about 1.9 min to about 2.1 min, from about 3 min to about 5 min, from about 3.1 min to about 4.9 min, from about 3.2 min to about 4.8 min, from about 3.3 min to about 4.7 min, from about 3.4 min to about 4.6 min, from about 3.5 min to about 4.5 min, from about 3.6 min to about 4.4 min, from about 3.7 min to about 4.3 min, from about 3.8 min to about 4.2 min, from about 3.9 min to about 4.1 min).

In still further aspects, the solvent can comprise Sn or Sb. In yet still in further aspects, the solvent comprises Sb. In yet still further aspects, the solvent comprises Sn. In yet still further aspects, the solvent comprises a combination of Sb and Sn.

In still further aspects, the solution used in this method is formed by mixing Mg, IV and V and the solvent, optionally provided in a powdered form, and heating to a temperature sufficient to homogeneously mix the solute and solvent. In still further aspects, the single nonlinear optical crystal Mg—IV—V₂ grows along [111] direction.

In still further aspects, the formed single nonlinear optical crystal Mg—IV—V₂ is uniaxial. In still further aspects, the formed single nonlinear optical crystal of Mg—IV-V₂ exhibits a substantially single phase. In such aspects, the single nonlinear optical crystal is substantially free of impurities. It is understood that if impurities are present, they can be defined as Mg—P phase impurity, Si—P phase impurity Mg—Si phase impurity, Mg phase impurity or Si phase impurity. In yet still further aspects, the impurity can comprise Mg₃P₂ phase impurity. In yet still further aspects, the impurity can comprise SiP phase impurity.

In some aspects, if the impurities are present, they can be present in an amount of about 10 wt % or less (e.g., about 9 wt % or less, about 8 wt % or less, about 7 wt % or less, about 6 wt % or less, about 5 wt % or less, about 4 wt % or less, about 3 wt % or less, about 2 wt % or less, about 1 wt % or less, about 0.5 wt % or less, about 0.1 wt % or less, about 0.05 wt % or less, about 0.01 wt % or less). In some aspects, if the impurities are present, they can be present in an amount of about 0.01 wt % or more (e.g., about 0.05 wt % or more, about 0.1 wt % or more, about 0.5 wt % or more, about 1 wt % or more, about 2 wt % or more, about 3 wt % or more, about 4 wt % or more, about 5 wt % or more, about 6 wt % or more, about 7 wt % or more, about 8 wt % or more, about 9 wt % or more, about 10 wt % or more). If the impurities are present, they can be present in an amount ranging from any of the minimum values described above to any of the maximum values described above. For example, in some aspects, if the impurities are present, they can be present in an amount of from about 0.01 wt % to about 10 wt % (e.g., from about 0.05 wt % to about 9 wt %, from about 0.1 wt % to about 8 wt %, from about 0.5 wt % to about 7 wt %, from about 1 wt % to about 6 wt %, from about 2 wt % to about 5 wt %, from about 3 wt % to about 4 wt %, from about 0.01 wt % to about 4 wt %, from about 0.05 wt % to about 3 wt %, from about 0.1 wt % to about 2 wt %, from about 0.5 wt % to about 1 wt %, from about 3 wt % to about 10 wt %, from about 4 wt % to about 9 wt %, from about 5 wt % to about 8 wt %, from about 6 wt % to about 7 wt %).

In yet still further aspects, the single nonlinear optical crystal formed by the disclosed methods exhibits any of the disclosed above properties.

In still further aspects, the disclosed herein single nonlinear optical crystals can be formed by additional methods. For example, and without limitations, the disclosed herein single nonlinear optical crystal can be formed according to Bridgman methods or float-zone methods.

In still further aspects, the method of forming the disclosed herein single nonlinear optical crystal can comprise a) sealing a polycrystalline material, comprising a Mg—IV—V₂ compound in a temperature resistant container; b) placing the temperature resistant container in a rocking furnace; c) heating the polycrystalline material to a third temperature at a rate of about 45° C./h to about 120° C./h and keeping the polycrystalline material at the third temperature for a first predetermined time; d) placing the temperature-resistant container in a three-zone furnace, wherein the three-zone furnace exhibits a temperature profile defined by an upper/melt zone temperature, a middle/crystallization zone temperature; and a lower/annealing zone temperature; e) translating the temperature-resistant container vertically or horizontally, thereby allowing the temperature-resistant container to arrive at a nucleating temperature to form a seeding crystal; f) growing an ingot material from the seeding crystal; g) annealing the ingot material to a temperature of about 700° C. to about 850° C. for a fourth predetermined time; and h) forming the single nonlinear optical crystal Mg—IV—V₂, wherein the crystal is substantially free of impurities, defined by a single phase and has a size from about 0.1 mm to about 10 cm in length.

In still further aspects, step a) can further comprise sealing the polycrystalline material and an excess of V in a temperature resistant container, for example, to suppress decomposition of the polycrystalline material. For example, and without limitations, if the polycrystalline material comprises MgSiP₂, step a) can further comprise sealing the polycrystalline material and an excess of P in a temperature resistant container.

In some aspects, the solute comprises a mixture of Mg, IV, and V in a molar ratio of about 0.95:0.95:2 or more (e.g., about 0.96:0.96:2 or more, about 0.97:0.97:2 or more, about 0.98:0.98:2 or more, about 0.99:0.99:2 or more, about 1:1:2 or more, about 1.01:1.01:2 or more, about 1.02:1.02:2 or more, about 1.03:1.03:2 or more, about 1.04:1.04:2 or more, about 1.05:1.05:2 or more). In some aspects, the solute comprises a mixture of Mg, IV, and V in a molar ratio of about 1.05:1.05:2 or less (e.g., about 1.04:1.04:2 or less, about 1.03:1.03:2 or less, about 1.02:1.02:2 or less, about 1.01:1.01:2 or less, about 1:1:2 or less, about 0.99:0.99:2 or less, about 0.98:0.98:2 or less, about 0.97:0.97:2 or less, about 0.96:0.96:2 or less, about 0.95:0.95:2 or less). The solute can comprise a mixture of Mg, IV, and V in a molar ratio ranging from any of the minimum values described above to any of the maximum values described above. For example, in some aspects, the solute comprises a mixture of Mg, IV, and V in a molar ratio of from about 0.95:0.95:2 to about 1.05:1.05:2 (e.g., from about 0.96:0.96:2 to about 1.04:1.04:2, from about 0.97:0.97:2 to about 1.03:1.03:2, from about 0.98:0.98:2 to about 1.02:1.02:2, from about 0.99:0.99:2 to about 1.01:1.01:2, from about 1.01:1.01:2 to about 0.99:0.99:2, from about 1.02:1.02:2 to about 0.98:0.98:2, from about 1.03:1.03:2 to about 0.97:0.97:2, from about 1.04:1.04:2 to about 0.96:0.96:2, from about 1.05:1.05:2 to about 0.95:0.95:2, from about 0.95:0.95:2 to about 1:1:2, from about 0.96:0.96:2 to about 0.99:0.99:2, from about 0.97:0.97:2 to about 0.98:0.98:2, from about 1.01:1.01:2 to about 1.04:1.04:2, from about 1.02:1.02:2 to about 1.03:1.03:2, from about 1.05:1.05:2 to about 1:1:2).

In some aspects, a total amount of each component is about 1 g or more (e.g., about 1.5 g or more, about 2 g or more, about 2.5 g or more, about 3 g or more, about 3.5 g or more, about 4 g or more, about 4.5 g or more, about 5 g or more). In some aspects, a total amount of each component is about 5 g or less (e.g., about 4.5 g or less, about 4 g or less, about 3.5 g or less, about 3 g or less, about 2.5 g or less, about 2 g or less, about 1.5 g or less, about 1 g or less). A total amount of each component can range from any of the minimum values described above to any of the maximum values described above. For example, in some aspects, a total amount of each component is from about 1 g to about 5 g (e.g., from about 1.5 g to about 4.5 g, from about 2 g to about 4 g, from about 2.5 g to about 3.5 g, from about 1 g to about 3 g, from about 1.5 g to about 2.5 g, from about 3 g to about 5 g, from about 3.5 g to about 4.5 g).

In yet further aspects, the polycrystalline material is ground prior to the step of sealing; and wherein grinding is performed in an inert atmosphere. Any known in the art methods of grinding can be used. For example, and without limitations, the material can be ground with mortar and pestle or by any other automatic grinding methods. In yet still further aspects, the inert atmosphere can comprise an inert gas, such as, for example, and without limitations, argon or nitrogen. In yet still further aspects, the grinding can be performed in a glove box.

In still further aspects, the ground polycrystalline material is placed into an alumina crucible which is then placed into the temperature-resistant container. In such aspects, the temperature-resistant container can be a quartz tube. It is understood that the alumina crucible can have any shape that would allow the desired outcome. Yet, in some aspects, the alumina crucible can have a tip-shaped form.

In some aspects, the third temperature is about 900° C. or more (e.g., about 950° C. or more, about 1,000° C. or more, about 1,050° C. or more, about 1,100° C. or more, about 1,150° C. or more, about 1,200° C. or more, about 1,250° C. or more, about 1,300° C. or more, about 1,350° C. or more, about 1,400° C. or more). In some aspects, the third temperature is about 1,400° C. or less (e.g., about 1,350° C. or less, about 1,300° C. or less, about 1,250° C. or less, about 1,200° C. or less, about 1,150° C. or less, about 1,100° C. or less, about 1,050° C. or less, about 1,000° C. or less, about 950° C. or less, about 900° C. or less). The third temperature can range from any of the minimum values described above to any of the maximum values described above. For example, in some aspects, the third temperature is from about 900° C. to about 1,400° C. (e.g., from about 950° C. to about 1,350° C., from about 1,000° C. to about 1,300° C., from about 1,050° C. to about 1,250° C., from about 1,100° C. to about 1,200° C., from about 900° C. to about 1,150° C., from about 950° C. to about 1,100° C., from about 1,000° C. to about 1,050° C., from about 1,150° C. to about 1,400° C., from about 1,200° C. to about 1,350° C., from about 1,250° C. to about 1,300° C.).

In some aspects, the heating is done at a rate of about 45° C./h or more (e.g., about 50° C./h or more, about 55° C./h or more, about 60° C./h or more, about 65° C./h or more, about 70° C./h or more, about 75° C./h or more, about 80° C./h or more, about 85° C./h or more, about 90° C./h or more, about 95° C./h or more, about 100° C./h or more, about 105° C./h or more, about 110° C./h or more, about 115° C./h or more, about 120° C./h or more). In some aspects, the heating is done at a rate of about 120° C./h or less (e.g., about 115° C./h or less, about 110° C./h or less, about 105° C./h or less, about 100° C./h or less, about 95° C./h or less, about 90° C./h or less, about 85° C./h or less, about 80° C./h or less, about 75° C./h or less, about 70° C./h or less, about 65° C./h or less, about 60° C./h or less, about 55° C./h or less, about 50° C./h or less, about 45° C./h or less). The heating can be done at a rate ranging from any of the minimum values described above to any of the maximum values described above. For example, in some aspects, the heating is done at a rate of from about 45° C./h to about 120° C./h (e.g., from about 50° C./h to about 115° C./h, from about 55° C./h to about 110° C./h, from about 60° C./h to about 105° C./h, from about 65° C./h to about 100° C./h, from about 70° C./h to about 95° C./h, from about 75° C./h to about 90° C./h, from about 80° C./h to about 85° C./h, from about 45° C./h to about 85° C./h, from about 50° C./h to about 80° C./h, from about 55° C./h to about 75° C./h, from about 60° C./h to about 70° C./h, from about 80° C./h to about 120° C./h, from about 85° C./h to about 115° C./h, from about 90° C./h to about 110° C./h, from about 95° C./h to about 105° C./h).

In some aspects, the third predetermined time is about 5 hours or more (e.g., about 6 hours or more, about 7 hours or more, about 8 hours or more, about 9 hours or more, about 10 hours or more, about 11 hours or more, about 12 hours or more). In some aspects, the third predetermined time is about 12 hours or less (e.g., about 11 hours or less, about 10 hours or less, about 9 hours or less, about 8 hours or less, about 7 hours or less, about 6 hours or less, about 5 hours or less). The third predetermined time can range from any of the minimum values described above to any of the maximum values described above. For example, in some aspects, the third predetermined time is from about 5 hours to about 12 hours (e.g., from about 6 hours to about 11 hours, from about 7 hours to about 10 hours, from about 8 hours to about 9 hours, from about 5 hours to about 9 hours, from about 6 hours to about 8 hours, from about 8 hours to about 12 hours, from about 9 hours to about 11 hours).

In yet still further aspects, the polycrystalline material is rocked within the rocking furnace at the third temperature to form a homogeneous mixture. In still further aspects, the method comprises obtaining a temperature profile of a three-zone Bridgman furnace. The three-zone furnace is defined by an upper/melt zone temperature, a middle/crystallization zone temperature, and a lower/annealing zone temperature.

In some aspects, the temperature profile is achieved with the required gradient temperature of about 1° C. or more (e.g., about 2° C. or more, about 3° C. or more, about 4° C. or more, about 5° C. or more, about 6° C. or more, about 7° C. or more, about 8° C. or more, about 9° C. or more, about 10° C. or more, about 11° C. or more, about 12° C. or more, about 13º° C. or more, about 14° C. or more, about 15° C. or more) at the crystallization zone. In some aspects, the temperature profile is achieved with the required gradient temperature of about 15° C. or less (e.g., about 14° C. or less, about 13° C. or less, about 12° C. or less, about 11° C. or less, about 10° C. or less, about 9° C. or less, about 8° C. or less, about 7° C. or less, about 6° C. or less, about 5° C. or less, about 4° C. or less, about 3° C. or less, about 2° C. or less, about 1° C. or less) at the crystallization zone. The temperature profile is achieved with the required gradient temperature at the crystallization zone ranging from any of the minimum values described above to any of the maximum values described above. For example, in some aspects, the temperature profile is achieved with the required gradient temperature of from about 1° C. to about 15° C. (e.g., from about 2° C. to about 14° C., from about 3° C. to about 13° C., from about 4° C. to about 12° C., from about 5° C. to about 11° C., from about 6° C. to about 10° C., from about 7° C. to about 9° C., from about 1° C. to about 8° C., from about 2° C. to about 7° C., from about 3° C. to about 6° C., from about 4° C. to about 5° C., from about 8° C. to about 15° C., from about 9° C. to about 14° C., from about 10° C. to about 13° C., from about 11° C. to about 12° C.) at the crystallization zone.

In some aspects, the upper/melt zone temperature is set to about 1,050° C. (e.g., about 1,060° C. or more, about 1,070° C. or more, about 1,080° C. or more, about 1,090° C. or more, about 1,100° C. or more, about 1,110° C. or more, about 1,120° C. or more, about 1,130° C. or more, about 1,140° C. or more, about 1,150° C. or more, about 1,160° C. or more, about 1,170° C. or more, about 1,180° C. or more, about 1,190° C. or more, about 1,200° C. or more). In some aspects, the upper/melt zone temperature is set to about 1,200° C. or less (e.g., about 1,190° C. or less, about 1,180° C. or less, about 1,170° C. or less, about 1,160° C. or less, about 1,150° C. or less, about 1,140° C. or less, about 1,130° C. or less, about 1,120° C. or less, about 1,110° C. or less, about 1,100° C. or less, about 1,090° C. or less, about 1,080° C. or less, about 1,070° C. or less, about 1,060° C. or less, about 1,050° C. or less). The upper/melt zone temperature can be set to a temperature ranging from any of the minimum values described above to any of the maximum values described above. For example, in some aspects, the upper/melt zone temperature is set to from about 1,050° C. to about 1,200° C. (e.g., from about 1,060° C. to about 1,190° C., from about 1,070° C. to about 1,180° C., from about 1,080° C. to about 1,170° C., from about 1,090° C. to about 1,160° C., from about 1,100° C. to about 1,150° C., from about 1,110° C. to about 1,140° C., from about 1,120° C. to about 1,130° C., from about 1,050° C. to about 1,130° C., from about 1,060° C. to about 1,120° C., from about 1,070° C. to about 1,110° C., from about 1,080° C. to about 1,100° C., from about 1,120° C. to about 1,200° C., from about 1,130° C. to about 1,190° C., from about 1,140° C. to about 1,180° C., from about 1,150° C. to about 1,170° C.).

In some aspects, the middle/crystallization zone temperature is set to about 950° C. or more (e.g., about 960° C. or more, about 970° C. or more, about 980° C. or more, about 990° C. or more, about 1,000° C. or more, about 1,010° C. or more, about 1,020° C. or more, about 1,030° C. or more, about 1,040° C. or more, about 1,050° C. or more, about 1,060° C. or more, about 1,070° C. or more, about 1,080° C. or more, about 1,090° C. or more, about 1,100° C. or more). In some aspects, the middle/crystallization zone temperature is set to about 1,100° C. or less (e.g., about 1,090° C. or less, about 1,080° C. or less, about 1,070° C. or less, about 1,060° C. or less, about 1,050° C. or less, about 1,040° C. or less, about 1,030° C. or less, about 1,020° C. or less, about 1,010° C. or less, about 1,000° C. or less, about 990° C. or less, about 980° C. or less, about 970° C. or less, about 960° C. or less, about 950° C. or less). The middle/crystallization zone temperature can be set to a temperature ranging from any of the minimum values described above to any of the maximum values described above. For example, in some aspects, the middle/crystallization zone temperature is set to from about 950° C. to about 1,100° C. (e.g., from about 1,000° C. to about 1,050° C., from about 1,010° C. to about 1,040° C., from about 1,020° C. to about 1,030° C., from about 1,000° C. to about 980° C., from about 1,010° C. to about 970° C., from about 1,020° C. to about 960° C., from about 1,030° C. to about 950° C., from about 1,020° C. to about 1,100° C., from about 1,030° C. to about 1,090° C., from about 1,040° C. to about 1,080° C., from about 1,050° C. to about 1,070° C.).

In some aspects, the lower/annealing zone temperature is set to about 750° C. or more (e.g., about 760° C. or more, about 770° C. or more, about 780° C. or more, about 790° C. or more, about 800° C. or more, about 810° C. or more, about 820° C. or more, about 830° C. or more, about 840° C. or more, about 850° C. or more, about 860° C. or more, about 870° C. or more, about 880° C. or more, about 890° C. or more, about 900° C. or more). In some aspects, the lower/annealing zone temperature is set to about 900° C. or less (e.g., about 890° C. or less, about 880° C. or less, about 870° C. or less, about 860° C. or less, about 850° C. or less, about 840° C. or less, about 830° C. or less, about 820° C. or less, about 810° C. or less, about 800° C. or less, about 790° C. or less, about 780° C. or less, about 770° C. or less, about 760° C. or less, about 750° C. or less). The lower/annealing zone temperature can be set to a temperature ranging from any of the minimum values described above to any of the maximum values described above. For example, in some aspects, the lower/annealing zone temperature is set to from about 750° C. to about 900° C. (e.g., from about 760° C. to about 890° C., from about 770° C. to about 880° C., from about 780° C. to about 870° C., from about 790° C. to about 860° C., from about 800° C. to about 850° C., from about 810° C. to about 840° C., from about 820° C. to about 830° C., from about 750° C. to about 830° C., from about 760° C. to about 820° C., from about 770° C. to about 810° C., from about 780° C. to about 800° C., from about 820° C. to about 900° C., from about 830° C. to about 890° C., from about 840° C. to about 880° C., from about 850° C. to about 870° C.).

In still further aspects, the sealed temperature-resistant container can be placed at a location where the temperature is above the melting point of the polycrystalline material. For example, and without limitations, if the polycrystalline material comprises MgSiP₂, such a location will have a temperature greater than about 1,130° C., greater than about 1,140° C., greater than about 1,150° C., greater than about 1,160° C., greater than about 1,170° C., greater than about 1,180° C., greater than about 1,200° C., greater than about 1,220° C., greater than about 1,240° C., greater than about 1,260° C., greater than about 1,280° C., greater than about 1,300° C., greater than about 1,320° C., greater than about 1,340° C., greater than about 1,360° C., greater than about 1,380° C., or greater than about 1,400° C. In some aspects, the temperature is greater than about 1,132° C. Yet, in other aspects, the temperature is greater than about 1,173° C.

In some aspects, the polycrystalline material is brought to the described temperatures in the disclosed zones in about 3 hours or more (e.g., about 4 hours or more, about 5 hours or more, about 6 hours or more, about 7 hours or more, about 8 hours or more, about 9 hours or more, about 10 hours or more, about 11 hours or more, about 12 hours or more, about 16 hours or more, about 20 hours or more, about 24 hours or more, about 28 hours or more, about 32 hours or more, about 36 hours or more, about 40 hours or more, about 44 hours or more, about 48 hours or more). In some aspects, the polycrystalline material is brought to the described temperatures in the disclosed zones in about 48 hours or less (e.g., about 44 hours or less, about 40 hours or less, about 36 hours or less, about 32 hours or less, about 28 hours or less, about 24 hours or less, about 20 hours or less, about 16 hours or less, about 12 hours or less, about 11 hours or less, about 10 hours or less, about 9 hours or less, about 8 hours or less, about 7 hours or less, about 6 hours or less, about 5 hours or less, about 4 hours or less, about 3 hours or less). The polycrystalline material can be brought to the described temperatures in the disclosed zones in a time ranging from any of the minimum values described above to any of the maximum values described above. For example, in some aspects, the polycrystalline material is brought to the described temperatures in the disclosed zones in from about 3 to about 48 hours (e.g., from about 4 hours to about 44 hours, from about 5 hours to about 40 hours, from about 6 hours to about 36 hours, from about 7 hours to about 32 hours, from about 8 hours to about 28 hours, from about 9 hours to about 24 hours, from about 10 hours to about 20 hours, from about 11 hours to about 16 hours, from about 3 hours to about 12 hours, from about 4 hours to about 11 hours, from about 5 hours to about 10 hours, from about 6 hours to about 9 hours, from about 7 hours to about 8 hours, from about 12 hours to about 48 hours, from about 16 hours to about 44 hours, from about 20 hours to about 40 hours, from about 24 hours to about 36 hours, from about 28 hours to about 32 hours).

In some aspects, the polycrystalline material is further dwelled at those temperatures for a fifth predetermined time. In some aspects, the fifth predetermined time is about 1 hour or more (e.g., about 2 hours or more, about 3 hours or more, about 4 hours or more, about 5 hours or more, about 6 hours or more, about 7 hours or more, about 8 hours or more, about 9 hours or more, about 10 hours or more, about 11 hours or more, about 12 hours or more, about 13 hours or more, about 14 hours or more, about 15 hours or more, about 16 hours or more, about 17 hours or more, about 18 hours or more, about 19 hours or more, about 20 hours or more, about 21 hours or more, about 22 hours or more, about 23 hours or more, about 24 hours or more). In some aspects, the fifth predetermined time is about 24 hours or less (e.g., about 23 hours or less, about 22 hours or less, about 21 hours or less, about 20 hours or less, about 19 hours or less, about 18 hours or less, about 17 hours or less, about 16 hours or less, about 15 hours or less, about 14 hours or less, about 13 hours or less, about 12 hours or less, about 11 hours or less, about 10 hours or less, about 9 hours or less, about 8 hours or less, about 7 hours or less, about 6 hours or less, about 5 hours or less, about 4 hours or less, about 3 hours or less, about 2 hours or less, about 1 hour or less). The fifth predetermined time can range from any of the minimum values described above to any of the maximum values described above. For example, in some aspects, the fifth predetermined time is from about 1 hour to about 24 hours (e.g., from about 2 hours to about 23 hours, from about 3 hours to about 22 hours, from about 4 hours to about 21 hours, from about 5 hours to about 20 hours, from about 6 hours to about 19 hours, from about 7 hours to about 18 hours, from about 8 hours to about 17 hours, from about 9 hours to about 16 hours, from about 10 hours to about 15 hours, from about 11 hours to about 14 hours, from about 12 hours to about 13 hours, from about 1 hour to about 13 hours, from about 2 hours to about 12 hours, from about 3 hours to about 11 hours, from about 4 hours to about 10 hours, from about 5 hours to about 9 hours, from about 6 hours to about 8 hours, from about 12 hours to about 24 hours, from about 13 hours to about 23 hours, from about 14 hours to about 22 hours, from about 15 hours to about 21 hours, from about 16 hours to about 20 hours, from about 17 hours to about 19 hours).

In some aspects, the step of translating the sealed temperature-resistant container vertically comprises raising the container about 50 mm or more (e.g., about 60 mm or more, about 70 mm or more, about 80 mm or more, about 90 mm or more, about 100 mm or more, about 110 mm or more, about 120 mm or more, about 130 mm or more, about 140 mm or more, about 150 mm or more, about 160 mm or more, about 170 mm or more, about 180 mm or more, about 190 mm or more, about 200 mm or more, about 210 mm or more, about 220 mm or more, about 230 mm or more, about 240 mm or more, about 250 mm or more, about 260 mm or more, about 270 mm or more, about 280 mm or more, about 290 mm or more, about 300 mm or more). In some aspects, the step of translating the sealed temperature-resistant container vertically comprises raising the container about 300 mm or less (e.g., about 290 mm or less, about 280 mm or less, about 270 mm or less, about 260 mm or less, about 250 mm or less, about 240 mm or less, about 230 mm or less, about 220 mm or less, about 210 mm or less, about 200 mm or less, about 190 mm or less, about 180 mm or less, about 170 mm or less, about 160 mm or less, about 150 mm or less, about 140 mm or less, about 130 mm or less, about 120 mm or less, about 110 mm or less, about 100 mm or less, about 90 mm or less, about 80 mm or less, about 70 mm or less, about 60 mm or less, about 50 mm or less). The step of translating the sealed temperature-resistant container vertically can comprise raising the container an amount ranging from any of the minimum values described above to any of the maximum values described above. For example, in some aspects, the step of translating the sealed temperature-resistant container vertically comprises raising the container from about 50 to about 300 mm (e.g., from about 60 mm to about 290 mm, from about 70 mm to about 280 mm, from about 80 mm to about 270 mm, from about 90 mm to about 260 mm, from about 100 mm to about 250 mm, from about 110 mm to about 240 mm, from about 120 mm to about 230 mm, from about 130 mm to about 220 mm, from about 140 mm to about 210 mm, from about 150 mm to about 200 mm, from about 160 mm to about 190 mm, from about 170 mm to about 180 mm, from about 50 mm to about 180 mm, from about 60 mm to about 170 mm, from about 70 mm to about 160 mm, from about 80 mm to about 150 mm, from about 90 mm to about 140 mm, from about 100 mm to about 130 mm, from about 110 mm to about 120 mm, from about 170 mm to about 300 mm, from about 180 mm to about 290 mm, from about 190 mm to about 280 mm, from about 200 mm to about 270 mm, from about 210 mm to about 260 mm, from about 220 mm to about 250 mm, from about 230 mm to about 240 mm).

In some aspects, the sealed temperature-resistant container is raised vertically with a translation rate of about 0.1 mm/h or more (e.g., about 0.2 mm/h or more, about 0.3 mm/h or more, about 0.4 mm/h or more, about 0.5 mm/h or more, about 0.6 mm/h or more, about 0.7 mm/h or more, about 0.8 mm/h or more, about 0.9 mm/h or more, about 1 mm/h or more). In some aspects, the sealed temperature-resistant container is raised vertically with a translation rate of about 1 mm/h or less (e.g., about 0.9 mm/h or less, about 0.8 mm/h or less, about 0.7 mm/h or less, about 0.6 mm/h or less, about 0.5 mm/h or less, about 0.4 mm/h or less, about 0.3 mm/h or less, about 0.2 mm/h or less, about 0.1 mm/h or less). The sealed temperature-resistant container can be raised vertically with a translation rate ranging from any of the minimum values described above to any of the maximum values described above. For example, in some aspects, the sealed temperature-resistant container is raised vertically with a translation rate of from about 0.1 mm/h to about 1 mm/h (e.g., from about 0.2 mm/h to about 0.9 mm/h, from about 0.3 mm/h to about 0.8 mm/h, from about 0.4 mm/h to about 0.7 mm/h, from about 0.5 mm/h to about 0.6 mm/h, from about 0.1 mm/h to about 0.6 mm/h, from about 0.2 mm/h to about 0.5 mm/h, from about 0.3 mm/h to about 0.4 mm/h, from about 0.5 mm/h to about 1 mm/h, from about 0.6 mm/h to about 0.9 mm/h, from about 0.7 mm/h to about 0.8 mm/h).

In yet still further aspects, at these conditions, the sealed temperature-resistant container can pass through the nucleation temperature to form a seeding crystal. In some aspects (for example, in aspects where MgSiP₂ crystal is formed), the nucleation temperature is about 1,050° C. or more (e.g., about 1,060° C. or more, about 1,070° C. or more, about 1,080° C. or more, about 1,090° C. or more, about 1,100° C. or more, about 1,110° C. or more, about 1,120° C. or more, about 1,130° C. or more, about 1,140° C. or more, about 1,150° C. or more, about 1,160° C. or more, about 1,170° C. or more, about 1,180° C. or more, about 1,190° C. or more, about 1,200° C. or more). In some aspects, the nucleation temperature is about 1,200° C. or less (e.g., about 1,190° C. or less, about 1,180° C. or less, about 1,170° C. or less, about 1,160° C. or less, about 1,150° C. or less, about 1,140° C. or less, about 1,130° C. or less, about 1,120° C. or less, about 1,110° C. or less, about 1,100° C. or less, about 1,090° C. or less, about 1,080° C. or less, about 1,070° C. or less, about 1,060° C. or less, about 1,050° C. or less). The nucleation temperature can range from any of the minimum values described above to any of the maximum values described above. For example, in some aspects, the nucleation temperature is from about 1,050° C. to about 1,200° C. (e.g., from about 1,060° C. to about 1,190° C., from about 1,070° C. to about 1,180° C., from about 1,080° C. to about 1,170° C., from about 1,090° C. to about 1,160° C., from about 1,100° C. to about 1,150° C., from about 1,110° C. to about 1,140° C., from about 1,120° C. to about 1,130° C., from about 1,050° C. to about 1,130° C., from about 1,060° C. to about 1,120° C., from about 1,070° C. to about 1,110° C., from about 1,080° C. to about 1,100° C., from about 1,120° C. to about 1,200° C., from about 1,130° C. to about 1,190° C., from about 1,140° C. to about 1,180° C., from about 1,150° C. to about 1,170° C.).

In still further aspects, prior to the annealing step, the upper/melt zone temperature, the middle/crystallization zone temperature, and the lower/annealing zone temperature reduced to a fourth temperature at a first predetermined cooling rate. In some aspects, the fourth temperature is about 700° C. or more (e.g., about 710° C. or more, about 720° C. or more, about 730° C. or more, about 740° C. or more, about 750° C. or more, about 760° C. or more, about 770° C. or more, about 780° C. or more, about 790° C. or more, about 800° C. or more, about 810° C. or more, about 820° C. or more, about 830° C. or more, about 840° C. or more, about 850° C. or more, about 860° C. or more, about 870° C. or more, about 880° C. or more, about 890° C. or more, about 900° C. or more). In some aspects, the fourth temperature is about 900° C. or less (e.g., about 890° C. or less, about 880° C. or less, about 870° C. or less, about 860° C. or less, about 850° C. or less, about 840° C. or less, about 830° C. or less, about 820° C. or less, about 810° C. or less, about 800° C. or less, about 790° C. or less, about 780° C. or less, about 770° C. or less, about 760° C. or less, about 750° C. or less, about 740° C. or less, about 730° C. or less, about 720° C. or less, about 710° C. or less, about 700° C. or less). The fourth temperature can range from any of the minimum values described above to any of the maximum values described above. For example, in some aspects, the fourth temperature is from about 700° C. to about 900° C. (e.g., from about 710° C. to about 890° C., from about 720° C. to about 880° C., from about 730° C. to about 870° C., from about 740° C. to about 860° C., from about 750° C. to about 850° C., from about 760° C. to about 840° C., from about 770° C. to about 830° C., from about 780° C. to about 820° C., from about 790° C. to about 810° C., from about 700° C. to about 800° C., from about 710° C. to about 790° C., from about 720° C. to about 780° C., from about 730° C. to about 770° C., from about 740° C. to about 760° C., from about 800° C. to about 900° C., from about 810° C. to about 890° C., from about 820° C. to about 880° C., from about 830° C. to about 870° C., from about 840° C. to about 860° C.)

In some aspects, the first predetermined cooling rate is about 1° C./h or more (e.g., about 2° C./h or more, about 3° C./h or more, about 4° C./h or more, about 5° C./h or more, about 6° C./h or more, about 7° C./h or more, about 8° C./h or more, about 9° C./h or more, about 10° C./h or more, about 11° C./h or more, about 12° C./h or more, about 13° C./h or more, about 14° C./h or more, about 15° C./h or more, about 16° C./h or more, about 17° C./h or more, about 18° C./h or more, about 19° C./h or more, about 20° C./h or more, about 21° C./h or more, about 22° C./h or more, about 23° C./h or more, about 24° C./h or more, about 25° C./h or more, about 26° C./h or more, about 27° C./h or more, about 28° C./h or more, about 29° C./h or more, about 30° C./h or more, about 31° C./h or more, about 32° C./h or more, about 33° C./h or more, about 34° C./h or more, about 35° C./h or more, about 36° C./h or more, about 37° C./h or more, about 38° C./h or more, about 39° C./h or more, about 40° C./h or more, about 41° C./h or more, about 42° C./h or more, about 43° C./h or more, about 44° C./h or more, about 45° C./h or more, about 46° C./h or more, about 47° C./h or more, about 48° C./h or more, about 49° C./h or more, about 50° C./h or more, about 51° C./h or more, about 52° C./h or more, about 53° C./h or more, about 54° C./h or more, about 55° C./h or more, about 56° C./h or more, about 57° C./h or more, about 58° C./h or more, about 59° C./h or more, about 60° C./h or more, about 61° C./h or more, about 62° C./h or more, about 63° C./h or more, about 64° C./h or more, about 65° C./h or more, about 66° C./h or more, about 67° C./h or more, about 68° C./h or more, about 69° C./h or more, about 70° C./h or more, about 71° C./h or more, about 72° C./h or more, about 73° C./h or more, about 74° C./h or more, about 75° C./h or more, about 76° C./h or more, about 77° C./h or more, about 78° C./h or more, about 79° C./h or more, about 80° C./h or more, about 81° C./h or more, about 82° C./h or more, about 83° C./h or more, about 84° C./h or more, about 85° C./h or more, about 86° C./h or more, about 87° C./h or more, about 88° C./h or more, about 89° C./h or more, about 90° C./h or more). In some aspects, the first predetermined cooling rate is about 90° C./h or less (e.g., about 89° C./h or less, about 88° C./h or less, about 87° C./h or less, about 86° C./h or less, about 85° C./h or less, about 84° C./h or less, about 83° C./h or less, about 82° C./h or less, about 81° C./h or less, about 80° C./h or less, about 79° C./h or less, about 78° C./h or less, about 77° C./h or less, about 76° C./h or less, about 75° C./h or less, about 74° C./h or less, about 73° C./h or less, about 72° C./h or less, about 71° C./h or less, about 70° C./h or less, about 69° C./h or less, about 68° C./h or less, about 67° C./h or less, about 66° C./h or less, about 65° C./h or less, about 64° C./h or less, about 63° C./h or less, about 62° C./h or less, about 61° C./h or less, about 60° C./h or less, about 59° C./h or less, about 58° C./h or less, about 57° C./h or less, about 56° C./h or less, about 55° C./h or less, about 54° C./h or less, about 53° C./h or less, about 52° C./h or less, about 51° C./h or less, about 50° C./h or less, about 49° C./h or less, about 48° C./h or less, about 47° C./h or less, about 46° C./h or less, about 45° C./h or less, about 44° C./h or less, about 43° C./h or less, about 42° C./h or less, about 41° C./h or less, about 40° C./h or less, about 39° C./h or less, about 38° C./h or less, about 37° C./h or less, about 36° C./h or less, about 35° C./h or less, about 34° C./h or less, about 33° C./h or less, about 32° C./h or less, about 31° C./h or less, about 30° C./h or less, about 29° C./h or less, about 28° C./h or less, about 27° C./h or less, about 26° C./h or less, about 25° C./h or less, about 24° C./h or less, about 23° C./h or less, about 22° C./h or less, about 21° C./h or less, about 20° C./h or less, about 19° C./h or less, about 18° C./h or less, about 17° C./h or less, about 16° C./h or less, about 15° C./h or less, about 14° C./h or less, about 13° C./h or less, about 12° C./h or less, about 11° C./h or less, about 10° C./h or less, about 9° C./h or less, about 8° C./h or less, about 7° C./h or less, about 6° C./h or less, about 5° C./h or less, about 4° C./h or less, about 3° C./h or less, about 2° C./h or less, about 1° C./h or less). The first predetermined cooling rate can range from any of the minimum values described above to any of the maximum values described above. For example, in some aspects, the first predetermined cooling rate is from about 1° C./h to about 90° C./h (e.g., from about 2° C./h to about 89° C./h, from about 3° C./h to about 88° C./h, from about 4° C./h to about 87° C./h, from about 5° C./h to about 86° C./h, from about 6° C./h to about 85° C./h, from about 7° C./h to about 84° C./h, from about 8° C./h to about 83° C./h, from about 9° C./h to about 82° C./h, from about 10° C./h to about 81° C./h, from about 11° C./h to about 80° C./h, from about 12° C./h to about 79° C./h, from about 13° C./h to about 78° C./h, from about 14° C./h to about 77° C./h, from about 15° C./h to about 76° C./h, from about 16° C./h to about 75° C./h, from about 17° C./h to about 74° C./h, from about 18° C./h to about 73° C./h, from about 19° C./h to about 72° C./h, from about 20° C./h to about 71° C./h, from about 21° C./h to about 70° C./h, from about 22° C./h to about 69° C./h, from about 23° C./h to about 68° C./h, from about 24° C./h to about 67° C./h, from about 25° C./h to about 66° C./h, from about 26° C./h to about 65° C./h, from about 27° C./h to about 64° C./h, from about 28° C./h to about 63° C./h, from about 29° C./h to about 62° C./h, from about 30° C./h to about 61° C./h, from about 31° C./h to about 60° C./h, from about 32° C./h to about 59° C./h, from about 33° C./h to about 58° C./h, from about 34° C./h to about 57° C./h, from about 35° C./h to about 56° C./h, from about 36° C./h to about 55° C./h, from about 37° C./h to about 54° C./h, from about 38° C./h to about 53° C./h, from about 39° C./h to about 52° C./h, from about 40° C./h to about 51° C./h, from about 41° C./h to about 50° C./h, from about 42° C./h to about 49° C./h, from about 43° C./h to about 48° C./h, from about 44° C./h to about 47° C./h, from about 45° C./h to about 46° C./h, from about 1° C./h to about 46° C./h, from about 2° C./h to about 45° C./h, from about 3° C./h to about 44° C./h, from about 4° C./h to about 43° C./h, from about 5° C./h to about 42° C./h, from about 6° C./h to about 41° C./h, from about 7° C./h to about 40° C./h, from about 8° C./h to about 39° C./h, from about 9° C./h to about 38° C./h, from about 10° C./h to about 37° C./h, from about 11° C./h to about 36° C./h, from about 12° C./h to about 35° C./h, from about 13° C./h to about 34° C./h, from about 14° C./h to about 33° C./h, from about 15° C./h to about 32° C./h, from about 16° C./h to about 31° C./h, from about 17° C./h to about 30° C./h, from about 18° C./h to about 29° C./h, from about 19° C./h to about 28° C./h, from about 20° C./h to about 27° C./h, from about 21° C./h to about 26° C./h, from about 22° C./h to about 25° C./h, from about 23° C./h to about 24° C./h, from about 45° C./h to about 90° C./h, from about 46° C./h to about 89° C./h, from about 47° C./h to about 88° C./h, from about 48° C./h to about 87° C./h, from about 49° C./h to about 86° C./h, from about 50° C./h to about 85° C./h, from about 51° C./h to about 84° C./h, from about 52° C./h to about 83° C./h, from about 53° C./h to about 82° C./h, from about 54° C./h to about 81° C./h, from about 55° C./h to about 80° C./h, from about 56° C./h to about 79° C./h, from about 57° C./h to about 78° C./h, from about 58° C./h to about 77° C./h, from about 59° C./h to about 76° C./h, from about 60° C./h to about 75° C./h, from about 61° C./h to about 74° C./h, from about 62° C./h to about 73° C./h, from about 63° C./h to about 72° C./h, from about 64° C./h to about 71° C./h, from about 65° C./h to about 70° C./h, from about 66° C./h to about 69° C./h, from about 67° C./h to about 68° C./h).

In some aspects, the annealing of the ingot material is at a temperature of about 700° C. or more (e.g., about 710° C. or more, about 720° C. or more, about 730° C. or more, about 740° C. or more, about 750° C. or more, about 760° C. or more, about 770° C. or more, about 780° C. or more, about 790° C. or more, about 800° C. or more, about 810° C. or more, about 820° C. or more, about 830° C. or more, about 840° C. or more, about 850° C. or more) for a fourth predetermined time. In some aspects, the annealing of the ingot material is at a temperature of about 850° C. or less (e.g., about 840° C. or less, about 830° C. or less, about 820° C. or less, about 810° C. or less, about 800° C. or less, about 790° C. or less, about 780° C. or less, about 770° C. or less, about 760° C. or less, about 750° C. or less, about 740° C. or less, about 730° C. or less, about 720° C. or less, about 710° C. or less, about 700° C. or less) for a fourth predetermined time. The annealing of the ingot material can be at a temperature ranging from any of the minimum values described above to any of the maximum values described above. For example, in some aspects, the annealing of the ingot material can be at a temperature of from about 700° C. to about 850° C. (e.g., from about 710° C. to about 840° C., from about 720° C. to about 830° C., from about 730° C. to about 820° C., from about 740° C. to about 810° C., from about 750° C. to about 800° C., from about 760° C. to about 790° C., from about 770° C. to about 780° C., from about 700° C. to about 780° C., from about 710° C. to about 770° C., from about 720° C. to about 760° C., from about 730° C. to about 750° C., from about 770° C. to about 850° C., from about 780° C. to about 840° C., from about 790° C. to about 830° C., from about 800° C. to about 820° C.) for a fourth predetermined time.

In some aspects, the fourth predetermined time is about 10 min or more (e.g., about 30 min or more, about 1 hour or more, about 2 hours or more, about 3 hours or more, about 4 hours or more, about 5 hours or more, about 6 hours or more, about 7 hours or more, about 8 hours or more, about 9 hours or more, about 10 hours or more, about 11 hours or more, about 12 hours or more). In some aspects, the fourth predetermined time is about 12 hours or less (e.g., about 11 hours or less, about 10 hours or less, about 9 hours or less, about 8 hours or less, about 7 hours or less, about 6 hours or less, about 5 hours or less, about 4 hours or less, about 3 hours or less, about 2 hours or less, about 1 hour or less, about 30 min or less, about 10 min or less). The fourth predetermined time can range from any of the minimum values described above to any of the maximum values described above. For example, in some aspects, the fourth predetermined time is from about 10 min to about 12 hours (e.g., from about 30 min to about 11 hours, from about 1 hour to about 10 hours, from about 2 hours to about 9 hours, from about 3 hours to about 8 hours, from about 4 hours to about 7 hours, from about 5 hours to about 6 hours, from about 10 hours to about 1 hour, from about 11 hours to about 30 min, from about 12 hours to about 10 min, from about 10 min to about 6 hours, from about 30 min to about 5 hours, from about 1 hour to about 4 hours, from about 2 hours to about 3 hours, from about 8 hours to about 9 hours, from about 10 hours to about 7 hours, from about 11 hours to about 6 hours, from about 12 hours to about 5 hours).

In still further aspects, the ingot material is cooled after annealing to room temperature at a second predetermined cooling rate. In some aspects, the second predetermined cooling range is about 1° C./h or more (e.g., about 2° C./h or more, about 3° C./h or more, about 4° C./h or more, about 5° C./h or more, about 6° C./h or more, about 7° C./h or more, about 8° C./h or more, about 9° C./h or more, about 10° C./h or more, about 11° C./h or more, about 12° C./h or more, about 13° C./h or more, about 14° C./h or more, about 15° C./h or more, about 16° C./h or more, about 17° C./h or more, about 18° C./h or more, about 19° C./h or more, about 20° C./h or more, about 21° C./h or more, about 22° C./h or more, about 23° C./h or more, about 24° C./h or more, about 25° C./h or more, about 26° C./h or more, about 27° C./h or more, about 28° C./h or more, about 29° C./h or more, about 30° C./h or more, about 31° C./h or more, about 32° C./h or more, about 33° C./h or more, about 34° C./h or more, about 35° C./h or more, about 36° C./h or more, about 37° C./h or more, about 38° C./h or more, about 39° C./h or more, about 40° C./h or more, about 41° C./h or more, about 42° C./h or more, about 43° C./h or more, about 44° C./h or more, about 45° C./h or more, about 46° C./h or more, about 47° C./h or more, about 48° C./h or more, about 49° C./h or more, about 50° C./h or more, about 51° C./h or more, about 52° C./h or more, about 53° C./h or more, about 54° C./h or more, about 55° C./h or more, about 56° C./h or more, about 57° C./h or more, about 58° C./h or more, about 59° C./h or more, about 60° C./h or more, about 61° C./h or more, about 62° C./h or more, about 63° C./h or more, about 64° C./h or more, about 65° C./h or more, about 66° C./h or more, about 67° C./h or more, about 68° C./h or more, about 69° C./h or more, about 70° C./h or more, about 71° C./h or more, about 72° C./h or more, about 73° C./h or more, about 74° C./h or more, about 75° C./h or more, about 76° C./h or more, about 77° C./h or more, about 78° C./h or more, about 79° C./h or more, about 80° C./h or more, about 81° C./h or more, about 82° C./h or more, about 83° C./h or more, about 84° C./h or more, about 85° C./h or more, about 86° C./h or more, about 87° C./h or more, about 88° C./h or more, about 89° C./h or more, about 90° C./h or more). In some aspects, the second predetermined cooling rate is about 90° C./h or less (e.g., about 89° C./h or less, about 88° C./h or less, about 87° C./h or less, about 86° C./h or less, about 85° C./h or less, about 84° C./h or less, about 83° C./h or less, about 82° C./h or less, about 81° C./h or less, about 80° C./h or less, about 79° C./h or less, about 78° C./h or less, about 77° C./h or less, about 76° C./h or less, about 75° C./h or less, about 74° C./h or less, about 73° C./h or less, about 72° C./h or less, about 71° C./h or less, about 70° C./h or less, about 69° C./h or less, about 68° C./h or less, about 67° C./h or less, about 66° C./h or less, about 65° C./h or less, about 64° C./h or less, about 63° C./h or less, about 62° C./h or less, about 61° C./h or less, about 60° C./h or less, about 59° C./h or less, about 58° C./h or less, about 57° C./h or less, about 56° C./h or less, about 55° C./h or less, about 54° C./h or less, about 53° C./h or less, about 52° C./h or less, about 51° C./h or less, about 50° C./h or less, about 49° C./h or less, about 48° C./h or less, about 47° C./h or less, about 46° C./h or less, about 45° C./h or less, about 44° C./h or less, about 43° C./h or less, about 42° C./h or less, about 41° C./h or less, about 40° C./h or less, about 39° C./h or less, about 38° C./h or less, about 37° C./h or less, about 36° C./h or less, about 35° C./h or less, about 34° C./h or less, about 33° C./h or less, about 32° C./h or less, about 31° C./h or less, about 30° C./h or less, about 29° C./h or less, about 28° C./h or less, about 27° C./h or less, about 26° C./h or less, about 25° C./h or less, about 24° C./h or less, about 23° C./h or less, about 22° C./h or less, about 21° C./h or less, about 20° C./h or less, about 19° C./h or less, about 18° C./h or less, about 17° C./h or less, about 16° C./h or less, about 15° C./h or less, about 14° C./h or less, about 13° C./h or less, about 12° C./h or less, about 11° C./h or less, about 10° C./h or less, about 9° C./h or less, about 8° C./h or less, about 7° C./h or less, about 6° C./h or less, about 5° C./h or less, about 4° C./h or less, about 3° C./h or less, about 2° C./h or less, about 1° C./h or less). The second predetermined cooling rate can range from any of the minimum values described above to any of the maximum values described above. For example, in some aspects, the second predetermined cooling rate is from about 1° C./h to about 90° C./h (e.g., from about 2° C./h to about 89° C./h, from about 3° C./h to about 88° C./h, from about 4° C./h to about 87° C./h, from about 5° C./h to about 86° C./h, from about 6° C./h to about 85° C./h, from about 7° C./h to about 84° C./h, from about 8° C./h to about 83° C./h, from about 9° C./h to about 82° C./h, from about 10° C./h to about 81° C./h, from about 11° C./h to about 80° C./h, from about 12° C./h to about 79° C./h, from about 13° C./h to about 78° C./h, from about 14° C./h to about 77° C./h, from about 15° C./h to about 76° C./h, from about 16° C./h to about 75° C./h, from about 17° C./h to about 74° C./h, from about 18° C./h to about 73° C./h, from about 19° C./h to about 72° C./h, from about 20° C./h to about 71° C./h, from about 21° C./h to about 70° C./h, from about 22° C./h to about 69° C./h, from about 23° C./h to about 68° C./h, from about 24° C./h to about 67° C./h, from about 25° C./h to about 66° C./h, from about 26° C./h to about 65° C./h, from about 27° C./h to about 64° C./h, from about 28° C./h to about 63° C./h, from about 29° C./h to about 62° C./h, from about 30° C./h to about 61° C./h, from about 31° C./h to about 60° C./h, from about 32° C./h to about 59° C./h, from about 33° C./h to about 58° C./h, from about 34° C./h to about 57° C./h, from about 35° C./h to about 56° C./h, from about 36° C./h to about 55° C./h, from about 37° C./h to about 54° C./h, from about 38° C./h to about 53° C./h, from about 39° C./h to about 52° C./h, from about 40° C./h to about 51° C./h, from about 41° C./h to about 50° C./h, from about 42° C./h to about 49° C./h, from about 43° C./h to about 48° C./h, from about 44° C./h to about 47° C./h, from about 45° C./h to about 46° C./h, from about 1° C./h to about 46° C./h, from about 2° C./h to about 45° C./h, from about 3° C./h to about 44° C./h, from about 4° C./h to about 43° C./h, from about 5° C./h to about 42° C./h, from about 6° C./h to about 41° C./h, from about 7° C./h to about 40° C./h, from about 8° C./h to about 39° C./h, from about 9° C./h to about 38° C./h, from about 10° C./h to about 37° C./h, from about 11° C./h to about 36° C./h, from about 12° C./h to about 35° C./h, from about 13° C./h to about 34° C./h, from about 14° C./h to about 33° C./h, from about 15° C./h to about 32° C./h, from about 16° C./h to about 31° C./h, from about 17° C./h to about 30° C./h, from about 18° C./h to about 29° C./h, from about 19° C./h to about 28° C./h, from about 20° C./h to about 27° C./h, from about 21° C./h to about 26° C./h, from about 22° C./h to about 25° C./h, from about 23° C./h to about 24° C./h, from about 45° C./h to about 90° C./h, from about 46° C./h to about 89° C./h, from about 47° C./h to about 88° C./h, from about 48° C./h to about 87° C./h, from about 49° C./h to about 86° C./h, from about 50° C./h to about 85° C./h, from about 51° C./h to about 84° C./h, from about 52° C./h to about 83° C./h, from about 53° C./h to about 82° C./h, from about 54° C./h to about 81° C./h, from about 55° C./h to about 80° C./h, from about 56° C./h to about 79° C./h, from about 57° C./h to about 78° C./h, from about 58° C./h to about 77° C./h, from about 59° C./h to about 76° C./h, from about 60° C./h to about 75° C./h, from about 61° C./h to about 74° C./h, from about 62° C./h to about 73° C./h, from about 63° C./h to about 72° C./h, from about 64° C./h to about 71° C./h, from about 65° C./h to about 70° C./h, from about 66° C./h to about 69° C./h, from about 67° C./h to about 68° C./h).

In some aspects, the formed single nonlinear optical crystal has a size of about 0.1 mm or more (e.g., about 0.5 mm or more, about 1 mm or more, about 5 mm or more, about 10 mm or more, about 1.5 cm or more, about 2 cm or more, about 2.5 cm or more, about 3 cm or more, about 3.5 cm or more, about 4 cm or more, about 4.5 cm or more, about 5 cm or more, about 5.5 cm or more, about 6 cm or more, about 6.5 cm or more, about 7 cm or more, about 7.5 cm or more, about 8 cm or more, about 8.5 cm or more, about 9 cm or more, about 9.5 cm or more, about 10 cm or more) in length. In some aspects, the formed single nonlinear optical crystal has a size of about 10 cm or less (e.g., about 9.5 cm or less, about 9 cm or less, about 8.5 cm or less, about 8 cm or less, about 7.5 cm or less, about 7 cm or less, about 6.5 cm or less, about 6 cm or less, about 5.5 cm or less, about 5 cm or less, about 4.5 cm or less, about 4 cm or less, about 3.5 cm or less, about 3 cm or less, about 2.5 cm or less, about 2 cm or less, about 1.5 cm or less, about 10 mm or less, about 5 mm or less, about 1 mm or less, about 0.5 mm or less, about 0.1 mm or less) in length. The formed single nonlinear optical crystal can have a size in length ranging from any of the minimum values described above to any of the maximum values described above. For example, in some aspects, the formed single nonlinear optical crystal has a size of from about 0.1 mm to about 10 cm (e.g., from about 0.5 mm to about 9.5 cm, from about 1 mm to about 9 cm, from about 10 mm to about 8 cm, from about 1.5 cm to about 7.5 cm, from about 2 cm to about 7 cm, from about 2.5 cm to about 6.5 cm, from about 3 cm to about 6 cm, from about 3.5 cm to about 5.5 cm, from about 4 cm to about 5 cm, from about 10 cm to about 0.1 mm, from about 0.1 mm to about 4.5 cm, from about 0.5 mm to about 4 cm, from about 1 mm to about 3.5 cm, from about 10 mm to about 2.5 cm, from about 1.5 cm to about 2 cm, from about 3 cm to about 5 mm, from about 5 cm to about 9.5 cm, from about 5.5 cm to about 9 cm, from about 6 cm to about 8.5 cm, from about 6.5 cm to about 8 cm, from about 7 cm to about 7.5 cm, from about 10 cm to about 4.5 cm) in length.

In still further aspects, the polycrystalline materials used in the methods of forming the disclosed single nonlinear optical crystals can be formed by the steps comprising: a) mixing Mg, IV, and V in a molar ratio of about 0.95:0.95:2 to about 1.05:1.05:2 to form a mixture; b) placing the mixture into a sealed container in a furnace; c) bringing the mixture to a first heating temperature of about 450° C. to about 550° C. at a rate of about 45° C./h to 55° C./h and keeping the mixture at the first heating temperature for about 60 to about 100 hours; d) bringing the mixture to a second heating temperature of about 780° C. to about 850° C. at a rate of about 20° C./h to about 40° C./h and keeping the mixture at the second heating temperature for about 50 to about 100 hours; e) bringing the mixture to a third heating temperature of about 1,100° C. to about 1,250° C. at a rate of about 20° C./h to about 40° C./h and keeping the mixture at the third heating temperature for about 50 to about 100 hours; f) cooling the mixture to a room temperature at a rate of about 50° C./h to about 150° C./h; g) recovering the polycrystalline material comprising Mg—IV—V₂, wherein the polycrystalline material is substantially free of impurities and has a substantially single phase.

In some aspects, the solute comprises a mixture of Mg, IV, and V in a molar ratio of about 0.95:0.95:2 or more (e.g., about 0.96:0.96:2 or more, about 0.97:0.97:2 or more, about 0.98:0.98:2 or more, about 0.99:0.99:2 or more, about 1:1:2 or more, about 1.01:1.01:2 or more, about 1.02:1.02:2 or more, about 1.03:1.03:2 or more, about 1.04:1.04:2 or more, about 1.05:1.05:2 or more). In some aspects, the solute comprises a mixture of Mg, IV, and V in a molar ratio of about 1.05:1.05:2 or less (e.g., about 1.04:1.04:2 or less, about 1.03:1.03:2 or less, about 1.02:1.02:2 or less, about 1.01:1.01:2 or less, about 1:1:2 or less, about 0.99:0.99:2 or less, about 0.98:0.98:2 or less, about 0.97:0.97:2 or less, about 0.96:0.96:2 or less, about 0.95:0.95:2 or less). The solute can comprise a mixture of Mg, IV, and V in a molar ratio ranging from any of the minimum values described above to any of the maximum values described above. For example, in some aspects, the solute comprises a mixture of Mg, IV, and V in a molar ratio of from about 0.95:0.95:2 to about 1.05:1.05:2 (e.g., from about 0.96:0.96:2 to about 1.04:1.04:2, from about 0.97:0.97:2 to about 1.03:1.03:2, from about 0.98:0.98:2 to about 1.02:1.02:2, from about 0.99:0.99:2 to about 1.01:1.01:2, from about 1.01:1.01:2 to about 0.99:0.99:2, from about 1.02:1.02:2 to about 0.98:0.98:2, from about 1.03:1.03:2 to about 0.97:0.97:2, from about 1.04:1.04:2 to about 0.96:0.96:2, from about 1.05:1.05:2 to about 0.95:0.95:2, from about 0.95:0.95:2 to about 1:1:2, from about 0.96:0.96:2 to about 0.99:0.99:2, from about 0.97:0.97:2 to about 0.98:0.98:2, from about 1.01:1.01:2 to about 1.04:1.04:2, from about 1.02:1.02:2 to about 1.03:1.03:2, from about 1.05:1.05:2 to about 1:1:2).

In some aspects, the first heating temperature is about 450° C. or more (e.g., about 460° C. or more, about 470° C. or more, about 480° C. or more, about 490° C. or more, about 500° C. or more, about 510° C. or more, about 520° C. or more, about 530° C. or more, about 540° C. or more, about 550° C. or more). In some aspects, the first heating temperature is about 550° C. or less (e.g., about 540° C. or less, about 530° C. or less, about 520° C. or less, about 510° C. or less, about 500° C. or less, about 490° C. or less, about 480° C. or less, about 470° C. or less, about 460° C. or less, about 450° C. or less). The first heating temperature can range from any of the minimum values described above to any of the maximum values described above. For example, in some aspects, the first heating temperature is from about 450° C. to about 550° C. (e.g., from about 460° C. to about 540° C., from about 470° C. to about 530° C., from about 480° C. to about 520° C., from about 490° C. to about 510° C., from about 450° C. to about 500° C., from about 460° C. to about 490° C., from about 470° C. to about 480° C., from about 500° C. to about 550° C., from about 510° C. to about 540° C., from about 520° C. to about 530° C.).

In some aspects, the first heating temperature is achieved at a rate of about 1° C./h or more (e.g., about 5° C./h or more, about 10° C./h or more, about 15° C./h or more, about 20° C./h or more, about 25° C./h or more, about 30° C./h or more, about 35° C./h or more, about 40° C./h or more, about 45° C./h or more, about 50° C./h or more). In some aspects, the first heating temperature is achieved at a rate of about 55° C./h or less (e.g., about 45° C./h or less, about 40° C./h or less, about 35° C./h or less, about 30° C./h or less, about 25° C./h or less, about 20° C./h or less, about 15° C./h or less, about 10° C./h or less, about 5° C./h or less, about 1° C./h or less). The first heating temperature can be achieved at a rate ranging from any of the minimum values described above to any of the maximum values described above. For example, in some aspects, the first heating temperature is achieved at a rate of from about 1° C./h to about 55° C./h (e.g., from about 5° C./h to about 45° C./h, from about 10° C./h to about 40° C./h, from about 15° C./h to about 35° C./h, from about 20° C./h to about 30° C./h, from about 1° C./h to about 25° C./h, from about 5° C./h to about 20° C./h, from about 10° C./h to about 15° C./h, from about 25° C./h to about 50° C./h, from about 30° C./h to about 45° C./h, from about 35° C./h to about 40° C./h).

In some aspects, the mixture is kept at the first heating temperature for about 60 hours or more (e.g., about 65 hours or more, about 70 hours or more, about 75 hours or more, about 80 hours or more, about 85 hours or more, about 90 hours or more, about 95 hours or more, about 100 hours or more). In some aspects, the mixture is kept at the first heating temperature for about 100 hours or less (e.g., about 95 hours or less, about 90 hours or less, about 85 hours or less, about 80 hours or less, about 75 hours or less, about 70 hours or less, about 65 hours or less, about 60 hours or less). The mixture can be kept at the first heating temperature for a duration ranging from any of the minimum values described above to any of the maximum values described above. For example, in some aspects, the mixture is kept at the first heating temperature for from about 60 hours to about 100 hours (e.g., from about 65 hours to about 95 hours, from about 70 hours to about 90 hours, from about 75 hours to about 85 hours, from about 60 hours to about 80 hours, from about 65 hours to about 75 hours, from about 80 hours to about 100 hours, from about 85 hours to about 95 hours).

In some aspects, the second heating temperature is about 780° C. or more (e.g., about 790° C. or more, about 800° C. or more, about 810° C. or more, about 820° C. or more, about 830° C. or more, about 840° C. or more, about 850° C. or more). In some aspects, the second heating temperature is about 850° C. or less (e.g., about 840° C. or less, about 830° C. or less, about 820° C. or less, about 810° C. or less, about 800° C. or less, about 790° C. or less, about 780° C. or less). The second heating temperature can range from any of the minimum values described above to any of the maximum values described above. For example, in some aspects, the second heating temperature is from about 780° C. to about 850° C. (e.g., from about 790° C. to about 840° C., from about 800° C. to about 830° C., from about 810° C. to about 820° C., from about 780° C. to about 820° C., from about 790° C. to about 810° C., from about 810° C. to about 850° C., from about 820° C. to about 840° C.).

In some aspects, the second heating temperature is achieved at a rate of about 1° C./h or more (e.g., about 5° C./h or more, about 10° C./h or more, about 15° C./h or more, about 20° C./h or more, about 25° C./h or more, about 30° C./h or more, about 35° C./h or more, about 40° C./h or more). In some aspects, the second heating temperature is achieved at a rate of about 40° C./h or less (e.g., about 35° C./h or less, about 30° C./h or less, about 25° C./h or less, about 20° C./h or less, about 15° C./h or less, about 10° C./h or less, about 5° C./h or less, about 1° C./h or less). The second heating temperature can be achieved at a rate ranging from any of the minimum values described above to any of the maximum values described above. For example, in some aspects, the second heating temperature is achieved at a rate of from about 1° C./h to about 40° C./h (e.g., from about 5° C./h to about 35° C./h, from about 10° C./h to about 30° C./h, from about 15° C./h to about 25° C./h, from about 1° C./h to about 20° C./h, from about 5° C./h to about 15° C./h, from about 20° C./h to about 40° C./h, from about 25° C./h to about 35° C./h).

In some aspects, the mixture is kept at the second heating temperature for about 50 hours or more (e.g., about 55 hours or more, about 60 hours or more, about 65 hours or more, about 70 hours or more, about 75 hours or more, about 80 hours or more, about 85 hours or more, about 90 hours or more, about 95 hours or more, about 100 hours or more). In some aspects, the mixture is kept at the second heating temperature for about 100 hours or less (e.g., about 95 hours or less, about 90 hours or less, about 85 hours or less, about 80 hours or less, about 75 hours or less, about 70 hours or less, about 65 hours or less, about 60 hours or less, about 55 hours or less, about 50 hours or less). The mixture can be kept at the second heating temperature for a duration ranging from any of the minimum values described above to any of the maximum values described above. For example, in some aspects, the mixture is kept at the second heating temperature for from about 50 hours to about 100 hours (e.g., from about 55 hours to about 95 hours, from about 60 hours to about 90 hours, from about 65 hours to about 85 hours, from about 70 hours to about 80 hours, from about 50 hours to about 75 hours, from about 55 hours to about 70 hours, from about 60 hours to about 65 hours, from about 75 hours to about 100 hours, from about 80 hours to about 95 hours, from about 85 hours to about 90 hours).

In some aspects, the third heating temperature is about 1,100° C. or more (e.g., about 1,110° C. or more, about 1,120° C. or more, about 1,130° C. or more, about 1,140° C. or more, about 1,150° C. or more, about 1,160° C. or more, about 1,170° C. or more, about 1,180° C. or more, about 1,190° C. or more, about 1,200° C. or more, about 1,210° C. or more, about 1,220° C. or more, about 1,230° C. or more, about 1,240° C. or more, about 1,250° C. or more). In some aspects, the third heating temperature is about 1,250° C. or less (e.g., about 1,240° C. or less, about 1,230° C. or less, about 1,220° C. or less, about 1,210° C. or less, about 1,200° C. or less, about 1, 190° C. or less, about 1,180° C. or less, about 1, 170° C. or less, about 1,160° C. or less, about 1,150° C. or less, about 1,140° C. or less, about 1,130° C. or less, about 1,120° C. or less, about 1,110° C. or less, about 1,100° C. or less). The third heating temperature can range from any of the minimum values described above to any of the maximum values described above. For example, in some aspects, the third heating temperature is from about 1,100° C. to about 1,250° C. (e.g., from about 1, 110° C. to about 1,240° C., from about 1,120° C. to about 1,230° C., from about 1,130° C. to about 1,220° C., from about 1,140° C. to about 1,210° C., from about 1, 150° C. to about 1,200° C., from about 1,160° C. to about 1,190° C., from about 1, 170° C. to about 1,180° C., from about 1,100° C. to about 1,180° C., from about 1, 110° C. to about 1,170° C., from about 1,120° C. to about 1,160° C., from about 1, 130° C. to about 1,150° C., from about 1,170° C. to about 1,250° C., from about 1,180° C. to about 1,240° C., from about 1,190° C. to about 1,230° C., from about 1,200° C. to about 1,220° C.).

In some aspects, the third heating temperature is achieved at a rate of about 20° C./h or more (e.g., about 22° C./h or more, about 25° C./h or more, about 28° C./h or more, about 30° C./h or more, about 32° C./h or more, about 35° C./h or more, about 38° C./h or more). In some aspects, the third heating temperature is achieved at a rate of about 40° C./h or less (e.g., about 35° C./h or less, about 32° C./h or less, about 30° C./h or less, about 28° C./h or less, about 25° C./h or less, about 22° C./h or less, about 20° C./h or less). The third heating temperature can be achieved at a rate ranging from any of the minimum values described above to any of the maximum values described above. For example, in some aspects, the third heating temperature is achieved at a rate of from about 20° C./h to about 40° C./h (e.g., from about 22° C./h to about 35° C./h, from about 25° C./h to about 32° C./h, from about 28° C./h to about 30° C./h, from about 20° C./h to about 30° C./h, from about 22° C./h to about 28° C./h, from about 28° C./h to about 38° C./h, from about 30° C./h to about 35° C./h).

In some aspects, the mixture is kept at the third heating temperature for about 50 hours or more (e.g., about 55 hours or more, about 60 hours or more, about 65 hours or more, about 70 hours or more, about 75 hours or more, about 80 hours or more, about 85 hours or more, about 90 hours or more, about 95 hours or more, about 100 hours or more). In some aspects, the mixture is kept at the third heating temperature for about 100 hours or less (e.g., about 95 hours or less, about 90 hours or less, about 85 hours or less, about 80 hours or less, about 75 hours or less, about 70 hours or less, about 65 hours or less, about 60 hours or less, about 55 hours or less, about 50 hours or less). The mixture can be kept at the third heating temperature for a duration ranging from any of the minimum values described above to any of the maximum values described above. For example, in some aspects, the mixture is kept at the third heating temperature for from about 50 hours to about 100 hours (e.g., from about 55 hours to about 95 hours, from about 60 hours to about 90 hours, from about 65 hours to about 85 hours, from about 70 hours to about 80 hours, from about 50 hours to about 75 hours, from about 55 hours to about 70 hours, from about 60 hours to about 65 hours, from about 75 hours to about 100 hours, from about 80 hours to about 95 hours, from about 85 hours to about 90 hours).

In some aspects, the cooling to room temperature is achieved at a rate of about 50° C./h or more (e.g., about 60° C./h or more, about 70° C./h or more, about 80° C./h or more, about 90° C./h or more, about 100° C./h or more, about 110° C./h or more, about 120° C./h or more, about 130° C./h or more, about 140° C./h or more, about 150° C./h or more). In some aspects, the cooling to room temperature is achieved at a rate of about 150° C./h or less (e.g., about 140° C./h or less, about 130° C./h or less, about 120° C./h or less, about 110° C./h or less, about 100° C./h or less, about 90° C./h or less, about 80° C./h or less, about 70° C./h or less, about 60° C./h or less, about 50° C./h or less). The cooling to room temperature can be achieved at a rate ranging from any of the minimum values described above to any of the maximum values described above. For example, in some aspects, the cooling to room temperature is achieved at a rate of from about 50° C./h to about 150° C./h (e.g., from about 60° C./h to about 140° C./h, from about 70° C./h to about 130° C./h, from about 80° C./h to about 120° C./h, from about 90° C./h to about 110° C./h, from about 50° C./h to about 100° C./h, from about 60° C./h to about 90° C./h, from about 70° C./h to about 80° C./h, from about 100° C./h to about 150° C./h, from about 110° C./h to about 140° C./h, from about 120° C./h to about 130° C./h).

In yet still further aspects, the polycrystalline material is substantially free of impurities and has a substantially single phase. It is understood that if impurities are present, they can be defined as Mg—IV phase impurity, Mg—V phase impurity, or Si—V phase impurity.

In some aspects, if the impurities are present, they can be present in an amount of about 10 wt % or less (e.g., about 9 wt % or less, about 8 wt % or less, about 7 wt % or less, about 6 wt % or less, about 5 wt % or less, about 4 wt % or less, about 3 wt % or less, about 2 wt % or less, about 1 wt % or less, about 0.5 wt % or less, about 0.1 wt % or less, about 0.05 wt % or less, about 0.01 wt % or less). In some aspects, if the impurities are present, they can be present in an amount of about 0.01 wt % or more (e.g., about 0.05 wt % or more, about 0.1 wt % or more, about 0.5 wt % or more, about 1 wt % or more, about 2 wt % or more, about 3 wt % or more, about 4 wt % or more, about 5 wt % or more, about 6 wt % or more, about 7 wt % or more, about 8 wt % or more, about 9 wt % or more, about 10 wt % or more). If the impurities are present, they can be present in an amount ranging from any of the minimum values described above to any of the maximum values described above. For example, in some aspects, if the impurities are present, they can be present in an amount of from about 0.01 wt % to about 10 wt % (e.g., from about 0.05 wt % to about 9 wt %, from about 0.1 wt % to about 8 wt %, from about 0.5 wt % to about 7 wt %, from about 1 wt % to about 6 wt %, from about 2 wt % to about 5 wt %, from about 3 wt % to about 4 wt %, from about 0.01 wt % to about 4 wt %, from about 0.05 wt % to about 3 wt %, from about 0.1 wt % to about 2 wt %, from about 0.5 wt % to about 1 wt %, from about 3 wt % to about 10 wt %, from about 4 wt % to about 9 wt %, from about 5 wt % to about 8 wt %, from about 6 wt % to about 7 wt %).

In yet still further aspects, the single nonlinear optical crystal formed by the disclosed methods exhibits any of the disclosed above properties.

In yet still further aspects, the method of forming the disclosed herein single nonlinear optical crystal can comprise: a) providing a solution comprising a solute comprising a mixture of Mg, IV and V in a molar ratio from about 0.95:0.95:2 to about 1.05:1.05:2 and a solvent; wherein a mass ratio between the solvent and solute is from about 10:1 to about 4:1; b) sealing the solution in a temperature-resistant container; c) placing the temperature-resistant container in a three-zone furnace, wherein the three-zone furnace exhibits a temperature profile defined by an upper/melt zone temperature, a middle/crystallization zone temperature; and a lower/annealing zone temperature; d) translating the temperature-resistant container vertically, thereby allowing the temperature-resistant container to arrive at a nucleating temperature to form a seeding crystal; e) growing an ingot material from the seeding crystal; and f) forming the single nonlinear optical crystal Mg—IV-V₂, wherein the single nonlinear optical crystal is substantially free of impurities, defined by a single phase and has a size from about 0.1 mm to about 10 cm in length.

In some aspects, the mixture has a molar ratio of Mg, IV, and V of about 0.95:0.95:2 or more (e.g., about 0.96:0.96:2 or more, about 0.97:0.97:2 or more, about 0.98:0.98:2 or more, about 0.99:0.99:2 or more, about 1:1:2 or more, about 1.01:1.01:2 or more, about 1.02:1.02:2 or more, about 1.03:1.03:2 or more, about 1.04:1.04:2 or more, about 1.05:1.05:2 or more). In some aspects, the mixture has a molar ratio of Mg, IV, and V of about 1.05:1.05:2 or less (e.g., about 1.04:1.04:2 or less, about 1.03:1.03:2 or less, about 1.02:1.02:2 or less, about 1.01:1.01:2 or less, about 1:1:2 or less, about 0.99:0.99:2 or less, about 0.98:0.98:2 or less, about 0.97:0.97:2 or less, about 0.96:0.96:2 or less, about 0.95:0.95:2 or less). The mixture can have a molar ratio of Mg, IV, and V ranging from any of the minimum values described above to any of the maximum values described above. For example, in some aspects, the mixture has a molar ratio of Mg, IV, and V of from about 0.95:0.95:2 to about 1.05:1.05:2 (e.g., from about 0.96:0.96:2 to about 1.04:1.04:2, from about 0.97:0.97:2 to about 1.03:1.03:2, from about 0.98:0.98:2 to about 1.02:1.02:2, from about 0.99:0.99:2 to about 1.01:1.01:2, from about 1.01:1.01:2 to about 0.99:0.99:2, from about 1.02:1.02:2 to about 0.98:0.98:2, from about 1.03:1.03:2 to about 0.97:0.97:2, from about 1.04:1.04:2 to about 0.96:0.96:2, from about 1.05:1.05:2 to about 0.95:0.95:2, from about 0.95:0.95:2 to about 1:1:2, from about 0.96:0.96:2 to about 0.99:0.99:2, from about 0.97:0.97:2 to about 0.98:0.98:2, from about 1.01:1.01:2 to about 1.04:1.04:2, from about 1.02:1.02:2 to about 1.03:1.03:2, from about 1.05:1.05:2 to about 1:1:2).

In some aspects, a mass ratio between the solvent and solute is about 4:1 or more (e.g., about 5:1 or more, about 6:1 or more, about 7:1 or more, about 8:1 or more, about 9:1 or more, about 10:1 or more). In some aspects, a mass ratio between the solvent and solute is about 10:1 or less (e.g., about 9:1 or less, about 8:1 or less, about 7:1 or less, about 6:1 or less, about 5:1 or less, about 4:1 or less). A mass ratio between the solvent and solute can range from any of the minimum values described above to any of the maximum values described above. For example, in some aspects, a mass ratio between the solvent and solute is from about 4:1 to about 10:1 (e.g., from about 5:1 to about 9:1, from about 6:1 to about 8:1, from about 4:1 to about 7:1, from about 5:1 to about 6:1, from about 7:1 to about 10:1, from about 8:1 to about 9:1).

In some aspects, a total amount of each component is about 1 g or more (e.g., about 1.5 g or more, about 2 g or more, about 2.5 g or more, about 3 g or more, about 3.5 g or more, about 4 g or more, about 4.5 g or more, about 5 g or more). In some aspects, a total amount of each component is about 5 g or less (e.g., about 4.5 g or less, about 4 g or less, about 3.5 g or less, about 3 g or less, about 2.5 g or less, about 2 g or less, about 1.5 g or less, about 1 g or less). A total amount of each component can range from any of the minimum values described above to any of the maximum values described above. For example, in some aspects, a total amount of each component is from about 1 g to about 5 g (e.g., from about 1.5 g to about 4.5 g, from about 2 g to about 4 g, from about 2.5 g to about 3.5 g, from about 1 g to about 3 g, from about 1.5 g to about 2.5 g, from about 3 g to about 5 g, from about 3.5 g to about 4.5 g).

In yet further aspects, the solution is ground prior to the step of sealing; and wherein grinding is performed in an inert atmosphere. Any known in the art methods of grinding can be used. For example, and without limitations, the material can be ground with mortar and pestle or by any other automatic grinding methods. In yet still further aspects, the inert atmosphere can comprise an inert gas, such as, for example, and without limitations, argon or nitrogen. In yet still further aspects, the grinding can be performed in a glove box.

In still further aspects, the solvent comprises Sb. In yet still further aspects, the solvent comprises Sn. In yet still further aspects, the solvent comprises a combination of Sb and Sn.

In still further aspects, the solution used in this method is formed by mixing Mg, IV and V and the solvent, optionally provided in a powdered form. In still further aspects, the single nonlinear optical crystal Mg—IV—V₂ grows along [111] direction.

In still further aspects, the solution is placed into an alumina crucible which is then placed into the temperature-resistant container. In such aspects, the temperature-resistant container can be a quartz tube. It is understood that the alumina crucible can have any shape that would allow the desired outcome. Yet, in some aspects, the alumina crucible can have a tip-shaped form.

The three-zone furnace is defined by an upper/melt zone temperature, a middle/crystallization zone temperature, and a lower/annealing zone temperature. In some aspects, the temperature profile is achieved with the required gradient temperature of about 10° C. or more (e.g., about 11° C. or more, about 12° C. or more, about 13° C. or more, about 14° C. or more, about 15° C. or more, about 16° C. or more, about 17° C. or more, about 18° C. or more, about 19° C. or more, about 20° C. or more, about 21° C. or more, about 22° C. or more, about 23° C. or more, about 24° C. or more, about 25° C. or more, about 26° C. or more, about 27° C. or more, about 28° C. or more, about 29° C. or more, about 30° C. or more). In some aspects, the temperature profile is achieved with the required gradient temperature of about 30° C. or less (e.g., about 29° C. or less, about 28° C. or less, about 27° C. or less, about 26° C. or less, about 25° C. or less, about 24° C. or less, about 23° C. or less, about 22° C. or less, about 21° C. or less, about 20° C. or less, about 19° C. or less, about 18° C. or less, about 17° C. or less, about 16° C. or less, about 15° C. or less, about 14° C. or less, about 13° C. or less, about 12° C. or less, about 11° C. or less, about 10° C. or less). The temperature profile can be achieved with the required gradient temperature ranging from any of the minimum values described above to any of the maximum values described above. For example, in some aspects, the temperature profile is achieved with the required gradient temperature of about 10° C. to about 30° C. (e.g., from about 11° C. to about 29° C., from about 12° C. to about 28° C., from about 13° C. to about 27° C., from about 14° C. to about 26° C., from about 15° C. to about 25° C., from about 16° C. to about 24° C., from about 17° C. to about 23° C., from about 18° C. to about 22° C., from about 19° C. to about 21° C., from about 10° C. to about 20° C., from about 11° C. to about 19° C., from about 12° C. to about 18° C., from about 13° C. to about 17° C., from about 14° C. to about 16° C., from about 20° C. to about 30° C., from about 21° C. to about 29° C., from about 22° C. to about 28° C., from about 23° C. to about 27° C., from about 24° C. to about 26° C.).

In some aspects, the upper/melt-zone temperature is about 1,000° C. or more (e.g., about 1,010° C. or more, about 1,020° C. or more, about 1,030° C. or more, about 1,040° C. or more, about 1,050° C. or more, about 1,060° C. or more, about 1,070° C. or more, about 1,080° C. or more, about 1,090° C. or more, about 1,100° C. or more, about 1,110° C. or more, about 1,120° C. or more, about 1,130° C. or more, about 1,140° C. or more, about 1,150° C. or more, about 1,160° C. or more, about 1,170° C. or more, about 1,180° C. or more, about 1,190° C. or more, about 1,200° C. or more). In some aspects, the upper/melt-zone temperature is about 1,200° C. or less (e.g., about 1,180° C. or less, about 1,170° C. or less, about 1,160° C. or less, about 1,150° C. or less, about 1,140° C. or less, about 1,130° C. or less, about 1,120° C. or less, about 1,110° C. or less, about 1,100° C. or less, about 1,090° C. or less, about 1,080° C. or less, about 1,070° C. or less, about 1,060° C. or less, about 1,050° C. or less, about 1,040° C. or less, about 1,030° C. or less, about 1,020° C. or less, about 1,010° C. or less, about 1,000° C. or less). The upper/melt-zone temperature can range from any of the minimum values described above to any of the maximum values described above. For example, in some aspects, the upper/melt-zone temperature is from about 1,000° C. to about 1,200° C. (e.g., from about 1,010° C. to about 1,180° C., from about 1,020° C. to about 1,170° C., from about 1,030° C. to about 1,160° C., from about 1,040° C. to about 1,150° C., from about 1,050° C. to about 1,140° C., from about 1,060° C. to about 1,130° C., from about 1,070° C. to about 1,120° C., from about 1,080° C. to about 1,110° C., from about 1,090° C. to about 1,100° C., from about 1,000° C. to about 1,100° C., from about 1,010° C. to about 1,090° C., from about 1,020° C. to about 1,080° C., from about 1,030° C. to about 1,070° C., from about 1,040° C. to about 1,060° C., from about 1,090° C. to about 1,190° C., from about 1,100° C. to about 1,180° C., from about 1,110° C. to about 1,170° C., from about 1,120° C. to about 1,160° C., from about 1,130° C. to about 1,150° C.).

In some aspects, the middle/crystallization zone temperature is set to about 800° C. or more (e.g., about 810° C. or more, about 820° C. or more, about 830° C. or more, about 840° C. or more, about 850° C. or more, about 860° C. or more, about 870° C. or more, about 880° C. or more, about 890° C. or more, about 900° C. or more, about 910° C. or more, about 920° C. or more, about 930° C. or more, about 940° C. or more, about 950° C. or more, about 960° C. or more, about 970° C. or more, about 980° C. or more, about 990° C. or more, about 1,000° C. or more, about 1,010° C. or more, about 1,020° C. or more, about 1,030° C. or more, about 1,040° C. or more, about 1,050° C. or more, about 1,060° C. or more, about 1,070° C. or more, about 1,080° C. or more, about 1,090° C. or more, about 1,100° C. or more). In some aspects, the middle/crystallization zone temperature is set to about 1,100° C. or less (e.g., about 1,090° C. or less, about 1,080° C. or less, about 1,070° C. or less, about 1,060° C. or less, about 1,050° C. or less, about 1,040° C. or less, about 1,030° C. or less, about 1,020° C. or less, about 1,010° C. or less, about 1,000° C. or less, about 990° C. or less, about 980° C. or less, about 970° C. or less, about 960° C. or less, about 950° C. or less, about 940° C. or less, about 930° C. or less, about 920° C. or less, about 910° C. or less, about 900° C. or less, about 890° C. or less, about 880° C. or less, about 870° C. or less, about 860° C. or less, about 850° C. or less, about 840° C. or less, about 830° C. or less, about 820° C. or less, about 810° C. or less, about 800° C. or less). The middle/crystallization zone can be set to a temperature ranging from any of the minimum values described above to any of the maximum values described above. For example, in some aspects, the middle/crystallization zone is set to a temperature of from about 800° C. to about 1,100° C. (e.g., from about 810° C. to about 1,090° C., from about 820° C. to about 1,080° C., from about 830° C. to about 1,070° C., from about 840° C. to about 1,060° C., from about 850° C. to about 1,050° C., from about 860° C. to about 1,040° C., from about 870° C. to about 1,030° C., from about 880° C. to about 1,020° C., from about 890° C. to about 1,010° C., from about 900° C. to about 1,000° C., from about 910° C. to about 990° C., from about 920° C. to about 980° C., from about 930° C. to about 970° C., from about 940° C. to about 960° C., from about 800° C. to about 950° C., from about 810° C. to about 940° C., from about 820° C. to about 930° C., from about 830° C. to about 920° C., from about 840° C. to about 910° C., from about 850° C. to about 900° C., from about 860° C. to about 890° C., from about 870° C. to about 880° C., from about 950° C. to about 1,100° C., from about 960° C. to about 1,090° C., from about 970° C. to about 1,080° C., from about 980° C. to about 1,070° C., from about 990° C. to about 1,060° C., from about 1,000° C. to about 1,050° C., from about 1,010° C. to about 1,040° C., from about 1,020° C. to about 1,030° C.).

In some aspects, the lower/annealing zone temperature is set to about 500° C. or more (e.g., about 510° C. or more, about 520° C. or more, about 530° C. or more, about 540° C. or more, about 550° C. or more, about 560° C. or more, about 570° C. or more, about 580° C. or more, about 590° C. or more, about 600° C. or more, about 610° C. or more, about 620° C. or more, about 630° C. or more, about 640° C. or more, about 650° C. or more, about 660° C. or more, about 670° C. or more, about 680° C. or more, about 690° C. or more, about 700° C. or more, about 710° C. or more, about 720° C. or more, about 730° C. or more, about 740° C. or more, about 750° C. or more, about 760° C. or more, about 770° C. or more, about 780° C. or more, about 790° C. or more, about 800° C. or more, about 810° C. or more, about 820° C. or more, about 830° C. or more, about 840° C. or more, about 850° C. or more, about 860° C. or more, about 870° C. or more, about 880° C. or more, about 890° C. or more, about 900° C. or more). In some aspects, the lower/annealing zone temperature is set to about 900° C. or less (e.g., about 890° C. or less, about 880° C. or less, about 870° C. or less, about 860° C. or less, about 850° C. or less, about 840° C. or less, about 830° C. or less, about 820° C. or less, about 810° C. or less, about 800° C. or less, about 790° C. or less, about 780° C. or less, about 770° C. or less, about 760° C. or less, about 750° C. or less, about 740° C. or less, about 730° C. or less, about 720° C. or less, about 710° C. or less, about 700° C. or less, about 690° C. or less, about 680° C. or less, about 670° C. or less, about 660° C. or less, about 650° C. or less, about 640° C. or less, about 630° C. or less, about 620° C. or less, about 610° C. or less, about 600° C. or less, about 590° C. or less, about 580° C. or less, about 570° C. or less, about 560° C. or less, about 550° C. or less, about 540° C. or less, about 530° C. or less, about 520° C. or less, about 510° C. or less, about 500° C. or less). The lower/annealing zone temperature can be set to a temperature ranging from any of the minimum values described above to any of the maximum values described above. For example, in some aspects, the lower/annealing zone temperature is set to from about 500° C. to about 900° C. (e.g., from about 510° C. to about 890° C., from about 520° C. to about 880° C., from about 530° C. to about 870° C., from about 540° C. to about 860° C., from about 550° C. to about 850° C., from about 560° C. to about 840° C., from about 570° C. to about 830° C., from about 580° C. to about 820° C., from about 590° C. to about 810° C., from about 600° C. to about 800° C., from about 610° C. to about 790° C., from about 620° C. to about 780° C., from about 630° C. to about 770° C., from about 640° C. to about 760° C., from about 650° C. to about 750° C., from about 660° C. to about 740° C., from about 670° C. to about 730° C., from about 680° C. to about 720° C., from about 690° C. to about 710° C., from about 500° C. to about 700° C., from about 510° C. to about 690° C., from about 520° C. to about 680° C., from about 530° C. to about 670° C., from about 540° C. to about 660° C., from about 550° C. to about 650° C., from about 560° C. to about 640° C., from about 570° C. to about 630° C., from about 580° C. to about 620° C., from about 590° C. to about 610° C., from about 700° C. to about 900° C., from about 710° C. to about 890° C., from about 720° C. to about 880° C., from about 730° C. to about 870° C., from about 740° C. to about 860° C., from about 750° C. to about 850° C., from about 760° C. to about 840° C., from about 770° C. to about 830° C., from about 780° C. to about 820° C., from about 790° C. to about 810° C.).

In some aspects, the solution is brought to the described temperatures in the disclosed zones in about 3 hours or more (e.g., about 4 hours or more, about 5 hours or more, about 6 hours or more, about 7 hours or more, about 8 hours or more, about 9 hours or more, about 10 hours or more, about 11 hours or more, about 12 hours or more, about 16 hours or more, about 20 hours or more, about 24 hours or more, about 28 hours or more, about 32 hours or more, about 36 hours or more, about 40 hours or more, about 44 hours or more, about 48 hours or more). In some aspects, the solution is brought to the described temperatures in the disclosed zones in about 48 hours or less (e.g., about 44 hours or less, about 40 hours or less, about 36 hours or less, about 32 hours or less, about 28 hours or less, about 24 hours or less, about 20 hours or less, about 16 hours or less, about 12 hours or less, about 11 hours or less, about 10 hours or less, about 9 hours or less, about 8 hours or less, about 7 hours or less, about 6 hours or less, about 5 hours or less, about 4 hours or less, about 3 hours or less). The solution can be brought to the described temperatures in the disclosed zones in a time ranging from any of the minimum values described above to any of the maximum values described above. For example, in some aspects, the solution is brought to the described temperatures in the disclosed zones in from about 3 hours to about 48 hours (e.g., from about 4 hours to about 44 hours, from about 5 hours to about 40 hours, from about 6 hours to about 36 hours, from about 7 hours to about 32 hours, from about 8 hours to about 28 hours, from about 9 hours to about 24 hours, from about 10 hours to about 20 hours, from about 11 hours to about 16 hours, from about 3 hours to about 12 hours, from about 4 hours to about 11 hours, from about 5 hours to about 10 hours, from about 6 hours to about 9 hours, from about 7 hours to about 8 hours, from about 12 hours to about 48 hours, from about 16 hours to about 44 hours, from about 20 hours to about 40 hours, from about 24 hours to about 36 hours, from about 28 hours to about 32 hours).

In some aspects, the solution is further dwelled at those temperatures for a fifth predetermined time. In some aspects, the fifth predetermined time is about 1 hour or more (e.g., about 2 hours or more, about 3 hours or more, about 4 hours or more, about 5 hours or more, about 6 hours or more, about 7 hours or more, about 8 hours or more, about 9 hours or more, about 10 hours or more, about 11 hours or more, about 12 hours or more, about 13 hours or more, about 14 hours or more, about 15 hours or more, about 16 hours or more, about 17 hours or more, about 18 hours or more, about 19 hours or more, about 20 hours or more, about 21 hours or more, about 22 hours or more, about 23 hours or more, about 24 hours or more). In some aspects, the fifth predetermined time is about 24 hours or less (e.g., about 23 hours or less, about 22 hours or less, about 21 hours or less, about 20 hours or less, about 19 hours or less, about 18 hours or less, about 17 hours or less, about 16 hours or less, about 15 hours or less, about 14 hours or less, about 13 hours or less, about 12 hours or less, about 11 hours or less, about 10 hours or less, about 9 hours or less, about 8 hours or less, about 7 hours or less, about 6 hours or less, about 5 hours or less, about 4 hours or less, about 3 hours or less, about 2 hours or less, about 1 hour or less). The fifth predetermined time can range from any of the minimum values described above to any of the maximum values described above. For example, in some aspects, the fifth predetermined time is from about 1 hour to about 24 hours (e.g., from about 2 hours to about 23 hours, from about 3 hours to about 22 hours, from about 4 hours to about 21 hours, from about 5 hours to about 20 hours, from about 6 hours to about 19 hours, from about 7 hours to about 18 hours, from about 8 hours to about 17 hours, from about 9 hours to about 16 hours, from about 10 hours to about 15 hours, from about 11 hours to about 14 hours, from about 12 hours to about 13 hours, from about 1 hour to about 13 hours, from about 2 hours to about 12 hours, from about 3 hours to about 11 hours, from about 4 hours to about 10 hours, from about 5 hours to about 9 hours, from about 6 hours to about 8 hours, from about 12 hours to about 24 hours, from about 13 hours to about 23 hours, from about 14 hours to about 22 hours, from about 15 hours to about 21 hours, from about 16 hours to about 20 hours, from about 17 hours to about 19 hours).

In some aspects, the step of translating the sealed temperature-resistant container vertically comprises raising the container about 50 mm or more (e.g., about 60 mm or more, about 70 mm or more, about 80 mm or more, about 90 mm or more, about 100 mm or more, about 110 mm or more, about 120 mm or more, about 130 mm or more, about 140 mm or more, about 150 mm or more, about 160 mm or more, about 170 mm or more, about 180 mm or more, about 190 mm or more, about 200 mm or more, about 210 mm or more, about 220 mm or more, about 230 mm or more, about 240 mm or more, about 250 mm or more, about 260 mm or more, about 270 mm or more, about 280 mm or more, about 290 mm or more, about 300 mm or more). In some aspects, the step of translating the sealed temperature-resistant container vertically comprises raising the container about 300 mm or less (e.g., about 290 mm or less, about 280 mm or less, about 270 mm or less, about 260 mm or less, about 250 mm or less, about 240 mm or less, about 230 mm or less, about 220 mm or less, about 210 mm or less, about 200 mm or less, about 190 mm or less, about 180 mm or less, about 170 mm or less, about 160 mm or less, about 150 mm or less, about 140 mm or less, about 130 mm or less, about 120 mm or less, about 110 mm or less, about 100 mm or less, about 90 mm or less, about 80 mm or less, about 70 mm or less, about 60 mm or less, about 50 mm or less). The step of translating the sealed temperature-resistant container vertically can comprise raising the container an amount ranging from any of the minimum values described above to any of the maximum values described above. For example, in some aspects, the step of translating the sealed temperature-resistant container vertically comprises raising the container from about 50 to about 300 mm (e.g., from about 60 mm to about 290 mm, from about 70 mm to about 280 mm, from about 80 mm to about 270 mm, from about 90 mm to about 260 mm, from about 100 mm to about 250 mm, from about 110 mm to about 240 mm, from about 120 mm to about 230 mm, from about 130 mm to about 220 mm, from about 140 mm to about 210 mm, from about 150 mm to about 200 mm, from about 160 mm to about 190 mm, from about 170 mm to about 180 mm, from about 50 mm to about 180 mm, from about 60 mm to about 170 mm, from about 70 mm to about 160 mm, from about 80 mm to about 150 mm, from about 90 mm to about 140 mm, from about 100 mm to about 130 mm, from about 110 mm to about 120 mm, from about 170 mm to about 300 mm, from about 180 mm to about 290 mm, from about 190 mm to about 280 mm, from about 200 mm to about 270 mm, from about 210 mm to about 260 mm, from about 220 mm to about 250 mm, from about 230 mm to about 240 mm).

In some aspects, the sealed temperature-resistant container is raised vertically with a translation rate of about 0.1 mm/h or more (e.g., about 0.2 mm/h or more, about 0.3 mm/h or more, about 0.4 mm/h or more, about 0.5 mm/h or more, about 0.6 mm/h or more, about 0.7 mm/h or more, about 0.8 mm/h or more, about 0.9 mm/h or more, about 1 mm/h or more). In some aspects, the sealed temperature-resistant container is raised vertically with a translation rate of about 1 mm/h or less (e.g., about 0.9 mm/h or less, about 0.8 mm/h or less, about 0.7 mm/h or less, about 0.6 mm/h or less, about 0.5 mm/h or less, about 0.4 mm/h or less, about 0.3 mm/h or less, about 0.2 mm/h or less, about 0.1 mm/h or less). The sealed temperature-resistant container can be raised vertically with a translation rate ranging from any of the minimum values described above to any of the maximum values described above. For example, in some aspects, the sealed temperature-resistant container is raised vertically with a translation rate of from about 0.1 mm/h to about 1 mm/h (e.g., from about 0.2 mm/h to about 0.9 mm/h, from about 0.3 mm/h to about 0.8 mm/h, from about 0.4 mm/h to about 0.7 mm/h, from about 0.5 mm/h to about 0.6 mm/h, from about 0.1 mm/h to about 0.6 mm/h, from about 0.2 mm/h to about 0.5 mm/h, from about 0.3 mm/h to about 0.4 mm/h, from about 0.5 mm/h to about 1 mm/h, from about 0.6 mm/h to about 0.9 mm/h, from about 0.7 mm/h to about 0.8 mm/h).

In yet still further aspects, at these conditions, the sealed temperature-resistant container can pass through the nucleation temperature to form a seeding crystal. In some aspects (for example, in aspects where MgSiP₂ crystal is formed), the nucleation temperature is about 1,050° C. or more (e.g., about 1,060° C. or more, about 1,070° C. or more, about 1,080° C. or more, about 1,090° C. or more, about 1,100° C. or more, about 1,110° C. or more, about 1,120° C. or more, about 1,130° C. or more, about 1,140° C. or more, about 1,150° C. or more, about 1,160° C. or more, about 1,170° C. or more, about 1,180° C. or more, about 1,190° C. or more, about 1,200° C. or more). In some aspects, the nucleation temperature is about 1,200° C. or less (e.g., about 1,190° C. or less, about 1,180° C. or less, about 1,170° C. or less, about 1,160° C. or less, about 1,150° C. or less, about 1,140° C. or less, about 1,130° C. or less, about 1,120° C. or less, about 1,110° C. or less, about 1,100° C. or less, about 1,090° C. or less, about 1,080° C. or less, about 1,070° C. or less, about 1,060° C. or less, about 1,050° C. or less). The nucleation temperature can range from any of the minimum values described above to any of the maximum values described above. For example, in some aspects, the nucleation temperature is from about 1,050° C. to about 1,200° C. (e.g., from about 1,060° C. to about 1,190° C., from about 1,070° C. to about 1,180° C., from about 1,080° C. to about 1,170° C., from about 1,090° C. to about 1,160° C., from about 1,100° C. to about 1,150° C., from about 1,110° C. to about 1,140° C., from about 1,120° C. to about 1,130° C., from about 1,050° C. to about 1,130° C., from about 1,060° C. to about 1,120° C., from about 1,070° C. to about 1,110° C., from about 1,080° C. to about 1,100° C., from about 1,120° C. to about 1,200° C., from about 1,130° C. to about 1,190° C., from about 1,140° C. to about 1,180° C., from about 1,150° C. to about 1,170° C.).

In still further aspects, the ingot material is cooled to room temperature at a predetermined cooling rate. In some aspects, the predetermined cooling range is about 1° C./h or more (e.g., about 2° C./h or more, about 3° C./h or more, about 4° C./h or more, about 5° C./h or more, about 6° C./h or more, about 7° C./h or more, about 8° C./h or more, about 9° C./h or more, about 10° C./h or more, about 11° C./h or more, about 12° C./h or more, about 13° C./h or more, about 14° C./h or more, about 15° C./h or more, about 16° C./h or more, about 17° C./h or more, about 18° C./h or more, about 19° C./h or more, about 20° C./h or more, about 21° C./h or more, about 22° C./h or more, about 23° C./h or more, about 24° C./h or more, about 25° C./h or more, about 26° C./h or more, about 27° C./h or more, about 28° C./h or more, about 29° C./h or more, about 30° C./h or more, about 31° C./h or more, about 32° C./h or more, about 33° C./h or more, about 34° C./h or more, about 35° C./h or more, about 36° C./h or more, about 37° C./h or more, about 38° C./h or more, about 39° C./h or more, about 40° C./h or more, about 41° C./h or more, about 42° C./h or more, about 43° C./h or more, about 44° C./h or more, about 45° C./h or more, about 46° C./h or more, about 47° C./h or more, about 48° C./h or more, about 49° C./h or more, about 50° C./h or more, about 51° C./h or more, about 52° C./h or more, about 53° C./h or more, about 54° C./h or more, about 55° C./h or more, about 56° C./h or more, about 57° C./h or more, about 58° C./h or more, about 59° C./h or more, about 60° C./h or more, about 61° C./h or more, about 62° C./h or more, about 63° C./h or more, about 64° C./h or more, about 65° C./h or more, about 66° C./h or more, about 67° C./h or more, about 68° C./h or more, about 69° C./h or more, about 70° C./h or more, about 71° C./h or more, about 72° C./h or more, about 73° C./h or more, about 74° C./h or more, about 75° C./h or more, about 76° C./h or more, about 77° C./h or more, about 78° C./h or more, about 79° C./h or more, about 80° C./h or more, about 81° C./h or more, about 82° C./h or more, about 83° C./h or more, about 84° C./h or more, about 85° C./h or more, about 86° C./h or more, about 87° C./h or more, about 88° C./h or more, about 89° C./h or more, about 90° C./h or more). In some aspects, the predetermined cooling rate is about 90° C./h or less (e.g., about 89° C./h or less, about 88° C./h or less, about 87° C./h or less, about 86° C./h or less, about 85° C./h or less, about 84° C./h or less, about 83° C./h or less, about 82° C./h or less, about 81° C./h or less, about 80° C./h or less, about 79° C./h or less, about 78° C./h or less, about 77° C./h or less, about 76° C./h or less, about 75° C./h or less, about 74° C./h or less, about 73° C./h or less, about 72° C./h or less, about 71° C./h or less, about 70° C./h or less, about 69° C./h or less, about 68° C./h or less, about 67° C./h or less, about 66° C./h or less, about 65° C./h or less, about 64° C./h or less, about 63° C./h or less, about 62° C./h or less, about 61° C./h or less, about 60° C./h or less, about 59° C./h or less, about 58° C./h or less, about 57° C./h or less, about 56° C./h or less, about 55° C./h or less, about 54° C./h or less, about 53° C./h or less, about 52° C./h or less, about 51° C./h or less, about 50° C./h or less, about 49° C./h or less, about 48° C./h or less, about 47° C./h or less, about 46° C./h or less, about 45° C./h or less, about 44° C./h or less, about 43° C./h or less, about 42° C./h or less, about 41° C./h or less, about 40° C./h or less, about 39° C./h or less, about 38° C./h or less, about 37° C./h or less, about 36° C./h or less, about 35° C./h or less, about 34° C./h or less, about 33° C./h or less, about 32° C./h or less, about 31° C./h or less, about 30° C./h or less, about 29° C./h or less, about 28° C./h or less, about 27° C./h or less, about 26° C./h or less, about 25° C./h or less, about 24° C./h or less, about 23° C./h or less, about 22° C./h or less, about 21° C./h or less, about 20° C./h or less, about 19° C./h or less, about 18° C./h or less, about 17° C./h or less, about 16° C./h or less, about 15° C./h or less, about 14° C./h or less, about 13° C./h or less, about 12° C./h or less, about 11° C./h or less, about 10° C./h or less, about 9° C./h or less, about 8° C./h or less, about 7° C./h or less, about 6° C./h or less, about 5° C./h or less, about 4° C./h or less, about 3° C./h or less, about 2° C./h or less, about 1° C./h or less). The predetermined cooling rate can range from any of the minimum values described above to any of the maximum values described above. For example, in some aspects, the predetermined cooling rate is from about 1° C./h to about 90° C./h (e.g., from about 2° C./h to about 89° C./h, from about 3° C./h to about 88° C./h, from about 4° C./h to about 87° C./h, from about 5° C./h to about 86° C./h, from about 6° C./h to about 85° C./h, from about 7° C./h to about 84° C./h, from about 8° C./h to about 83° C./h, from about 9° C./h to about 82° C./h, from about 10° C./h to about 81° C./h, from about 11° C./h to about 80° C./h, from about 12° C./h to about 79° C./h, from about 13° C./h to about 78° C./h, from about 14° C./h to about 77° C./h, from about 15° C./h to about 76° C./h, from about 16° C./h to about 75° C./h, from about 17° C./h to about 74° C./h, from about 18° C./h to about 73° C./h, from about 19° C./h to about 72° C./h, from about 20° C./h to about 71° C./h, from about 21° C./h to about 70° C./h, from about 22° C./h to about 69° C./h, from about 23° C./h to about 68° C./h, from about 24° C./h to about 67° C./h, from about 25° C./h to about 66° C./h, from about 26° C./h to about 65° C./h, from about 27° C./h to about 64° C./h, from about 28° C./h to about 63° C./h, from about 29° C./h to about 62° C./h, from about 30° C./h to about 61° C./h, from about 31° C./h to about 60° C./h, from about 32° C./h to about 59° C./h, from about 33° C./h to about 58° C./h, from about 34° C./h to about 57° C./h, from about 35° C./h to about 56° C./h, from about 36° C./h to about 55° C./h, from about 37° C./h to about 54° C./h, from about 38° C./h to about 53° C./h, from about 39° C./h to about 52° C./h, from about 40° C./h to about 51° C./h, from about 41° C./h to about 50° C./h, from about 42° C./h to about 49° C./h, from about 43° C./h to about 48° C./h, from about 44° C./h to about 47° C./h, from about 45° C./h to about 46° C./h, from about 1° C./h to about 46° C./h, from about 2° C./h to about 45° C./h, from about 3° C./h to about 44° C./h, from about 4° C./h to about 43° C./h, from about 5° C./h to about 42° C./h, from about 6° C./h to about 41° C./h, from about 7° C./h to about 40° C./h, from about 8° C./h to about 39° C./h, from about 9° C./h to about 38° C./h, from about 10° C./h to about 37° C./h, from about 11° C./h to about 36° C./h, from about 12° C./h to about 35° C./h, from about 13° C./h to about 34° C./h, from about 14° C./h to about 33° C./h, from about 15° C./h to about 32° C./h, from about 16° C./h to about 31° C./h, from about 17° C./h to about 30° C./h, from about 18° C./h to about 29° C./h, from about 19° C./h to about 28° C./h, from about 20° C./h to about 27° C./h, from about 21° C./h to about 26° C./h, from about 22° C./h to about 25° C./h, from about 23° C./h to about 24° C./h, from about 45° C./h to about 90° C./h, from about 46° C./h to about 89° C./h, from about 47° C./h to about 88° C./h, from about 48° C./h to about 87° C./h, from about 49° C./h to about 86° C./h, from about 50° C./h to about 85° C./h, from about 51° C./h to about 84° C./h, from about 52° C./h to about 83° C./h, from about 53° C./h to about 82° C./h, from about 54° C./h to about 81° C./h, from about 55° C./h to about 80° C./h, from about 56° C./h to about 79° C./h, from about 57° C./h to about 78° C./h, from about 58° C./h to about 77° C./h, from about 59° C./h to about 76° C./h, from about 60° C./h to about 75° C./h, from about 61° C./h to about 74° C./h, from about 62° C./h to about 73° C./h, from about 63° C./h to about 72° C./h, from about 64° C./h to about 71° C./h, from about 65° C./h to about 70° C./h, from about 66° C./h to about 69° C./h, from about 67° C./h to about 68° C./h).

In some aspects, the formed single nonlinear optical crystal has a size of about 0.1 mm or more (e.g., about 0.5 mm or more, about 1 mm or more, about 5 mm or more, about 10 mm or more, about 1.5 cm or more, about 2 cm or more, about 2.5 cm or more, about 3 cm or more, about 3.5 cm or more, about 4 cm or more, about 4.5 cm or more, about 5 cm or more, about 5.5 cm or more, about 6 cm or more, about 6.5 cm or more, about 7 cm or more, about 7.5 cm or more, about 8 cm or more, about 8.5 cm or more, about 9 cm or more, about 9.5 cm or more, about 10 cm or more) in length. In some aspects, the formed single nonlinear optical crystal has a size of about 10 cm or less (e.g., about 9.5 cm or less, about 9 cm or less, about 8.5 cm or less, about 8 cm or less, about 7.5 cm or less, about 7 cm or less, about 6.5 cm or less, about 6 cm or less, about 5.5 cm or less, about 5 cm or less, about 4.5 cm or less, about 4 cm or less, about 3.5 cm or less, about 3 cm or less, about 2.5 cm or less, about 2 cm or less, about 1.5 cm or less, about 10 mm or less, about 5 mm or less, about 1 mm or less, about 0.5 mm or less, about 0.1 mm or less) in length. The formed single nonlinear optical crystal can have a size in length ranging from any of the minimum values described above to any of the maximum values described above. For example, in some aspects, the formed single nonlinear optical crystal has a size of from about 0.1 mm to about 10 cm (e.g., from about 0.5 mm to about 9.5 cm, from about 1 mm to about 9 cm, from about 10 mm to about 8 cm, from about 1.5 cm to about 7.5 cm, from about 2 cm to about 7 cm, from about 2.5 cm to about 6.5 cm, from about 3 cm to about 6 cm, from about 3.5 cm to about 5.5 cm, from about 4 cm to about 5 cm, from about 10 cm to about 0.1 mm, from about 0.1 mm to about 4.5 cm, from about 0.5 mm to about 4 cm, from about 1 mm to about 3.5 cm, from about 10 mm to about 2.5 cm, from about 1.5 cm to about 2 cm, from about 3 cm to about 5 mm, from about 5 cm to about 9.5 cm, from about 5.5 cm to about 9 cm, from about 6 cm to about 8.5 cm, from about 6.5 cm to about 8 cm, from about 7 cm to about 7.5 cm, from about 10 cm to about 4.5 cm) in length.

In still further aspects, the solvent can comprise Sn or Sb. In yet still in By way of a non-limiting illustration, examples of certain aspects of the present disclosure are given below.

### EXAMPLES

The following examples are put forth so as to provide those of ordinary skill in the art with a complete disclosure and description of how the compounds, compositions, articles, devices, and/or methods claimed herein are made and evaluated and are intended to be purely exemplary and are not intended to limit the disclosure. Efforts have been made to ensure accuracy with respect to numbers (e.g., amounts, temperature, etc.), but some errors and deviations should be accounted for. Unless indicated otherwise, parts are parts by weight, temperature is degrees C. or is at ambient temperature, and pressure is at or near atmospheric.

### Example 1

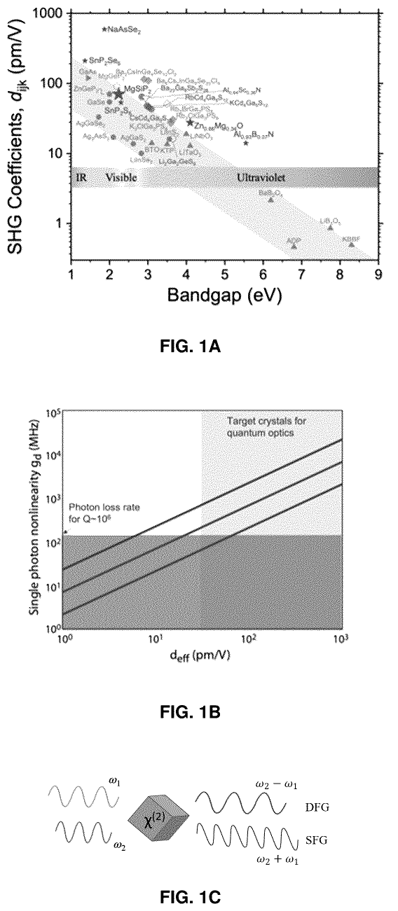

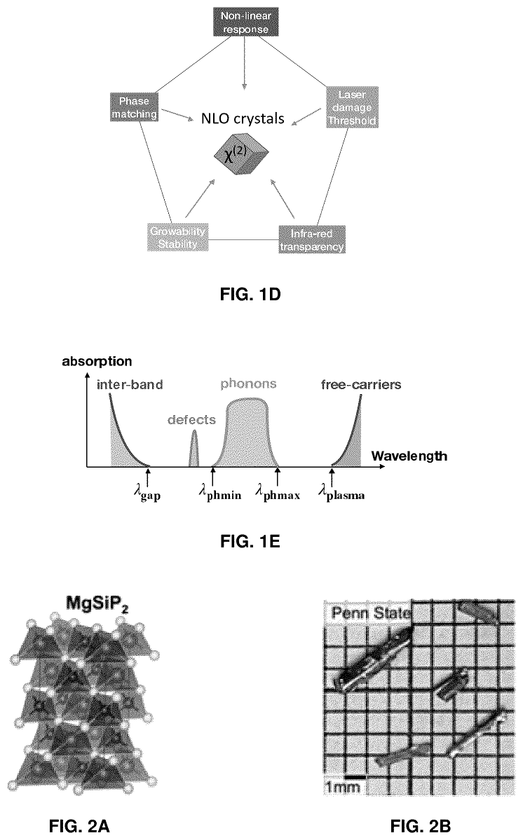

The lack of high-performance NLO single crystals is limiting the development of new laser technologies, especially in the ultraviolet (below 400 nm wavelength), mid-IR (2-25 μm) and far-IR/THz (above 25 μm). High-performance commercial nonlinear optical crystals are a handful: LiNbO₃, β-BaB₂O₄, and KTiOPO₄ (KTP) are the most popular in the visible. The dearth of nonlinear crystals is even more severe in the infrared and in the ultraviolet (see FIG. 1A). The current disclosure addresses second-order nonlinearity characterized by tensor coefficients, dᵢⱼₖ that combine two photons to create a third photon; all three photons can have different frequencies (colors), thus generating new light colors. One typically desires a large transparency range (hence a large bandgap E_{g}) and a large dᵢⱼₖ to maximize the frequency conversion efficiency. However, as seen in FIG. 1A, E_{g} and dᵢⱼₖ are inversely related to each other. While larger electronic gaps do indeed lead to smaller linear and nonlinear electronic polarizabilities, a grand challenge is to find outliers that can best optimize E_{g} and dᵢⱼₖ beyond the grey band in FIG. 1A.

Quantum optics demands strong nonlinear optical effects, particularly at the single-photon and few-photon levels, which represents the ultimate efficiency of nonlinear optics, and underlies crucially many important quantum photonic functionalities such as photon blockade and single-photon transistor, deterministic quantum logic gating, on-demand generation and manipulation of quantum entanglement, high-efficiency single-photon conversion and detection, to name a few. In general, the strength of second-order nonlinear optical interaction can be quantified by the single-photon nonlinearity, given by

$${g}_{d} = \sqrt{ℏ} {ω}^{3 / 2} {d}_{eff} / {n}_{o}^{3} \sqrt{{ε}_{o} V} ,$$

where d_{eff} is an effective second-order nonlinear coefficient (in pm/V; it is a combination of various dᵢⱼₖ for a given measurement geometry), w is the resonance frequency of optical cavity mode (in s⁻¹), nₒ is the refractive index of the optical medium, and Vis the effective mode volume of nonlinear optical interactions (in μm³), and eₒ is the vacuum permittivity (in C/Vm). Of particular interest is the strong coupling regime where g_{d}>k, where k is the loss rate, and where even a single photon can produce a very significant nonlinear effect.

As FIG. 1B shows, for practical cavity mode volumes, this requires a large non-resonant (low loss) second-order nonlinearity of d_{eff}>˜50 pm/V. The consequence of strong single-photon nonlinearity is very profound. With the required energy of ˜0.1 attoJoules for a single photon in the telecom band, this would result in orders of magnitude improvement in energy efficiency, making nonlinear optical switching a real compelling technique in photonic signal processing. However, new nonlinear crystals are required to crack open this field of single photon strong nonlinearity regime.

The disclosure aims to synthesize and characterize promising nonlinear optical single crystals (outliers above the grey band in FIG. 1A that optimize the highest second-order nonlinear optical coefficients with the largest bandgap (Eg>2 eV) towards efficient frequency conversion.

Light-matter interaction is classically described by the polarization response of a material to an electric field (Eⱼ) given by,

$${P}_{i} = {ε}_{0} {χ}_{i j}^{( 1 )} {E}_{j} + {χ}_{i j k}^{( 2 )} {E}_{j} {E}_{k} + … extending to higher order terms ) .$$

(Note that dᵢⱼₖ=½ χᵢⱼₖ⁽²⁾ where the dummy subscripts keep track of the polarization directions of the interacting photons). The complex linear susceptibility tensor χᵢⱼ⁽¹⁾ sets the complex refractive index, n as nᵢⱼ²=1+χᵢⱼ⁽¹⁾.

However, under intense electric fields of light, higher-order effects become important, which collectively form the field of non-linear optics (NLO). For example, through the second-order term, χ⁽²⁾, an electric field E˜cos ωt (ω is the frequency of light, determining its color, and it is time) will give rise to a nonlinear polarization,

$$P ∼ {χ}^{( 2 )} {cos}^{2} ω t = ( {χ}^{( 2 )} / 2 ) ( cos 0 ω t + cos 2 ω t ) . ) .$$

As one notes, new colors of light are generated by the crystal, namely ω+ω=2ω (called second harmonic generation, SHG) and ω−ω=0 (called optical rectification). SHG is a special case of sum frequency generation (SFG), and the rectification is a special case of difference frequency generation (DFG), as shown in FIG. 1C. Multiple photons of different colors can combine in various ways to give a single photon (called SFG), or multiple photons of different colors can interact through the NLO crystal to create photons corresponding to their frequency difference (called DFG). DFG is particularly useful to create lower energy infrared photons starting from a higher frequency incident photon. Conversely, SFG can create infrared photons starting from a CO₂ laser at 10.6 μm or ultraviolet light from visible. As understood by the skilled practitioner, an important aspect of frequency conversion is phase-matching, where different nonlinear waves involved in a process must travel with the same phase velocity inside the crystal for efficient frequency conversion. The emerging field of quantum photonics also depends on NLO materials and their ability to generate pairs of entangled photons through spontaneous parametric down-conversion. In this example, the inventors have focused on the second-order NLO process, χ⁽²⁾.

The requirements for efficient NLO crystals are summarized below and shown in FIGS. 1D and 1E.

One of the requirements is non-centrosymmetry, i.e., the material must lack a center of inversion symmetry. Further, a large non-linear susceptibility, i.e. χ⁽²⁾, or in tensor form, dᵢⱼₖ (=½χᵢⱼₖ⁽²⁾) is desired; For mid-infrared wavelengths (λ>1 μm), d_{eff}>20-100 pm/V and for the ultraviolet (λ˜150−40 nm), a d_{eff}>3-10 pm/V is desired at a minimum.

Further, a large transparency range in the wavelength of interest, such as λ˜0.8-15 μm and beyond for DFG in the infrared and λ˜0.1-0.4 μm for SFG in the visible/ultraviolet. This requires large electronic bandgaps of E_{g}>1.5 eV for the DFG in the infrared and >2 eV for the SFG in the visible/ultraviolet. It also requires the energy at which multiphonon absorption begins to be small (e.g., Eₚₕₒₙₒₙ<60 meV). The transparency window for a photon of energy E is defined as E_{g}>E>Eₚₕₒₙₒₙ (FIGS. 1D-1E).

Still further, a moderate birefringence of Δn˜0.05-0.2 for dispersion phase-matching is required. This is a process of momentum conservation between photons that leads to high NLO efficiency.

Yet still further chemical and thermal stability and ease of large crystal growth are needed. Congruent compositions are the easiest to grow, but they may have non-stoichiometric defects.

Also, efficient NLO crystals are needed to build a laser with a high laser damage threshold (LDT): i.e., the laser power density at which damage or thermal lensing occurs must be large. This typically scales with E_{g} and lower physical and chemical defects.

Tradeoffs abound, such as large band gaps, E_{g}, correlate with large LDT's but smaller NLO dᵢⱼₖ coefficients (see FIG. 1A). High LDT also requires very low defect concentrations to minimize absorption and thermal lensing of the laser beam. Too small a birefringence cannot lead to phase-matching, while too large a birefringence leads to a “beam walk-off” problem that reduces the distance over which the photons interact within the crystal and thus limits the NLO efficiency.

Consider the classical theory of an electron in a nonlinear potential given by

$$U = ( 1 / 2 ) {k}_{s} {x}^{2} + ( 1 / 3 ) Am {x}^{3} + …$$

where kₛ is a spring constant reflecting the binding energy of the electron of mass m and charge e, x is the displacement of this spring under an incident light field, E, of frequency ω, and A reflects the nonlinearity of the anharmonic potential well. Ignoring the tensor notation for the moment, the second-order non-resonant optical constants, χ, in the total polarization P=εₒχE+χ⁽²⁾ E²+ . . . can then be derived as: εₒχ=Nₑe²/m(ωₒ²−ω²) and 2d=χ⁽²⁾=(mAεₒ³/Nₑ²e²)χ² (ω)χ(2ω). Here, Nₑ is the density of electron springs of resonant frequency ωₒ, and optical absorption is excluded for simplicity.

Even in this classical approach, one can immediately conclude the basic design principles: (1) Large non-resonant linear optical susceptibilities χ(2ω) and χ(ω) give rise to large non-resonant SHG nonlinear susceptibility, χ⁽²⁾; hence large refractive indices are desired, which in turn depend on a proximal resonance with a large pair density of states (PDOS). As will be seen below, lower dimensional motifs (weakly bonded 0D polyhedra, 1D chains, 2D sheets etc.) within a 3D crystal can give flat bands and larger PDOS.

(2) Larger the anharmonicity of the potential well that the electron sees (parameter A above), the larger is the nonlinear coefficient d. In ferroelectrics, d∝QP⁰, where P⁰ is the spontaneous ferroelectric polarization that breaks inversion symmetry and the Q˜Qᵢⱼₖₗ is a fourth-rank tensor in the paraelectric phase. Thus, a strong ferroelectric polarization should enhance d.

In the examples of the present disclosure, chalcopyrites, MgSiP₂ and MgGeP₂ were synthesized. Chalcopyrites for NLO possess diamond-like non-centrosymmetric structures with I4̅2d space group that permits nonzero d₁₄=d₂₅ and d₃₆ second-order NLO coefficients that are, in principle, phase-matchable. Recently, high throughput and density functional theory (DFT) calculations have explored Mg—IV—V₂ (IV═Si, Ge, Sn; V═P, As) using the first-principles theory. FIG. 1A depicts that of these, the predicted d₃₆ values of MgSiP₂ are close to two times that of the benchmark AgGaSe₂. The predicted value of MgGeP₂ is almost three to four times that of AgGaSe₂. However, no single-crystal optical studies have been performed so far to determine their complete tensors or phase-matching conditions. The d₃₆ values increase dramatically in the regions dominated by Si, Ge-p and P-p orbitals of the anionic units [IV—V₂]²⁻. The stronger covalent characters of Si—V and Ge—V bonds enhance the interband dipole moment and hence leads to a stronger SHG response. The MgSiP₂ single crystals were successfully synthesized, as shown in Example 2.

Initial optical SHG measurements from 1.55 μm fundamental to 0.775 μm fundamental wavelengths, obtained in this example, suggest a giant nonlinear coefficient of d_{eff}˜85 pm/V (see FIG. 1A), which significantly exceeds the theory prediction above, indicating that d₁₄, the other non-zero coefficient might also be huge. If so, and if it is phase-matchable, then a 2-3 times increase in d coefficient can lower the incident power by 4-9 times, thus reducing the laser damage issues.

In addition to a large bandgap and large nonlinear coefficients, one requires phase-matching for efficient frequency conversion. The basic idea is that different colors of light interacting in a crystal need to travel with the same phase velocity for the highest efficiency of NLO frequency conversion. There are two approaches for achieving this: Dispersion phase-matching and quasi-phase matching. In the former, in crystals with moderate birefringence, one can find conditions where different nonlinear waves propagate with the same phase velocity. In the latter, one artificially creates a domain grating that compensates for a specific phase-mismatch.

Determination of the conditions for dispersion phase matching in NLO requires accurate determination of ñᵢⱼ(ω) as a function of temperature. This can be arranged by exploiting the anisotropic refractive indices of the crystal. For a negative uniaxial crystal (nₒ(ω)>nₑ (ω)), Type I phase matching in the SHG process aims to find a crystal orientation where nₑ(2ω)=nₒ(ω), while Type II phase matching aims to find the condition where 2nₑ (2ω)=nₒ(ω)+nₑ(ω). These dispersion phase-matching conditions can be determined using cutting and polishing to take advantage of this phase-matching condition and tested in an optical parametric oscillator cavity.

Where dispersion phase matching is not possible, quasi-phase-matching can be employed.

In pursuit of the vision of single photon nonlinearity posed in FIG. 1B, resonant microcavities from the most promising NLO crystals with the largest d_{eff} (>50 pm/V) and lowest optical losses were designed. High Q ring cavities can be created, and modal phase matching can be achieved between fundamental and second harmonic waves. The single photon nonlinearity, g_{d}, was quantified by measuring the efficiency of the process of a single 2ω photon down-converted to two ω photons. There are two ways the present application explores this. First, by modal dispersion phase matching, a lower order 2ω optical cavity mode can be made to phase match with a higher order w optical cavity mode. Second, if the cavity itself is periodically poled, such that the period of poling, Λ=2πr, as follows: Λ=2π/(k^{2ω}−2k^{ω}), where k are the wavevectors for the fundamental mode at the two frequencies, then a quasi-phase-matched cavity can be used for sum or difference frequency generation.

### Example 2

Generally, for practical use, and as disclosed above, the infrared NLO materials should satisfy the following requirements: large second-order nonlinearity (large SHG coefficients), broad transparency window, phase matchability, high LDT values, and good crystal growth habit. The main challenge of NLO crystal discovery is balancing the SHG coefficients and the bandgap since large bandgaps generally lead to high LDT values but small SHG coefficients. FIG. 1A shows the SHG coefficients vs. bandgap for some well-known NLO crystals. It depicts a general trend that an increase in the bandgap of a crystal can result in a decrease in the SHG coefficient.

The diamond-like structure can be derived from the diamond structure and consists of vertex-sharing tetrahedra, which are aligned along the same direction. The aligned tetrahedra lead to not only the intrinsic noncentrosymmetric nature but also the superposition of the NLO effects from each microscopic building unit and, therefore, a large macroscopic SHG response.

In this example, the disclosed NLO crystal is represented by MgSiP₂, which is a metal pnictide with the chalcopyrite structure similar to ZnGeP₂. MgSiP₂ exhibits giant second-order nonlinearity and phase-matchability, promising for high-efficiency laser applications.

In addition to the nonlinear optical frequency conversion application mentioned above, these crystals in the family Mg—IV—V₂ (IV═Si, Sn and Ge, and V═P and As) exhibit superior electro-optic coefficients. Electro-optics is the phenomenon where the refractive index of the material changes in response to an electric field. This is crucial to powering the internet, where the conversion between electrical and optical signals is performed by electro-optic crystals. The current industry standard is LiNbO₃. However, the above family of crystals could also have large electro-optic coefficients; these properties will be addressed in the present application.

Finally, in addition to second-order optical nonlinearities, third-order nonlinearities leading to the third harmonic generation and nonlinear absorption and nonlinear refraction are also superior.

The single nonlinear optical crystals MgSiP₂ were synthesized using the flux method. Mg turnings, Si powder, and P powder with a molar ratio of 1:1:2 were put into an alumina crucible. The Sb powder was added to the alumina crucible and formed an 83.4 mass percent solution with the raw materials. The alumina crucible was inserted into a quartz tube and sealed under a vacuum. The sealed ampoule was placed inside a muffle furnace and heated to 1100° C. in 48 hours to ensure homogeneous melt, followed by slow cooling at a rate of 3° C./h to 650° C. The excessive Sb flux was then removed by centrifugation. The red transparent needle-like MgSiP₂ single crystals were well separated from the flux, with typical dimensions of 0.3-0.5 mm (width)×0.3-0.4 mm (thickness)×2-6 mm (length). X-ray diffraction (XRD) and transmission electron microscopy (TEM) analysis confirmed the crystal structure was the same as the reported one of MgSiP₂. The composition analyses using an energy dispersive spectrometer (EDS) also confirmed the obtained crystals have compositions close to the expected stoichiometric composition in MgSiP₂.

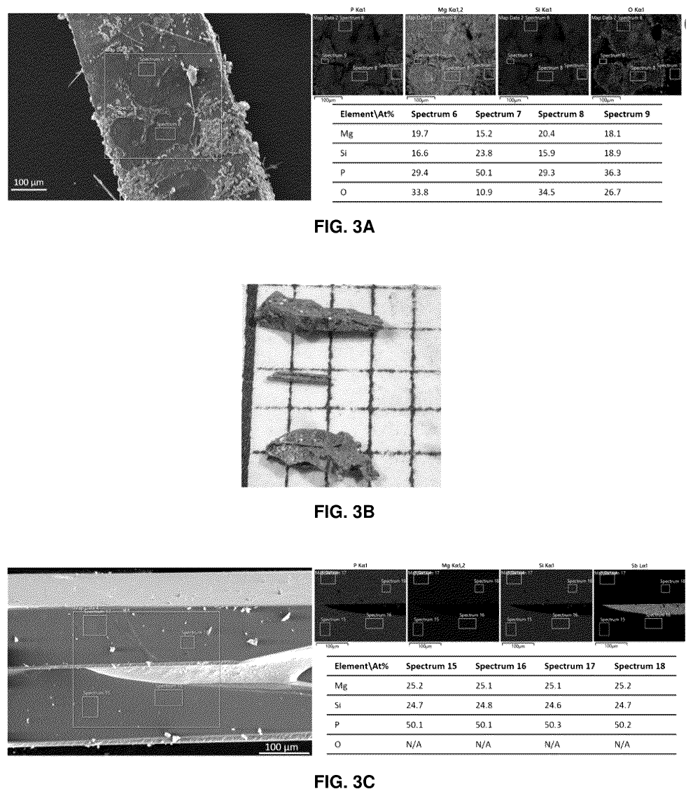

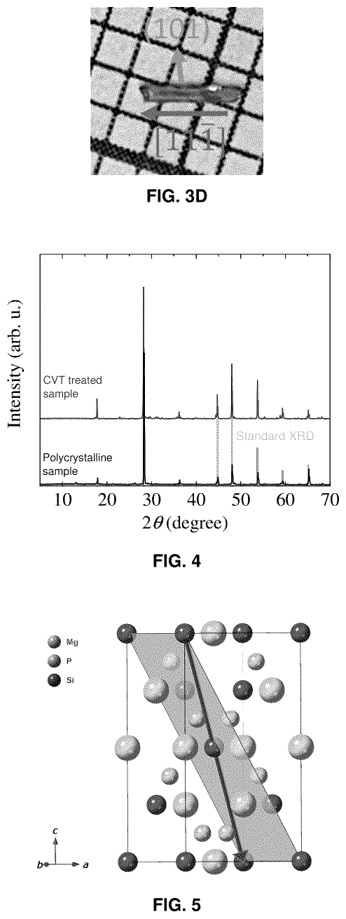

The CVT method was used to mimic the vacuum distillation method previously used to form MgSiP₂ crystals. The flux-grown crystals and Sb flux were sealed in quartz tubes under a high vacuum. No transport agents, such as 12, were added. The sealed quartz tubes were then put into a CVT furnace. The hot end temperature was set to 700° C., and the cold end temperature was set to 600° C. The tubes were heated for 1 week to ensure the total removal of Sb flux. The remaining part is the MgSiP₂ crystals with black color, as shown in FIG. 3B. CVT (vacuum distillation) grown crystals are darker compared to the crystals grown according to the methods disclosed herein (flux (centrifugal) grown crystals), as can be seen from the crystal image shown in FIGS. 3B and 3D. SEM images also suggest that CVT-grown crystals have dirty surfaces compared to the crystals obtained by the disclosed herein methods. (FIGS. 3A and 3C, respectively). Large amount of oxygen element was detected in the CVT-treated crystals, and no oxygen was detected in the flux (centrifugal) grown crystals, as shown in FIGS. 3A and 3C, respectively. The XRD measurements of the CVT-treated crystal and polycrystalline samples obtained accordingly to the disclosed methods show that the CVT-treated sample exhibits phase impurities not observed in the r polycrystalline sample (FIG. 4).

MgSiP₂ was also investigated using first-principles calculations. Its conventional tetragonal cell has one internal parameter x associated with the position of P atoms (8d Wyckoff sites). all the simulations were performed with the ABINIT software in the framework of density-functional theory (DFT) for the ground-state (GS) calculations and the density-functional perturbation theory (DFPT) for the response functions. The wavefunctions were expanded on a plane-wave basis set using a kinetic energy cutoff of 42 Ha, in combination with scalar relativistic Optimized Norm-Conserving Vanderbilt Pseudopotentials (ONCVPSP) from the PseudoDojo. The DFT and DFPT calculations adopted the local-density approximation (LDA) for the exchange-correlation energy. As an alternative, the Perdew-Burke-Ernzerhof generalized-gradient approximation was also tested for the ground-state calculations, but it did not lead to any significant changes.

All relaxations were performed using a 10×10×10 Monkhorst-Pack k-point mesh to sample the Brillouin zone. The structure was optimized until the maximum force on each atom was lower than 2.5 meV/Å. The relaxation of the tetragonal cell parameters (a and c) resulted in an excellent agreement with their experimental values:

$$\frac{\vert {a}_{e x p} - {a}_{L D A} \vert}{{a}_{e x p}} = 0 \text{.75} \% \frac{\vert {c}_{e x p} - {c}_{L D A} \vert}{{c}_{e x p}} = 0 \text{.58} \%$$

Table 1 summarizes the conditions used for the synthesis of MgSiP2 according to the methods with a CVT treatment and centrifugal treatment.

| Flux removal | CVT (vacuum distillation) | |
|---|---|---|
| method | (control) | Centrifugal |
| Temperature | High-purity Mg turnings, Si | High-purity Mg turnings, Si |
| profile | powder, and P powder with | powder, and P powder with |
| | a mole ratio of 1:1:2 were | a mole ratio of 1:1:2 were |
| | put into alumina crucibles. | put into alumina crucibles. |
| | Sb powder was added to the | Sb powder was added to the |
| | alumina crucible and | alumina crucible and |
| | formed a 10-mass percent | formed a 16.6 mass percent |
| | solution with the raw | solution with the raw |
| | materials. Temperature | materials. The alumina |
| | ramped to 1150° C. in 30 | crucibles were then put into |
| | hours due to a large amount | clear silica tubes and sealed |
| | of chemicals inside the | under a vacuum with the |
| | crucible. After heating at | typical vacuum level |
| | 1150° C. for two hours, | ranging from 3*10⁻⁴ torr |
| | the ampoules were cooled | to 9*10⁻⁴ torr. The |
| | down at a rate of 30° C. | sealed ampoules were then |
| | per hour down to room | placed inside a muffle |
| | temperature. The flux-grown | furnace and then heated to |
| | crystal and Sb flux around | 1100° C. for 48 hours to |
| | them was sealed in quartz | ensure homogeneous melt, |
| | tubes under a high vacuum. | followed by slow cooling at |
| | No transport agents, such | 3° C./h to 650° C. The |
| | as I₂, were added. | MgSiP₂ crystals were |
| | The sealed quartz tubes | separated from the Sb flux |
| | were then put into a CVT | through centrifugation. We |
| | furnace. Hot end temperature | removed the sealed tube |
| | was set to 700° C., and | from the furnace at |
| | the cold end temperature | 650° C., above the Sb |
| | was set to 600° C. The | melting point, and then |
| | tubes were heated for 1 week | immediately centrifugated it |
| | to ensure the total removal | to remove the Sb flux from |
| | of Sb flux. | the small crucible. After |
| | | centrifugation, the crystals |
| | | remained in the crucible |
| | | while the Sb flux in liquid |
| | | form spun off. The |
| | | needle-like MgSiP₂ single |
| | | crystals were well separated |
| | | with flux. |
| Detailed | CVT temperature: hot end | Centrifugal speed: |
| information | 700° C.; cold end 600° C. | 1400 rpm |
| | | Centrifugal temperature: |
| | | 600° C.-650° C. |

Since reliable third-order energy derivatives typically require a denser sampling of the Brillouin zone, a 16×16×16 Monkhorst-Pack k-point mesh was adopted for all the calculations other than the relaxations. For the optical properties, a scissor shift was systematically applied on all conduction bands to match the experimental bandgap of 2.34 eV.

The static high-frequency (clamped-ions) dielectric and SHG tensors were first computed within DFPT using ABINIT. Thanks to the Optic utility of ABINIT, their frequency-dependent counterparts were calculated in the independent-particle approximation with a sum-over-states approach as developed by Hughes and Sipe. The inclusion of the anti-resonant terms results from an unpublished modification of the Optic utility. A total of 60 empty conduction bands (i.e., all the bands up to 25 eV above the valence band maximum) were included in the computation. Divergences were avoided by smoothing the spectrum with a broadening of 0.002 Ha (54 meV). The dielectric function provides the refractive index and extinction coefficients following the usual relations.

The crystal structure was first fully relaxed, adopting the local-density approximation (LDA) for the exchange-correlation (XC) energy. The MgSiP₂ as synthesized herein has a crystal structure defined by unit cell parameters a=5.721 Å, c=10.037 Å, x=0.207, and a unit cell volume of 330.4 Å³, wherein the single nonlinear optical crystal exhibits a refractive index of about 2.776 to about 2.778 and from about 2.806 to about 2.808 for nₒ and nₑ respectively at a wavelength of 1,550 nm, and a nonlinear coefficient of d_{eff} of SHG from about 80 to about 95 pm/V. Calculated and experimental cell and internal parameters were found to be in excellent agreement with a difference below 1%. Finally, a relaxation of the internal parameter was also performed while keeping the cell parameters a and c fixed to their experimental values. This led to x=0.207 and a distortion parameter

$$u = \frac{1}{4} + \frac{{d}_{M g - P}^{2} - {d}_{S i - P}^{2}}{{a}^{2}} = 0.2 \; 93$$

in accordance with previous investigations. The resulting structure was used in all subsequent computations unless stated otherwise.

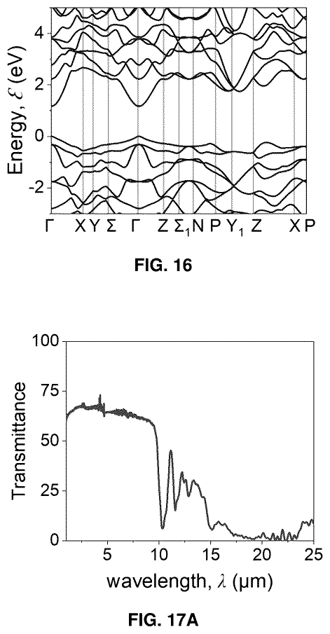

The band structure, shown in FIG. 16, was computed in the same framework. The predicted 1.17 eV bandgap is direct and greatly underestimates the experimental value of 2.34 eV. Such a discrepancy is inherent to DFT when using local or semi-local functionals for the XC energy. Since optical properties are directly related to the bandgap, the latter was systematically corrected to match the experimental gap by applying a scissor shift to all conduction bands. The band structures with internal relaxation and scissor shift are shown in FIG. 23.

### Example 3

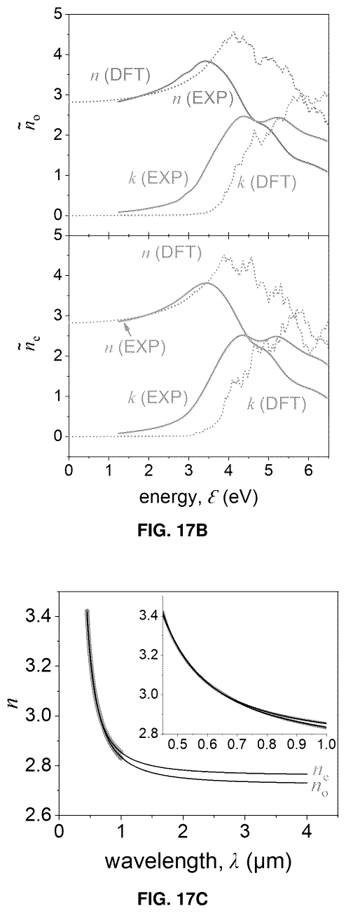

In this example, the linear optical properties of MgSiP₂ were investigated. The infrared transparency of MgSiP₂ was determined using Fourier transform infrared (FTIR) spectroscopy equipped with a 15×objective to ensure that the beam was focused on an area with uniform thickness. The transmittance spectrum shown in FIG. 2A and FIG. 17A was collected on the (112) plane of a single crystal with a thickness of ˜225 μm in the spectral range of 1-25 μm at room temperature. It was found that MgSiP₂ is transparent up to ˜10.35 μm. Given that its bandgap is 2.34 eV (˜0.53 μm), MgSiP₂ has a large transparency window of 0.53-10.35 μm. Though AgGaS₂, AgGaSe₂ and ZnGeP₂ are transparent further into the infrared region (13.2 μm, 13.22 μm and 10.7 μm respectively), it is better than CdSiP₂ (9.5 μm), allowing broadband tunability.

The anisotropic complex linear optical constants ñ=n+ik were determined using spectroscopic ellipsometry (Woollam M-2000F). Since MgSiP₂ belongs to the tetragonal crystal system, it is a uniaxial crystal with two distinct complex refractive indices: ordinary ñₒ in the plane perpendicular to the 4-fold rotation axis, and extraordinary ñₑ along the 4-fold rotation axis.

The measurement was performed on the (101) plane of MgSiP₂ in two different orientations where the orientation [111̅] was parallel and perpendicular to the plane of incidence. FIG. 5 illustrates the (101) plane and the [111̅] direction of MgSiP₂ and how they relate to the a, b, and c axes. The ellipsometric spectra collected from 0.200 μm to 1 μm were fitted with the Gaussian oscillators. The constants ñₒ and ñₑ can then be extracted by simultaneously fitting the two sets of ellipsometry data with the Gaussian oscillators (FIGS. 24A-24B), whose fit parameters are listed in Table 2. The dielectric functions and the complex refractive indices were also computed from first principles within DFT-LDA, which show excellent qualitative and quantitative agreement with the experiments, as shown in FIG. 2B and FIG. 17B. From the extrapolation of the experimental result using the Urbach absorption equation

$$k = {k}_{0} {e}^{( E - {E}_{o} ) / {E}_{u}}$$

(detailed parameters are shown in Table 3), the experimental extinction coefficient k in the crystals is currently 0.05 at 1550 nm and ˜0.03 at wavelengths above 3 μm; however, the first principles calculations show that k is 0.02 at 1550 nm and 7×10⁻⁴ above 3 μm. This indicates that the absorption can be improved if the crystals have higher purity and lower defects with better synthesis.

In the process of second harmonic generation (SHG), two photons of frequency ω are combined into one photon of frequency 2ω (ω+ω=2ω) when traveling in a nonlinear optical medium. The nonlinear polarization can be expressed as Pᵢ^{2ω}=dᵢⱼₖEⱼ^{ω}Eₖ^{ω}, where dᵢⱼₖ is the second-order optical susceptibility, E is the incoming electric fields of light, and the subscripts i,j,k are dummy variables describing the polarization of the various photons of light.

TABLE 2
The parameters of each Gaussian oscillator for the
anisotropic linear optical properties.

| n | Aₙ^{o} | Bₙ^{o} | Eₙ^{o} | Aₙ^{e} | Bₙ^{e} | Eₙ^{e} |
|---|---|---|---|---|---|---|
| 1 | 0.471953 | 0.7415 | 1.380 | 0.705190 | 1.5000 | 1.869 |
| 2 | 0.535267 | 0.6213 | 1.903 | 1.595466 | 1.1720 | 2.816 |
| 3 | 0.253523 | 0.4389 | 2.199 | 11.738561 | 1.1339 | 3.816 |
| 4 | 2.045975 | 1.0273 | 2.804 | 6.300771 | 0.9236 | 4.377 |
| 5 | 10.675545 | 1.0064 | 3.759 | 3.038134 | 0.6423 | 5.002 |
| 6 | 6.947348 | 0.7798 | 4.305 | 5.504536 | 1.0572 | 5.279 |
| 7 | 5.289288 | 0.8086 | 5.005 | 3.669765 | 1.1620 | 6.217 |
| 8 | 5.429668 | 2.1412 | 5.695 | — | — | — |

TABLE 3
The parameters of Urbach absorption equations
for extinction coefficients.

| k | k₀ | Eᵤ(eV) | E₀ (eV) |
|---|---|---|---|
| kₒ | 0.06419 | 0.9833 | 0.9999 |
| kₑ | 0.078 | 1.189 | 0.946 |

It is necessary to ensure the SHG process only involves virtual transitions such that the absorption loss is minimized and the process is non-resonant. Since the bandgap of MgSiP₂ is 2.24V, the fundamental wavelength was chosen to be 1550 nm, and the wavelength of the SHG was 775 nm.

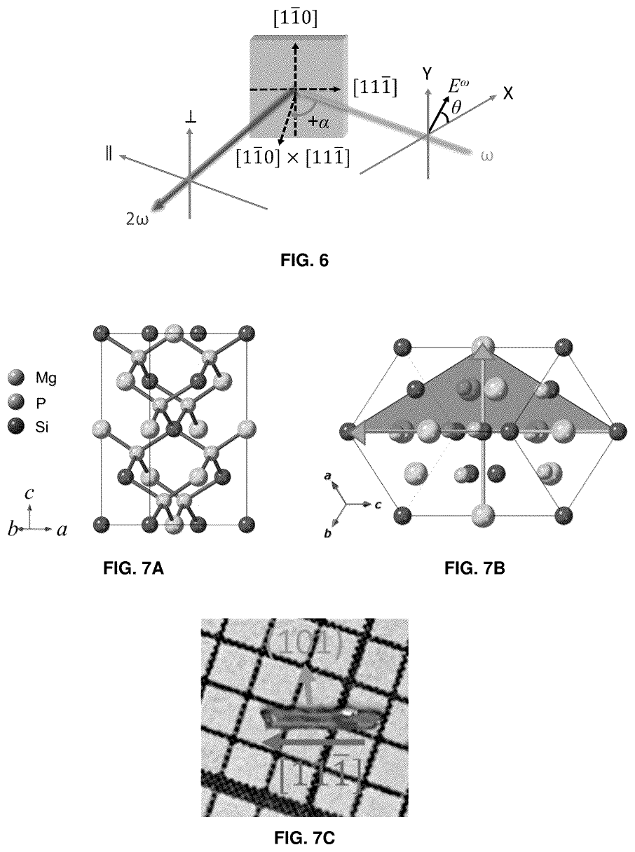

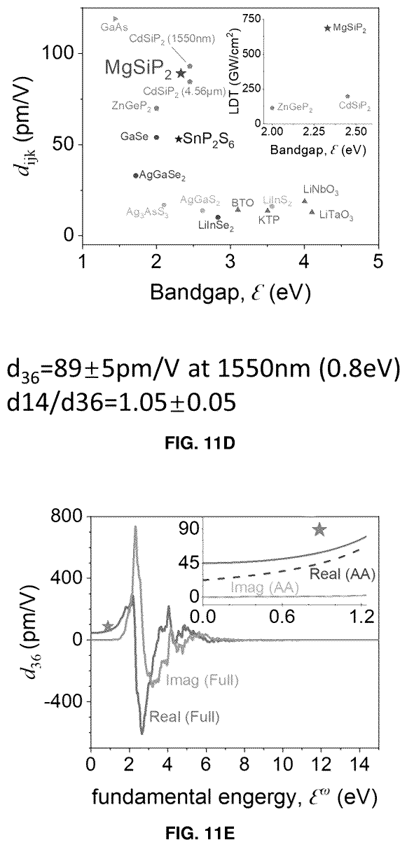

The SHG measurement was performed in reflection geometry, shown in FIG. 6 and FIG. 11A. The 1,550 nm fundamental laser beam was generated by Coherent Libra Amplified Ti:Sapphire Laser (85 fs, 2 kHz). At an incident angle of α=−30°, the fundamental electric field E_{ω} was linear polarized and rotated by an angle of ψ with respect to lab axis X. A wedged crystal with a crystal plane (112) was oriented such that the [111̅] and [11̅0] crystal axes coincide with the lab axes X and Y, respectively. The advantage of using a wedge sample is that only the SHG generated from the front surface needs to be considered, which has proven robustness in extracting the SHG tensor. The relationship between these two directions and the a, b, c axes can be viewed from FIG. 7B. The reflected SHG field was decomposed into p-polarized (∥) and s-polarized (⊥) by an analyzer and detected by a photo-multiplier tube.

For the point group 4̅2m, the d tensor in Voigt notation is:

$$d = ( \begin{matrix}0 & 0 & 0 & {d}_{14} & 0 & 0 \\ 0 & 0 & 0 & 0 & {d}_{14} & 0 \\ 0 & 0 & 0 & 0 & 0 & {d}_{36}\end{matrix} )$$

The theoretical expressions for the SHG intensity in normal reflection geometry were generated by the modeling tool #SHAARP:

$${1}_{X}^{2 ω} = 1.501 \times 1 {0}^{- 5} {( 1 . + cos 2 ψ )}^{2} \text{} {d}_{14}^{2} + \text{} [ - 2.324 \times 1 {0}^{- 5} + 3.123 \times {10}^{- 5} cos 2 ψ + 5.447 \times {10}^{- 5} {( cos 2 ψ )}^{2} ] {d}_{14} {d}_{36} + \text{} [ 9.001 \times 1 {0}^{- 6} - 4.219 \times 1 {0}^{- 5} cos 2 ψ + 4.943 \times 1 {0}^{- 5} {( cos 2 ψ )}^{2} ] {d}_{36}^{2}$$

$${I}_{Y}^{2 ω} = 9.532 \times 1 {0}^{- 5} {( sin 2 ψ )}^{2} {d}_{14}^{2} z$$

The numbers are the numerical values of the relevant Fresnel coefficients (for conversion from 1550 nm to 775 nm) and that of the rotation matrix that transforms the crystal physics coordinates (Z₁, Z₂, Z₃) to the experimental coordinate system (X, Y, Z).

The full analytical expressions for LiNbO₃ and MgSiP₂ are generated using #SHAARP.si package. The X-cut LiNbO₃ (112̅0) is oriented with the c axis parallel to the lab X direction labeled as L₁. Lab Y and Z are labeled as L₂ and L₃ respectively. At normal incidence, the extraordinary wave and ordinary waves at ω

$$\begin{matrix}{ε}_{L a b}^{ω} = ( \begin{matrix}{ε}_{{L}_{1} {L}_{1}}^{ω} & 0 & 0 \\ 0 & {ε}_{{L}_{2} {L}_{2}}^{ω} & 0 \\ 0 & 0 & {ε}_{{L}_{3} {L}_{3}}^{ω}\end{matrix} ) = ( \begin{matrix}{( {n}_{3}^{ω} )}^{2} & 0 & 0 \\ 0 & {( {n}_{1}^{ω} )}^{2} & 0 \\ 0 & 0 & {( {n}_{1}^{ω} )}^{2}\end{matrix} ) \\ {ε}_{L a b}^{2 ω} = ( \begin{matrix}{ε}_{{L}_{1} {L}_{1}}^{2 ω} & 0 & 0 \\ 0 & {ε}_{{L}_{2} {L}_{2}}^{2 ω} & 0 \\ 0 & 0 & {ε}_{{L}_{3} {L}_{3}}^{2 ω}\end{matrix} ) = ( \begin{matrix}{( {n}_{3}^{2 ω} )}^{2} & 0 & 0 \\ 0 & {( {n}_{1}^{2 ω} )}^{2} & 0 \\ 0 & 0 & {( {n}_{1}^{2 ω} )}^{2}\end{matrix} )\end{matrix}$$

The electric field directions and effective refractive indices for both ordinary and extraordinary waves at their corresponding frequencies are

$$\begin{matrix}{E}^{e , ω} = ( 1 , 0 , 0 ) ; {n}_{eff}^{e , ω} = \sqrt{{ε}_{{L}_{1} {L}_{1}}^{ω}} ; {E}^{o , ω} = ( 0 , 1 , 0 ) ; {n}_{eff}^{o , ω} = \sqrt{{ε}_{{L}_{2} {L}_{2}}^{ω}} \\ {E}^{e , 2 ω} = ( 1 , 0 , 0 ) ; {n}_{eff}^{e , 2 ω} = \sqrt{{ε}_{{L}_{1} {L}_{1}}^{2 ω}} ; {E}^{o , 2 ω} = ( 0 , 1 , 0 ) ; {n}_{eff}^{o , 2 ω} = \sqrt{{ε}_{{L}_{2} {L}_{2}}^{2 ω}}\end{matrix}$$

The transmitted electric fields at ω frequencies are expressed below, in agreement with Fresnel coefficients,

$$\begin{matrix}{E}^{T , e , ω} = ( \frac{2 cos φ}{1 + \sqrt{{ε}_{{L}_{1} {L}_{1}}^{ω}}} , 0 , 0 ) \\ {E}^{T , o , ω} = ( 0 , \frac{2 sin φ}{1 + \sqrt{{ε}_{{L}_{2} {L}_{2}}^{ω}}} , 0 )\end{matrix}$$

where superscript T, e, o are transmitted waves, extraordinary wave and ordinary wave, respectively. Azimuthal angle φ describes the rotation of incident polarization, as shown in the SHG polarimetry. The resulting SHG tensor in the lab coordinate system and nonlinear polarizations are thus expressed as,

$$\begin{matrix}d = ( \begin{matrix}{d}_{33} & {d}_{31} & {d}_{31} & 0 & 0 & 0 \\ 0 & {d}_{22} & - {d}_{22} & 0 & 0 & {d}_{15} \\ 0 & 0 & 0 & - {d}_{22} & {d}_{15} & 0\end{matrix} ) \\ {P}^{T , ee , 2 ω} = ( {P}_{{L}_{1}}^{T , ee , 2 ω} , {P}_{{L}_{2}}^{T , e e , 2 ω} , {P}_{{L}_{3}}^{T , ee , 2 ω} ) = ( \frac{4 {( cos φ )}^{2} {d}_{33} {ε}_{0}}{{( 1 + \sqrt{{ε}_{{L}_{1} {L}_{1}}^{ω}} )}^{2}} , 0 , 0 ) \\ {P}^{T , oo , 2 ω} = ( {P}_{{L}_{1}}^{T , oo , 2 ω} , {P}_{{L}_{2}}^{T , oo , 2 ω} , {P}_{{L}_{3}}^{T , oo , 2 ω} ) = ( \frac{4 {( sin φ )}^{2} {d}_{31} {ε}_{0}}{{( 1 + \sqrt{{ε}_{{L}_{2} {L}_{2}}^{ω}} )}^{2}} , \frac{4 {( sin φ )}^{2} {d}_{22} {ε}_{0}}{{( 1 + \sqrt{{ε}_{{L}_{2} {L}_{2}}^{ω}} )}^{2}} , 0 ) \\ {P}^{T , eo , 2 ω} = ( {P}_{{L}_{1}}^{T , eo , 2 ω} , {P}_{{L}_{2}}^{T , e o , 2 ω} , {P}_{{L}_{3}}^{T , e o , 2 ω} ) = ( 0 , \frac{8 sin φcosφ {d}_{15} {ε}_{0}}{( 1 + \sqrt{{ε}_{{L}_{1} {L}_{1}}^{ω}} ) ( 1 + \sqrt{{ε}_{{L}_{2} {L}_{2}}^{ω}} )} , 0 )\end{matrix}$$

here, superscript ee, oo and eo represent the nonlinear polarizations are formed using two extraordinary waves, two ordinary waves or mixtures of extraordinary waves and extraordinary waves. The corresponding electric fields generated by the nonlinear polarizations are thus calculated as shown below,

$$\begin{matrix}{C}^{T , ee , 2 ω} = ( {C}_{{L}_{1}}^{T , ee , 2 ω} , {C}_{{L}_{2}}^{T , e e , 2 ω} , {C}_{{L}_{3}}^{T , e e , 2 ω} ) = ( - \frac{{P}_{{L}_{1}}^{T , ee , 2 ω}}{{ε}_{{L}_{1} {L}_{1}}^{2 ω} {ε}_{0} - {ε}_{{L}_{1} {L}_{1}}^{ω} {ε}_{0}} , 0 , 0 ) \\ {C}^{T , o o , 2 ω} = ( {C}_{{L}_{1}}^{T , oo , 2 ω} , {C}_{{L}_{2}}^{T , oo , 2 ω} , {C}_{{L}_{3}}^{T , oo , 2 ω} ) = ( - \frac{{P}_{{L}_{1}}^{T , oo , 2 ω}}{{ε}_{{L}_{1} {L}_{1}}^{2 ω} {ε}_{0} - {ε}_{{L}_{2} {L}_{2}}^{ω} {ε}_{0}} , - \frac{{P}_{{L}_{2}}^{T , oo , 2 ω}}{{ε}_{{L}_{2} {L}_{2}}^{2 ω} {ε}_{0} - {ε}_{{L}_{2} {L}_{2}}^{ω} {ε}_{0}} , 0 ) \\ {C}^{T , e e , 2 ω} = ( {C}_{{L}_{1}}^{T , eo , 2 ω} , {C}_{{L}_{2}}^{T , e o , 2 ω} , {C}_{{L}_{3}}^{T , e o , 2 ω} ) = ( 0 , - \frac{4 {P}_{{L}_{2}}^{T , eo , 2 ω}}{{ε}_{0} ( 4 {ε}_{{L}_{2} {L}_{2}}^{2 ω} - {( \sqrt{{ε}_{{L}_{1} {L}_{1}}^{ω}} + \sqrt{{ε}_{{L}_{2} {L}_{2}}^{ω}} )}^{2} )} , 0 , 0 )\end{matrix}$$

Finally, the polarization-resolved SHG electric fields reflected by the wedged LiNbO₃ are shown below using boundary conditions at 2ω frequency,

$${E}_{{L}_{1}}^{R , 2 ω} = \frac{2 {C}_{{L}_{1}}^{T , ee , 2 ω} ( \sqrt{{ε}_{{L}_{1} {L}_{1}}^{2 ω}} - \sqrt{{ε}_{{L}_{1} {L}_{1}}^{ω}} + \sqrt{{ε}_{{L}_{1} {L}_{1}}^{2 ω} {ε}_{{L}_{2} {L}_{2}}^{2 ω}} - \sqrt{{ε}_{{L}_{1} {L}_{1}}^{ω} {ε}_{{L}_{2} {L}_{2}}^{2 ω}} ) + 2 {C}_{{L}_{1}}^{T , oo , 2 ω} ( \sqrt{{ε}_{{L}_{1} {L}_{1}}^{2 ω}} + \sqrt{{ε}_{{L}_{1} {L}_{1}}^{2 ω} {ε}_{{L}_{2} {L}_{2}}^{2 ω}} - \sqrt{{ε}_{{L}_{2} {L}_{2}}^{ω}} - \sqrt{{ε}_{{L}_{2} {L}_{2}}^{ω} {ε}_{{L}_{2} {L}_{2}}^{2 ω}} )}{2 ( 1 + \sqrt{{ε}_{{L}_{1} {L}_{1}}^{2 ω}} ) ( 1 + \sqrt{{ε}_{{L}_{2} {L}_{2}}^{2 ω}} )}$$

$${E}_{{L}_{2}}^{R , 2 ω} = \frac{2 {C}_{{L}_{2}}^{T , oo , 2 ω} ( \sqrt{{ε}_{{L}_{2} {L}_{2}}^{2 ω}} - \sqrt{{ε}_{{L}_{2} {L}_{2}}^{ω}} ) - {C}_{{L}_{2}}^{T , eo , 2 ω} ( \sqrt{{ε}_{{L}_{1} {L}_{1}}^{ω}} - 2 \sqrt{{ε}_{{L}_{2} {L}_{2}}^{2 ω}} + \sqrt{{ε}_{{L}_{2} {L}_{2}}^{ω}} )}{2 ( 1 + \sqrt{{ε}_{{L}_{2} {L}_{2}}^{2 ω}} )}$$

Similarly, the following relations can thus be derived for MgSiP₂. The surface plane of MgSiP₂ is (112) and the direction perpendicular to the plane of incidence is [11̅0]. The dielectric tensors in the lab coordinate system at both ω and 2ω frequencies are shown below,

$${ε}_{Lab}^{ω} = ( \begin{matrix}{ε}_{{L}_{1} {L}_{1}}^{ω} & 0 & {ε}_{{L}_{1} {L}_{3}}^{ω} \\ 0 & {ε}_{{L}_{2} {L}_{2}}^{ω} & 0 \\ {ε}_{{L}_{1} {L}_{3}}^{ω} & 0 & {ε}_{{L}_{3} {L}_{3}}^{ω}\end{matrix} ) = ( \begin{matrix}0.39 {( {n}_{1}^{ω} )}^{2} + 0.61 {( {n}_{3}^{ω} )}^{2} & 0 & - 0.49 {( {n}_{1}^{ω} )}^{2} + 0.49 {( {n}_{3}^{ω} )}^{2} \\ 0 & {( {n}_{1}^{2 ω} )}^{2} & 0 \\ - 0.49 {( {n}_{1}^{ω} )}^{2} + 0.49 {( {n}_{3}^{ω} )}^{2} & 0 & 0.61 {( {n}_{1}^{ω} )}^{2} + 0.39 {( {n}_{3}^{ω} )}^{2}\end{matrix} )$$

$${ε}_{Lab}^{2 ω} = ( \begin{matrix}{ε}_{{L}_{1} {L}_{1}}^{2 ω} & 0 & {ε}_{{L}_{1} {L}_{3}}^{2 ω} \\ 0 & {ε}_{{L}_{2} {L}_{2}}^{2 ω} & 0 \\ {ε}_{{L}_{1} {L}_{3}}^{2 ω} & 0 & {ε}_{{L}_{3} {L}_{3}}^{2 ω}\end{matrix} ) = ( \begin{matrix}0.39 {( {n}_{1}^{2 ω} )}^{2} + 0.61 {( {n}_{3}^{2 ω} )}^{2} & 0 & - 0.49 {( {n}_{1}^{2 ω} )}^{2} + 0.49 {( {n}_{3}^{2 ω} )}^{2} \\ 0 & {( {n}_{1}^{2 ω} )}^{2} & 0 \\ - 0.49 {( {n}_{1}^{2 ω} )}^{2} + 0.49 {( {n}_{3}^{2 ω} )}^{2} & 0 & 0.61 {( {n}_{1}^{2 ω} )}^{2} + 0.39 {( {n}_{3}^{2 ω} )}^{2}\end{matrix} )$$

n₁^{ω} and n₃^{ω} are refractive indices in the principal coordinate system, describing refractive indices along a-b directions and c directions, respectively. The electric field directions and effective refractive indices for both ordinary and extraordinary waves at their corresponding frequencies are written below,

$${E}^{e , ω} = ( - \frac{{ε}_{{L}_{3} {L}_{3}}^{ω}}{\sqrt{{( {ε}_{{L}_{1} {L}_{3}}^{ω} )}^{2} + {( {ε}_{{L}_{3} {L}_{3}}^{ω} )}^{2}}} , 0 , \frac{{ε}_{{L}_{1} {L}_{3}}^{ω}}{\sqrt{{( {ε}_{{L}_{1} {L}_{3}}^{ω} )}^{2} + {( {ε}_{{L}_{3} {L}_{3}}^{ω} )}^{2}}} ) ; {n}_{eff}^{e , ω} = \sqrt{\frac{- {( {ε}_{{L}_{1} {L}_{3}}^{ω} )}^{2} + {ε}_{{L}_{1} {L}_{1}}^{ω} + {ε}_{{L}_{3} {L}_{3}}^{ω}}{{ε}_{{L}_{3} {L}_{3}}^{ω}}} ;$$

$${E}^{o , ω} = ( 0 , 1 , 0 ) ; {n}_{eff}^{o , ω} = \sqrt{{ε}_{{L}_{2} {L}_{2}}^{ω}}$$

$${E}^{e , 2 ω} = ( - \frac{{ε}_{{L}_{3} {L}_{3}}^{2 ω}}{\sqrt{{( {ε}_{{L}_{1} {L}_{3}}^{2 ω} )}^{2} + {( {ε}_{{L}_{3} {L}_{3}}^{2 ω} )}^{2}}} , 0 , \frac{{ε}_{{L}_{1} {L}_{3}}^{2 ω}}{\sqrt{{( {ε}_{{L}_{1} {L}_{3}}^{2 ω} )}^{2} + {( {ε}_{{L}_{3} {L}_{3}}^{ω} )}^{2}}} ) ; {n}_{eff}^{e , 2 ω} = \sqrt{\frac{- {( {ε}_{{L}_{1} {L}_{3}}^{2 ω} )}^{2} + {ε}_{{L}_{1} {L}_{1}}^{2 ω} + {ε}_{{L}_{3} {L}_{3}}^{2 ω}}{{ε}_{{L}_{3} {L}_{3}}^{2 ω}}} ;$$

$${E}^{o , 2 ω} = ( 0 , 1 , 0 ) ; {n}_{eff}^{o , 2 ω} = \sqrt{{ε}_{{L}_{2} {L}_{2}}^{2 ω}}$$

The transmitted electric field at ω frequencies are expressed below, in agreement with Fresnel coefficients,

$${E}^{T , e , ω} = ( \frac{2 cos φ}{1 + \sqrt{{ε}_{{L}_{1} {L}_{1}}^{ω} - \frac{{( {ε}_{{L}_{1} {L}_{3}}^{ω} )}^{2}}{{ε}_{{L}_{3} {L}_{3}}^{ω}}}} , 0 , - \frac{2 {ε}_{{L}_{1} {L}_{3}}^{ω} cos φ}{{ε}_{{L}_{3} {L}_{3}}^{ω} + \sqrt{{ε}_{{L}_{1} {L}_{1}}^{ω} - {( {ε}_{{L}_{1} {L}_{3}}^{ω} )}^{2}}} )$$

$${E}^{T , o , ω} = ( 0 , \frac{2 sin φ}{1 + \sqrt{{ε}_{{L}_{2} {L}_{2}}^{ω}}} , 0 )$$

where superscript T, e, o are transmitted waves, extraordinary wave and ordinary wave, respectively. Azimuthal angle φ describes the rotation of incident polarization, as shown in the SHG polarimetry. The resulting SHG tensor in the lab coordinate system and nonlinear polarizations are thus expressed as,

$$d = ( \begin{matrix}0.61 {d}_{14} + 0.31 {d}_{36} & - 0.78 {d}_{36} & - 0.61 {d}_{14} + 0.47 {d}_{36} & 0 & - 0.148 {d}_{14} - 0.38 {d}_{36} & 0 \\ 0 & 0 & 0 & - 0.63 {d}_{14} & 0 & - 0.78 {d}_{14} \\ - 0.76 {d}_{14} + 0.25 {d}_{36} & - 0.63 {d}_{36} & 0.76 {d}_{14} + 0.38 {d}_{36} & 0 & 0.17 {d}_{14} - 0.31 {d}_{36} & 0\end{matrix} )$$

$${P}^{T , ee , 2 ω} = ( {P}_{{L}_{1}}^{T , ee , 2 ω} , {P}_{{L}_{2}}^{T , ee , 2 ω} , {P}_{{L}_{3}}^{T , ee , 2 ω} ) = ( \begin{matrix}\frac{( {( cos φ )}^{2} ( ( - 2.45 {( {ε}_{{L}_{1} {L}_{3}}^{ω} )}^{2} + 1.08 {ε}_{{L}_{1} {L}_{3}}^{ω} {ε}_{{L}_{3} {L}_{3}}^{ω} + 2.45 {( {ε}_{{L}_{3} {L}_{3}}^{ω} )}^{2} ) {d}_{14} + ( 1.9 {( {ε}_{{L}_{1} {L}_{3}}^{ω} )}^{2} + 3.05 {ε}_{{L}_{1} {L}_{3}}^{ω} {ε}_{{L}_{3} {L}_{3}}^{ω} + 1.22 {( {ε}_{{L}_{3} {L}_{3}}^{ω} )}^{2} ) {d}_{36} ) {ε}_{0}}{{( 1. + \sqrt{{ε}_{{L}_{1} {L}_{1}}^{ω} - \frac{{( {ε}_{{L}_{1} {L}_{3}}^{ω} )}^{2}}{{ε}_{{L}_{3} {L}_{3}}^{ω}}} )}^{2} {( {ε}_{{L}_{3} {L}_{3}}^{ω} )}^{2}} \\ \frac{( {( cos φ )}^{2} ( ( 3.05 {( {ε}_{{L}_{1} {L}_{3}}^{ω} )}^{2} + 1.34 {ε}_{{L}_{1} {L}_{3}}^{ω} {ε}_{{L}_{3} {L}_{3}}^{ω} - 3.05 {( {ε}_{{L}_{3} {L}_{3}}^{ω} )}^{2} ) {d}_{14} + ( 1.52 {( {ε}_{{L}_{1} {L}_{3}}^{ω} )}^{2} + 2.45 {ε}_{{L}_{1} {L}_{3}}^{ω} {ε}_{{L}_{3} {L}_{3}}^{ω} + 0.98 {( {ε}_{{L}_{3} {L}_{3}}^{ω} )}^{2} ) {d}_{36} ) {ε}_{0}}{{( 1. + \sqrt{{ε}_{{L}_{1} {L}_{1}}^{ω} - \frac{{( {ε}_{{L}_{1} {L}_{3}}^{ω} )}^{2}}{{ε}_{{L}_{3} {L}_{3}}^{ω}}} )}^{2} {( {ε}_{{L}_{3} {L}_{3}}^{ω} )}^{2}}\end{matrix} )$$

$${P}^{T , oo , 2 ω} = ( {P}_{{L}_{1}}^{T , oo , 2 ω} , {P}_{{L}_{2}}^{T , oo , 2 ω} , {P}_{{L}_{3}}^{T , oo , 2 ω} ) = ( \frac{3.12 {( sin φ )}^{2} {d}_{36} {ε}_{0}}{{( 1 + \sqrt{{ε}_{{L}_{2} {L}_{2}}^{ω}} )}^{2}} , 0 , - \frac{2.51 {( Sin φ )}^{2} {d}_{36} {ε}_{0}}{{( 1 + \sqrt{{ε}_{{L}_{2} {L}_{2}}^{ω}} )}^{2}} )$$

$${P}^{T , eo , 2 ω} = ( {P}_{{L}_{1}}^{T , eo , 2 ω} , {P}_{{L}_{2}}^{T , eo , 2 ω} , {P}_{{L}_{3}}^{T , eo , 2 ω} ) = ( 0 , ( - \frac{6.24 cos φ sin φ}{( 1 + \sqrt{{ε}_{{L}_{2} {L}_{2}}^{ω}} ( 1 + \sqrt{{ε}_{{L}_{1} {L}_{1}}^{ω} - \frac{{( {ε}_{{L}_{1} {L}_{3}}^{ω} )}^{2}}{{ε}_{{L}_{3} {L}_{3}}^{ω}}} )} + \frac{5.01 {ε}_{{L}_{1} {L}_{3}}^{ω} cos φ sin φ}{( 1 + \sqrt{{ε}_{{L}_{2} {L}_{2}}^{ω}} ) ( {ε}_{{L}_{3} {L}_{3}}^{ω} + \sqrt{{ε}_{{L}_{1} {L}_{1}}^{ω} - \frac{{( {ε}_{{L}_{1} {L}_{3}}^{ω} )}^{2}}{{ε}_{{L}_{3} {L}_{3}}^{ω}}} {ε}_{{L}_{3} {L}_{3}}^{ω} )} ) {d}_{14} {ε}_{0} , 0 )$$

here, superscript ee, co and eo represent the nonlinear polarizations are formed using two extraordinary waves, two ordinary waves or mixtures of extraordinary waves and extraordinary waves. The corresponding electric fields generated by the nonlinear polarizations are thus calculated as shown below,

$${C}^{T , ee , 2 ω} = ( {C}_{{L}_{1}}^{T , ee , 2 ω} , {C}_{{L}_{2}}^{T , ee , 2 ω} , {C}_{{L}_{3}}^{T , ee , 2 ω} ) = ( \begin{matrix}\frac{( - {P}_{{L}_{3}}^{T , ee , 2 ω} {ε}_{{L}_{1} {L}_{3}}^{2 ω} + {P}_{{L}_{1}}^{T , ee , 2 ω} {ε}_{{L}_{3} {L}_{3}}^{2 ω} ) {ε}_{{L}_{3} {L}_{3}}^{2 ω}}{( {( {ε}_{{L}_{1} {L}_{3}}^{2 ω} )}^{2} {ε}_{{L}_{3} {L}_{3}}^{2 ω} - {ε}_{{L}_{3} {L}_{3}}^{2 ω} ( {ε}_{{L}_{1} {L}_{1}}^{2 ω} {ε}_{{L}_{3} {L}_{3}}^{2 ω} + {( {ε}_{{L}_{1} {L}_{3}}^{2 ω} )}^{2} - {ε}_{{L}_{1} {L}_{1}}^{2 ω} {ε}_{{L}_{3} {L}_{3}}^{2 ω} ) ) {ε}_{0}} \\ - \frac{{P}_{{L}_{2}}^{T , ee , 2 ω} {ε}_{{L}_{3} {L}_{3}}^{ω}}{( {ε}_{{L}_{2} {L}_{2}}^{2 ω} {ε}_{{L}_{3} {L}_{3}}^{2 ω} + {( {ε}_{{L}_{1} {L}_{3}}^{2 ω} )}^{2} - {ε}_{{L}_{1} {L}_{1}}^{2 ω} {ε}_{{L}_{3} {L}_{3}}^{2 ω} ) {ε}_{0}} \\ \frac{{P}_{{L}_{3}}^{T , ee , 2 ω} {ε}_{{L}_{1} {L}_{1}}^{2 ω} {ε}_{{L}_{3} {L}_{3}}^{ω} - {P}_{{L}_{1}}^{T , ee , 2 ω} {ε}_{{L}_{1} {L}_{3}}^{2 ω} {ε}_{{L}_{3} {L}_{3}}^{ω} + {P}_{{L}_{3}}^{T , ee , 2 ω} ( {( {ε}_{{L}_{1} {L}_{3}}^{ω} )}^{2} - {ε}_{{L}_{1} {L}_{1}}^{ω} {ε}_{{L}_{3} {L}_{3}}^{ω} ) {ω}^{2}}{( {( {ε}_{{L}_{1} {L}_{3}}^{2 ω} )}^{2} {ε}_{{L}_{3} {L}_{3}}^{ω} - {ε}_{{L}_{3} {L}_{3}}^{2 ω} ( {ε}_{{L}_{1} {L}_{1}}^{2 ω} {ε}_{{L}_{3} {L}_{3}}^{2 ω} + {( {ε}_{{L}_{1} {L}_{3}}^{ω} )}^{2} - {ε}_{{L}_{1} {L}_{1}}^{ω} {ε}_{{L}_{3} {L}_{3}}^{ω} ) ) {ε}_{0}}\end{matrix} )$$

$${C}^{T , oo , 2 ω} = ( {c}_{{L}_{1}}^{T , oo , 2 ω} , {c}_{{L}_{2}}^{T , oo , 2 ω} , {c}_{{L}_{3}}^{T , oo , 2 ω} ) = ( \frac{- {P}_{{L}_{3}}^{T , oo , 2 ω} {ε}_{{L}_{1} {L}_{3}}^{2 ω} + {P}_{{L}_{1}}^{T , oo , 2 ω} {ε}_{{L}_{3} {L}_{3}}^{2 ω}}{( ( {ε}_{{L}_{1} {L}_{3}}^{2 ω} ) - {ε}_{{L}_{1} {L}_{1}}^{2 ω} {ε}_{{L}_{3} {L}_{3}}^{2 ω} + {ε}_{{L}_{2} {L}_{2}}^{ω} {ε}_{{L}_{3} {L}_{3}}^{2 ω} ) {ε}_{0}} , 0 , - \frac{- {P}_{{L}_{3}}^{T , oo , 2 ω} {ε}_{{L}_{1} {L}_{1}}^{2 ω} + {P}_{{L}_{1}}^{T , oo , 2 ω} {ε}_{{L}_{1} {L}_{3}}^{2 ω} + {P}_{{L}_{3}}^{T , oo , 2 ω} {ε}_{{L}_{2} {L}_{2}}^{ω}}{( {( {ε}_{{L}_{1} {L}_{3}}^{2 ω} )}^{2} - {ε}_{{L}_{1} {L}_{1}}^{2 ω} {ε}_{{L}_{3} {L}_{3}}^{2 ω} + {ε}_{{L}_{2} {L}_{2}}^{ω} {ε}_{{L}_{3} {L}_{3}}^{2 ω} ) {ε}_{0}} )$$

$${c}^{T , e e , 2 ω} = ( {c}_{{L}_{1}}^{T , e o , 2 ω} , {c}_{{L}_{2}}^{T , e o , 2 ω} , {c}_{{L}_{3}}^{T , e o , 2 ω} ) = ( 0 , - \frac{4 {P}_{{L}_{2}}^{T , eo , 2 ω} {ε}_{{L}_{3} {L}_{3}}^{ω}}{( 4 {ε}_{{L}_{2} {L}_{2}}^{2 ω} {ε}_{{L}_{3} {L}_{3}}^{ω} + {( {ε}_{{L}_{1} {L}_{3}}^{ω} )}^{2} - ( {ε}_{{L}_{1} {L}_{1}}^{ω} + {ε}_{{L}_{2} {L}_{2}}^{ω} + 2 \sqrt{{ε}_{{L}_{2} {L}_{2}}^{ω}} \sqrt{{ε}_{{L}_{1} {L}_{1}}^{ω} - \frac{{( {ε}_{{L}_{1} {L}_{3}}^{ω} )}^{2}}{{ε}_{{L}_{3} {L}_{3}}^{ω}}} ) {ε}_{{L}_{3} {L}_{3}}^{ω} ) {ε}_{0}} , 0 , 0 )$$

Finally, the polarization resolved SHG electric fields reflected by the wedged MgSiP₂ is shown below using boundary conditions at 2ω frequency,

$${E}_{{L}_{1}}^{R , 2 ω} = \frac{{C}_{{L}_{1}}^{T , oo , 2 ω} ( - \sqrt{{ε}_{{L}_{2} {L}_{2}}^{2 ω}} + \sqrt{{ε}_{{L}_{1} {L}_{1}}^{2 ω} - \frac{{( {ε}_{{L}_{1} {L}_{3}}^{2 ω} )}^{2}}{{ε}_{{L}_{3} {L}_{3}}^{2 ω}}} ) + {C}_{{L}_{1}}^{T , ee , 2 ω} ( \sqrt{{ε}_{{L}_{1} {L}_{1}}^{2 ω} - \frac{{( {ε}_{{L}_{1} {L}_{3}}^{2 ω} )}^{2}}{{ε}_{{L}_{3} {L}_{3}}^{2 ω}}} - \sqrt{{ε}_{{L}_{1} {L}_{1}}^{ω} - \frac{{( {ε}_{{L}_{1} {L}_{3}}^{ω} )}^{2}}{{ε}_{{L}_{3} {L}_{3}}^{ω}}} )}{1 + \sqrt{{ε}_{{L}_{1} {L}_{1}}^{2 ω} - \frac{{( {ε}_{{L}_{1} {L}_{3}}^{2 ω} )}^{2}}{{ε}_{{L}_{3} {L}_{3}}^{2 ω}}}}$$

$${E}_{{L}_{2}}^{R , 2 ω} = \frac{{C}_{{L}_{2}}^{T , e e , 2 ω} ( 2 \sqrt{{ε}_{{L}_{2} {L}_{2}}^{2 ω}} - 2 \sqrt{{ε}_{{L}_{2} {L}_{2}}^{2 ω} - \frac{{( {ε}_{{L}_{1} {L}_{3}}^{ω} )}^{2}}{{ε}_{{L}_{3} {L}_{3}}^{ω}}} ) - {C}_{{L}_{2}}^{T , eo , 2 ω} ( - 2 \sqrt{{ε}_{{L}_{2} {L}_{2}}^{2 ω}} + \sqrt{{ε}_{{L}_{2} {L}_{2}}^{ω}} + \sqrt{{ε}_{{L}_{1} {L}_{1}}^{ω} - \frac{{( {ε}_{{L}_{1} {L}_{3}}^{ω} )}^{2}}{{ε}_{{L}_{3} {L}_{3}}^{ω}}} )}{2 ( 1 + \sqrt{{ε}_{{L}_{2} {L}_{2}}^{2 ω}} )}$$

Here, constants, including ε₀, μ₀ and ω are normalized to 1 for clearer demonstration, as all the constants will be cancelled out by comparing the intensity between LiNbO₃ and MgSiP₂.

### Example 4

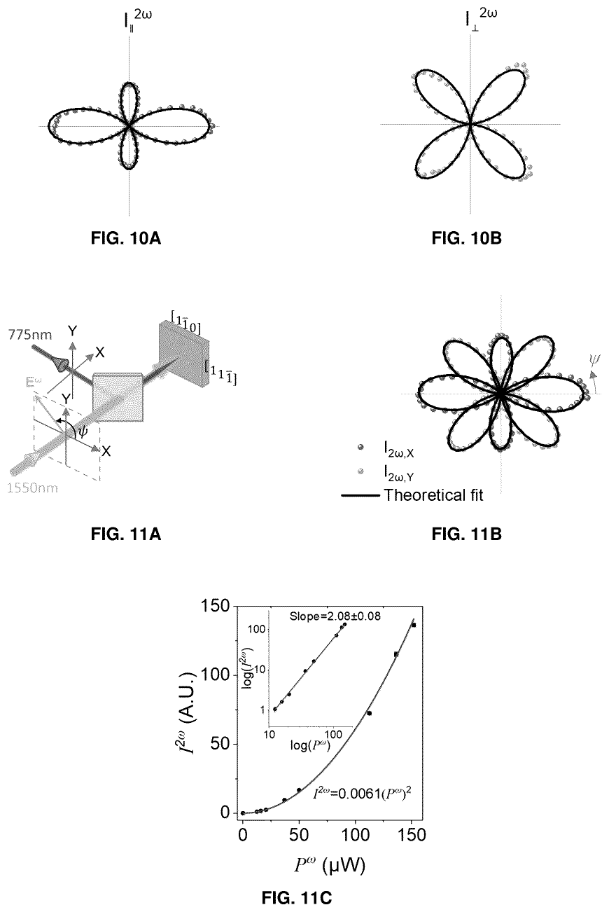

To obtain the dᵢⱼ coefficients of MgSiP₂, the polar plots were fitted to the equation for I_{Y}^{2ω} (FIGS. 10A-10B, FIG. 11B) and compared with that measured on a wedged x-cut LiNbO₃ reference under the same experimental conditions (FIG. 26). From I_{X}^{2ω}, the ratio of d₁₄/d₃₆=1.05±0.05 was obtained, and thus the two non-zero SHG coefficients are practically equal, confirming the Kleinman symmetry and the non-resonant SHG process. The SHG coefficients d₁₄ and d₃₆ were extracted to be from about 80 pm/V to about 95 pm/V, surpassing the commercial NLO crystals AgGaS₂, AgGaSe₂ and ZnGeP₂. To ensure that the detected signal was from the second-order NLO effect, the SHG intensities were measured as a function of incident power, as shown in FIG. 11C. The SHG response demonstrates a clear quadratic dependence on the input power. When it is plotted in the logarithmic scale, the slope is 2.08±0.08, confirming that the signal measured was generated by the second-order NLO effect.

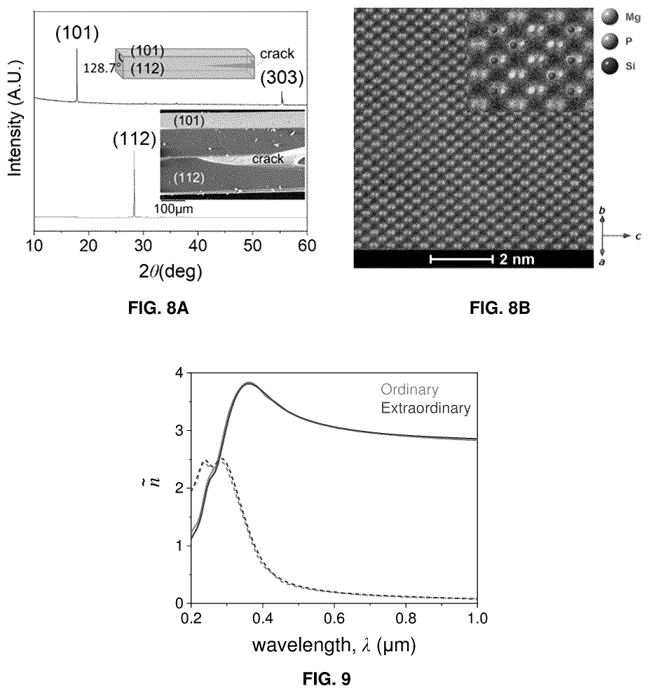

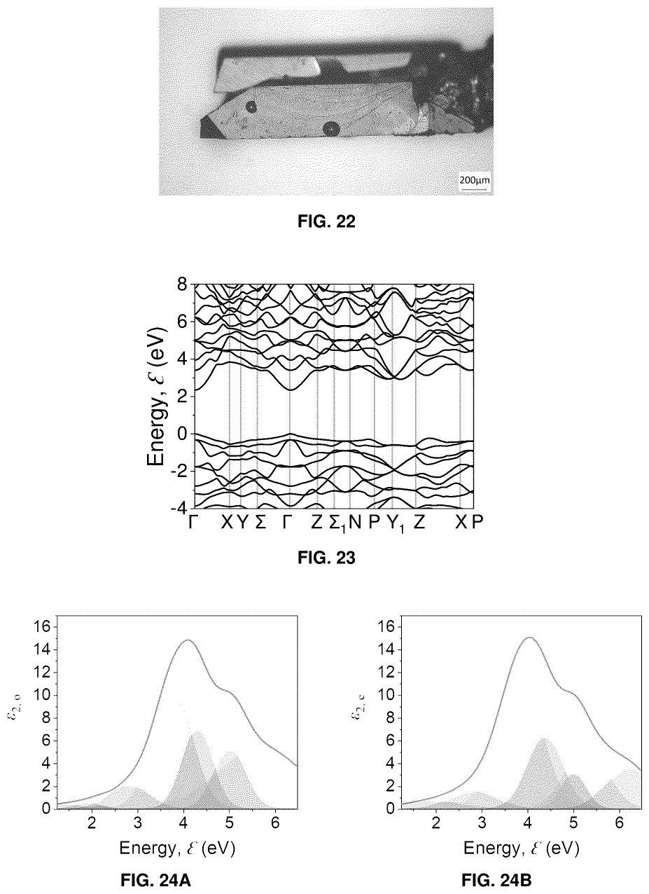

MgSiP₂ belongs to the space group 14̅2d (point group 4̅2m) and has the chalcopyrite structure closely related to the zinc blende structure except that the unit cell is twice larger (FIG. 7A). Similar to other chalcopyrite structured crystals, it comprises of aligned MgP₄ and SiP₄ units (FIG. 20), allowing the superposition of the microscopic SHG response generated from these tetrahedra, which results in overall strong SHG performance. Each P³⁻ anion is bonded with two Si⁴⁺ and two Mg²⁺ cations, while both the Si⁴⁺ and Mg²⁺ cations are coordinated with four anions with different Si—P and Mg—P bond lengths, leading to distortion of the anion sublattice. As shown in FIG. 21, the as-grown crystals are needle-like with typical dimensions of 0.3-0.5 mm (width)×0.3-0.4 mm (thickness)×2-6 mm (length). The MgSiP₂ single crystals have a similar growth habit as ZnSiP₂ and CdSiP₂:they grow along the [111] direction, with two natural facets corresponding to the (112) and (101) planes. FIG. 7C shows an image of a MgSiP₂ single crystal with labeled facets and growth direction. The planes were also verified by XRD by measuring each facet of the MgSiP₂ crystal, as shown in FIG. 8A. The crystals are air-sensitive but stable in water. When left in the ambient atmosphere for two days, the surface of the crystal starts to degrade, as shown in FIG. 22; hence for eventual applications, the crystal surfaces will need to be sealed against air exposure. Additionally, the XRD pattern confirmed its 4̅2m crystal structure and phase purity. FIG. 8B shows the atomic resolution high angle annular dark field (HAADF)-STEM image taken along the [110] axis. The STEM image also illustrates that the as-grown MgSiP₂ crystal possesses the same structure as the previously reported structure (FIG. 7A).

FIG. 8A XRD pattern of the MgSiP₂ single crystals confirmed the phase-purity and plane orientation. (b) STEM image is taken from the [110] axis. Inset: A magnified HAADF-STEM image superimposed with a simulated crystal structure confirmed the phase and structure.

The ordinary and extraordinary refractive indices in the spectral range of 0.2 μm to 1 μm were extracted by simultaneously fitting the two sets of ellipsometry data measured on (101) surface with the Gaussian oscillators, as shown in FIG. 9.

Since MgSiP₂ has a large transparency window of 0.53-10.35 μm (FIG. 17A), the dispersion is small in 1-4 μm. Therefore the refractive indices n from 0.45 μm to 1 μm were fitted to the Sellmeier equation

$${n}^{2} = A + \frac{B}{{λ}^{2} - C}$$

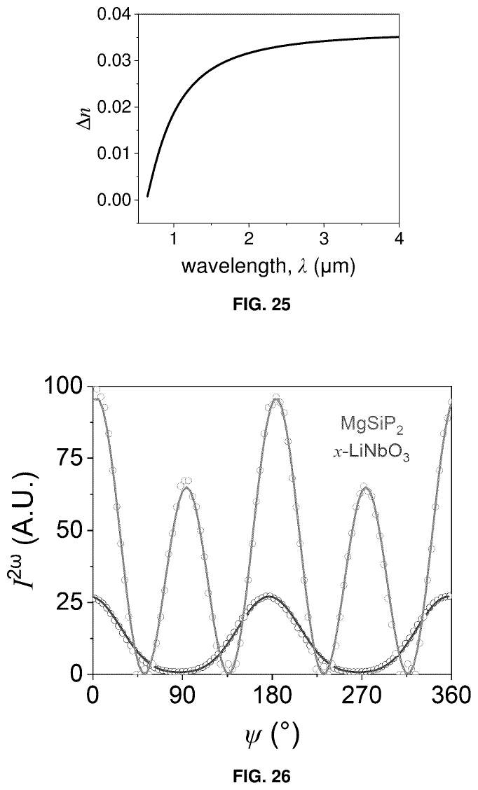

and extrapolated to 4 μm for the SHG analysis and phase-matching calculations (FIG. 17C). The parameters of the Sellmeier equations are shown in Table 4. The birefringence is also calculated and shown in FIG. 25.

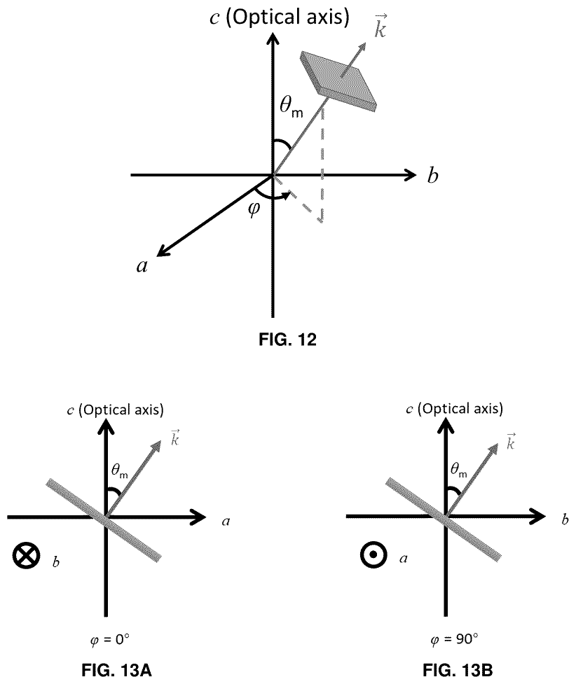

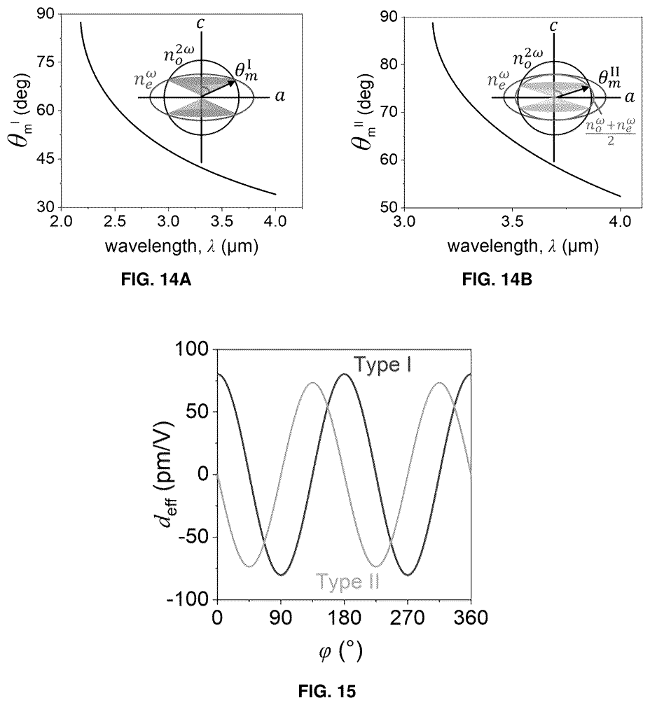

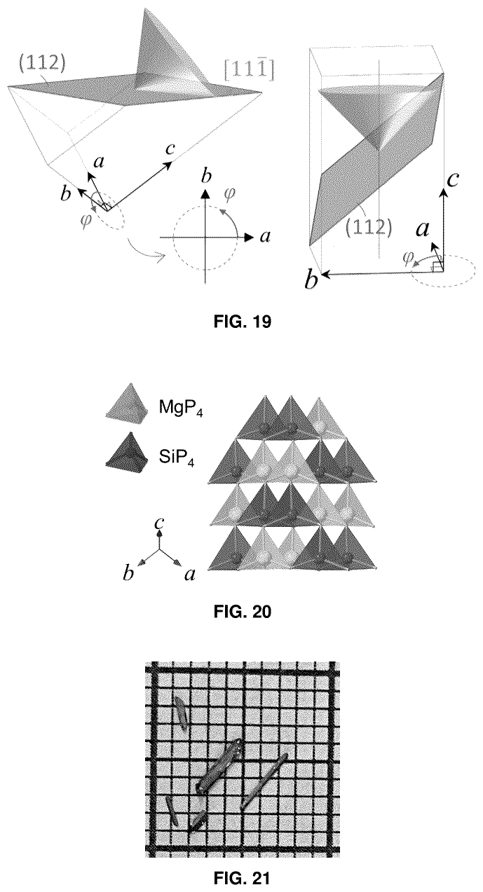

In real applications, phase-matching is one of the most crucial criteria for efficient high-power nonlinear conversion. When the crystal achieves the phase-matching conditions, the fundamental wave and the SHG wave travel at the same speed; in other words, n^{ω}=n^{2ω}. This can only be realized in anisotropic crystals with a large enough birefringence. Since MgSiP₂ is a positive uniaxial crystal (nₒ<nₑ), the Type-I phase-matching condition is n_{o,2ω}=n_{e,ω}(θₘ) and the Type-II phase-matching condition is nₒ^{ω}+nₑ^{ω}(θₘ)=2nₒ^{2ω}(θₘ), where θₘ is the angle between the optical axis and the wave vector. Using the above-mentioned Sellmeier equations for the refractive indices, the phase-matching conditions of MgSiP₂ can thus be calculated, as shown in FIGS. 14A-14B. The effective d coefficient for Type I and Type II can be expressed as d_{eff,I}=d₃₆ sin(2θₘ) cos(2φ) and d_{eff,II}=−d₃₆ sin(θₘ) sin(2φ), where φ is the azimuthal angle as defined in FIG. 12 and FIG. 19. In practical applications, the crystal will be cut into a wafer such that the angle between the surface normal and the optical axis equals the phase-matching angle (FIGS. 13A-13B). Using Miller's rule, one can estimate the value of d₃₆ at other wavelengths. For example, d₃₆≈81.6 pm/V at 3.5 μm and therefore |d_{eff,I}| is greater than about 75 pm/V to about 90 pm/V at φ=0° and |d_{eff,II}| is greater than about 70 pm/V to about 80 pm/V at φ=45° as shown in FIG. 15.

TABLE 4
The parameters of Sellmeier equations for ordinary
and extraordinary refractive indices.

| n | A | B | C (μm²) |
|---|---|---|---|
| nₒ | 7.43 | 0.5686 | 0.06685 |
| nₑ | 7.622 | 0.4774 | 0.08485 |

### Example 5

To further understand the high NLO susceptibility, first-principles calculations within DFT-LDA were carried out. The static SHG tensor dᵢⱼ was computed within density-functional perturbation theory (DFPT). As expected from the small structural difference, both the fully and the internally relaxed structures yield similar results with d₃₆^{∞}=27 pm/V and d₃₆^{∞}=29 pm/V, respectively. However, a difference in the cell parameters of less than 1% results in a change of the SHG coefficient of 6%. This demonstrates the high sensitivity of SHG to structural variations. Without any scissor shift, d₃₆^{∞} increases to 54.859 pm/V and 57.519 pm/V for both structures, respectively. This shows the importance of the bandgap (and, more generally, of linear optics) in nonlinear optical calculations, as summarized by Miller's rule. Following a sum-over-states approach, the dispersion of the SHG tensor was also calculated. As illustrated in the inset of FIG. 11E, from 0 to 1.24 eV, the inclusion of anti-resonant terms is shown to affect exclusively the low-energy range of the real component by doubling its static value. This slightly increases the discrepancy with its DFPT counterpart, but the agreement with the experimental result at 1550 nm (0.8 eV) is improved despite a clear underestimation of the SHG component.

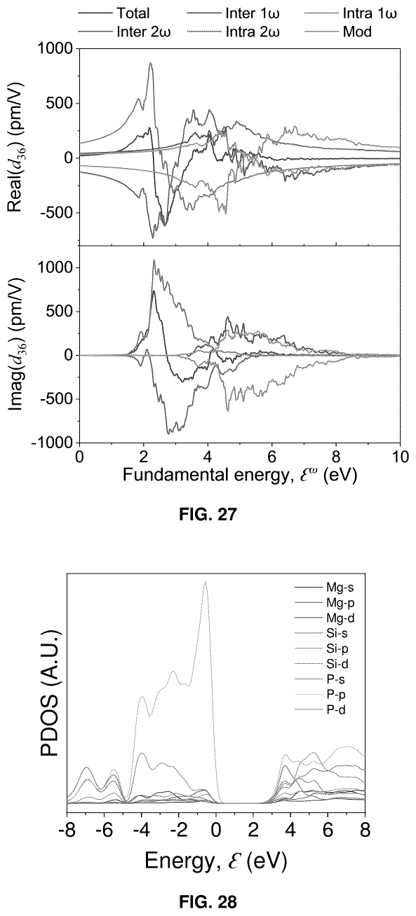

In order to physically understand the origin of the large SHG coefficient, the total response was decomposed into three different terms originating from 1) the interband transitions; 2) the intraband transitions; and 3) the modulation of the interband terms by intraband terms. In the following, they will respectively be called “inter,” “intra,” and “mod.” Their definition directly originates from the Genkin-Mednis approach in the mathematical treatment applied to the Hamiltonian when developing the sum-over-states equation. There is no straightforward way to relate the “inter,” “intra,” and “mod” terms to distinct features of the electronic band structure. However, by simplifying the different sums, it is possible to identify the bands that contribute the most to each of these terms, as will be shown below. From FIG. 27, it can be seen that, in MgSiP₂, the total real response (resonant terms only) in the low energy range primarily originates from the “intra” term and, more precisely, from its 2ω resonance. According to the following sum rule,

$$R ( {χ}^{( 2 )} ( 0 , 0 , 0 ) ) = \frac{2}{π} P \int \frac{I ( {χ}^{( 2 )} ( - 2 ω , ω , ω ) )}{ω} d ω ,$$

the spectrum of the imaginary part of the SHG tensor is responsible for its real value in the static limit. In the present case, it appears that the high positive peak of I(χ⁽²⁾ (−2ω,ω,ω)) around 2.27 eV constitutes the main feature of interest (see FIG. 27). Its major component is also the “intra” 2ω resonant term, as expected from the above equation.

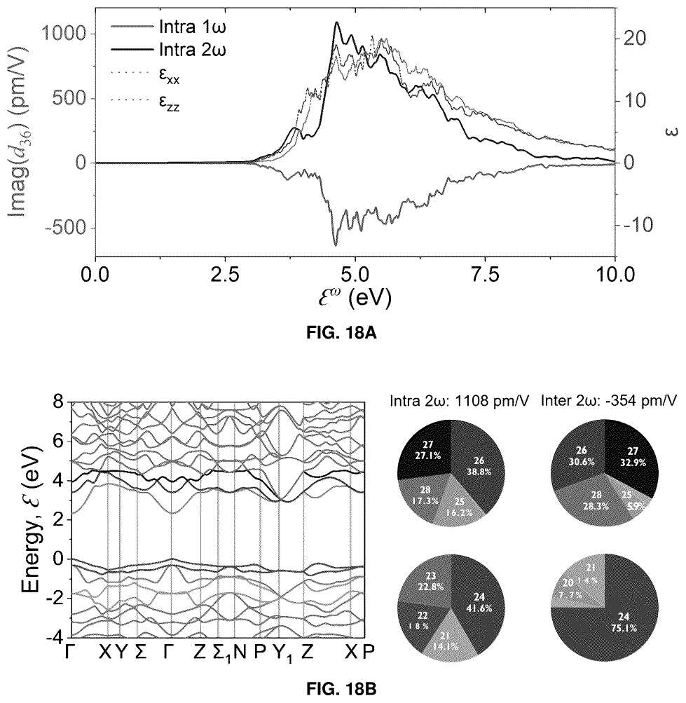

When shifting the 2ω term in accordance with its resonance, as shown in FIG. 18A, the imaginary “intra” curves can be seen as modulations of the absorption one. This is perfectly in line with what Sipe and Ghahramani proposed originally. It once again proves the importance of linear optics for the emergence of nonlinear optical phenomena, as emphasized by Miller's rule. One can indeed assume that a large or abrupt absorption could favor this “intra” contribution, leading, in turn to an important real value at low frequencies. This assumption and the required interpretation of the “intra” term should be explored in further investigations.

In all the above, the “inter,” “intra,” and “mod” terms are a sum over two- or three-band contributions. Similar to the band-resolved analysis introduced by Lee et al., the valence and conduction bands with the largest SHG contribution were identified by summing over the bands in two different ways. The results of this analysis in the case of the main ω peak of I(χ⁽²⁾ (−2ω,ω,ω)) are illustrated in FIG. 18B. Only the “intra” 2ω and “inter” 2ω are represented since they largely dominate the other terms (see FIG. 27) in this frequency range. As shown by the pie charts in the figure, the SHG mainly comes from the interaction between five bands at the top of the valence band and four bands at the bottom of the conduction band. From the projected density of states (PDOS) of FIG. 28, the top of the valence band corresponds to P-p orbitals, while the bottom of the conduction band can be attributed to Si-s, Si-p, and P-p orbitals. This emphasizes the importance of the [SiP₄] tetrahedral units as well as their geometrical arrangement.

FIG. 11D compares the highest non-resonant SHG coefficient MgSiP₂ and some well-known NLO crystals. It also illustrates the general trend that the NLO susceptibility anticorrelates with the electronic bandgap of a material. Compared with AgGaSe₂ and ZnGeP₂, MgSiP₂ possesses both a large SHG coefficient and a larger bandgap, whereas compared to CdSiP₂ (84 pm V⁻¹ at 4.56 μm fundamental wavelength and 93 pm V⁻¹ at 1550 nm fundamental wavelength by Miller's rule), it has a slightly smaller bandgap (5%) and comparable SHG coefficient considering the error bar.

### Example 6

The LDT value of MgSiP₂ was also assessed, as it is a critical requirement for high-power laser applications. The thermal conductivity measurements were conducted on pressed polycrystalline material. Polycrystalline material was ground into a fine powder and then pressed into a bar (10 mm×3 mm×1.65 mm). This bar was then annealed under a vacuum at 850° C. for 48 hours. Gold-plated copper leads were attached to the sample using silver epoxy. Thermal conductivity was measured from 5-300 K using the thermal transport option in a Quantum Design Physical Property Measurement System using a standard 4 lead method.

The evaluation was performed on the as-grown (112) plane of the crystal without polishing and without any antireflection coating the surfaces. A femtosecond laser system (1550 nm, 1 kHz, 100 fs) was used to generate high peak power laser pulses (up to 50 GW). During the measurement, the beam size (diameter of ˜70 μm) was kept the same while the incident power was gradually increased. The surface of the crystal was inspected with an optical microscope for each trial until apparent damages appeared. MgSiP₂ has a giant LDT value of 684 GW cm⁻². For comparison, the LDTs of ZnGeP₂ and CdSiP₂ (provided by BAE Systems) were also measured using the same laser system, which are 115 GW cm⁻² and 198 GW cm⁻², respectively. The obtained LDT of ZnGeP₂ is in excellent agreement with the previously reported value. The LDT of MgSiP₂ is ˜six times greater than ZnGeP₂ and ˜three times greater than CdSiP₂, as illustrated in the inset of FIG. 11D. The detailed parameters are shown in Table 5. Though its thermal conductivity is lower than that of CdSiP₂ (Supplementary Information), its LDT is significantly larger. The combination of large phase-matchable SHG coefficients and LDT makes MgSiP₂ an excellent material for high-power laser applications.

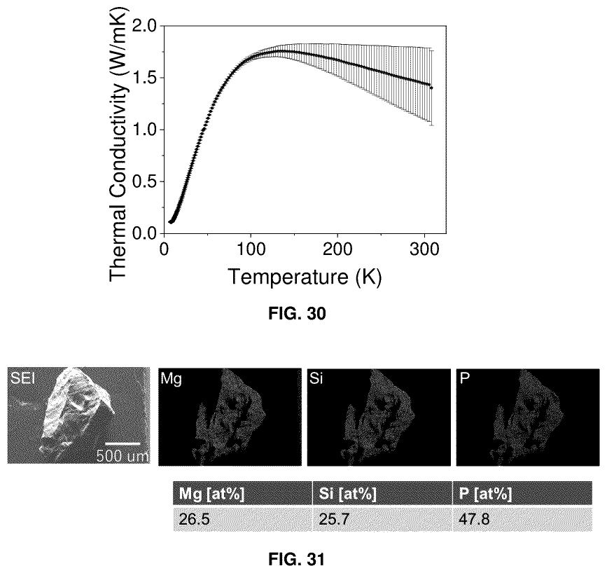

The temperature-dependent thermal conductivity of MgSiP₂ is shown in FIG. 30. The room temperature thermal conductivity of MgSiP₂ is 1.46 W m⁻¹ K⁻¹, which is comparable with AgGaS₂ and BaGaS₇ and slightly higher than AgGaSe₂ and BaGaSe₇. A comparison between MgSiP₂ and some well-known NLO crystals is given in Table 5. It is worth mentioning that high thermal conductivity generally leads to high LDT, but this statement is not always accurate since many other factors can affect the LDT value, such as bandgap and defects. For example, ZnGeP₂ has much higher thermal conductivity than CdSiP₂, yet its LDT is only half that of CdSiP₂, likely because of the smaller bandgap and two-photon absorption.

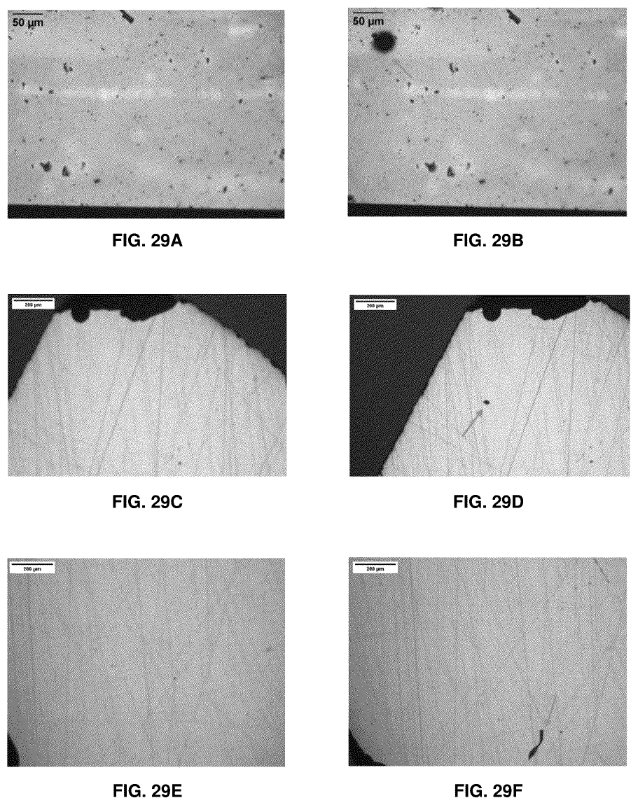

FIGS. 29A-29F show crystal images of MgSiP₂, CdSiP₂, and ZnGeP₂ before and after the laser damage measurements.

TABLE 5
The experimental parameters of the LDT measurements.

| | Wavelength | Beam size (μm) | LDT (GW/cm²) |
|---|---|---|---|
| MgSiP₂ | 1550 nm | 70 | 684 |
| CdSiP₂ | 1550 nm | 102 | 198 |
| ZnGeP₂ | 1550 nm | 102 | 115 |

### Example 7

The vertical Bridgman and floating-zone methods can be used to synthesize cm-sized single crystals. To perform Bridgman and floating-zone growths, one may synthesize polycrystalline MgSiP₂ materials through a solid-state reaction method, as disclosed below. Elements of Mg, Si and red phosphorus can be used as source materials. Mixture of Mg, Si and P with a stoichiometric molar ratio can be sealed into a quartz tube. The quartz tube loaded with mixed source materials can be heated in a step-like mode to avoid possible explosion caused by the high vapor pressure of P:the material will first be heated to 525° C. and stay at this temperature for 24 hours, then heated to 830° C. and dwell at this temperature for 35 hours, followed by increasing the temperature to 1,350° C. to get homogeneous melt. After waiting for 3 hours at 1160° C., the melt can be cooled down gradually at a rate of 100° C./h. At 525° C. and 830° C.

### Example 8

The polycrystalline MgSiP₂ has been synthesized according to the following conditions.

Magnesium turnings, silicon powder and phosphorus powder were mixed in the stoichiometric ratio and loaded into a pyrolytic Boron Nitride (PBN) crucible. The PBN crucible was put into a quartz tube which was then sealed under a vacuum. The quartz tube was put into the programmable muffle furnace. The temperature was raised from room temperature to 525° C. at a rate of 50° C./hr and then kept at this temperature for 72 hours. The temperature was further increased to 830° C. at 30° C./hr and dwelled for 60 hours to ensure the complete reaction of Mg and P. Afterward, the tube was heated to 1150° C. at 30° C./hr and held for 60 hours. Finally, it was cooled to room temperature at 100° C./hr. The polycrystalline MgSiP₂ was grounded into powder and confirmed the phase purity using x-ray diffraction (XRD).

The typical mass of individual pieces of crystals ranges from 1 mg to 5 mg. The total mass of crystals from a batch depends on not only the amount of source materials used for growth but also the cooling rate during the growth and many other factors. The total crystal mass of a batch typically ranges from ˜10 mg to ˜100 mg.

Sn flux: Stoichiometric quantities of high-purity Mg turnings, Si powder, and P powder were put into alumina crucibles. Sn powder was added to the alumina crucible and formed a 10 molar percent solution with the raw materials. The alumina crucible was then put in a quartz tube and sealed under a vacuum. The ampoule was then heated to 1100° C. for 24 hours, followed by slow cooling to 400° C. for 240 hours. Centrifugation was used to remove Sn flux when the temperature reached 400° C.

### Example 9

MgSiP₂ can be obtained by Sb-flux growth. A study was conducted which optimized the flux growth condition first to make larger MgSiP₂ crystals. The study confirmed the thermal stability of MgSiP₂, impact of cooling rate and effect of the amount of raw materials.

Experimental Procedure: Single crystal samples were grown by Sb-flux growth. Mg turnings, Si powder and red P powder with an atomic ratio of 1:1:2 were weighed out and loaded into an alumina crucible in the glove box. The crucible was manually shaken to mix the raw materials. Then, Sb shots were added to the crucible to form a mass ratio of 83.4 wt % Sb. The total amount of raw materials and flux was 2.2 g or 4.4 g. The alumina crucible was placed inside a quartz tube and sealed under a vacuum (5×10⁻⁴ to 9×10⁻⁴ torr). The sealed quartz tubes were heated in a muffle furnace to 1100° C. over 48 hours, followed by cooling to 1050-850° C. at a rate of 1-3° C./h. Then, the ampoules were immediately picked up from the furnace and centrifuged to separate the crystals from the Sb flux. The crystals were then collected from the crucible.

Polycrystalline samples were synthesized using solid state reaction. Mg turnings, Si powder, and red P powder with a molar ratio of 1:1:2 were mixed by the mortar and pestle in the glove box. The total amount of raw materials was 0.5 g. The mixture was loaded into alumina crucibles. The alumina crucibles were set in a quartz tube and sealed under vacuum below 9.0×10⁻⁴ torr. The ampoules were placed in the muffle furnace and heated to 525° C. at 50° C./h, held for 72 h, heated again to 830° C. at 30° C./h, held for 60 h, finally heated to 1150° C. at 30° C./h, held for 60 h, and followed by natural cooling. After the heating, the samples were taken out from the alumina crucibles and were ground using the mortar and pestle. Then, polycrystalline powder samples were obtained.

TGA (Thermogravimetric Analysis)-DSC (Differential Scanning calorimetry) measurement was performed using SDT650, TA instruments. Polycrystalline powder was used for this measurement. The condition is heating up to 1400° C. at 20° C./min under N₂ flow (100 mL/min) and then cooling down to room temperature at 20° C./min under N₂ flow (100 mL/min).

Thermal Stability of MgSiP₂: To evaluate the thermal stability of MgSiP₂, polycrystalline MgSiP₂ was synthesized, and TGA-DSC were performed using polycrystalline powder. The PXRD diffraction peaks were in good agreement with the reference pattern for MgSiP₂ in the ICDD database, confirming that the synthesized powder was indeed MgSiP₂.

MgSiP₂ remained thermally stable up to approximately 800° C. Beyond this temperature, the sample's weight gradually decreased, indicating that decomposition began around 800° C. Two prominent endothermic peaks were observed at 1166° C. and 1336° C. The peak at 1166° C. corresponds well with the reported melting point of SiP, suggesting that MgSiP₂ decomposes according to the following reaction:

3MgSiP₂→3SiP+Mg₃P₂+P↑

At this temperature, SiP melts. However, the decomposition of MgSiP₂ was not fully completed during the measurement, as the calculated phosphorus mass fraction (53.7 wt %) was larger than the total weight loss (24.95 wt %). This indicates that some MgSiP₂ remained intact after 1166° C. The second endothermic peak at 1336° C. is the melting point of MgSiP₂.

During the cooling process, two exothermic peaks were observed at 1076° C. and 1316° C., which correspond to the solidification points of SiP and MgSiP₂, respectively.

This measurement reveals that the decomposition of MgSiP₂ begins at approximately 800° C., and its melting point is around 1340° C.

Cooling rate: To grow larger MgSiP₂ crystals, the cooling rate was reduced from 3° C./h to 1° C./h. Theoretically, a slower cooling rate promotes the growth of larger crystals. Needle-like red crystals were obtained under all conditions. Crystals grown at a cooling rate of 1° C./h tended to be larger than those grown at a faster cooling rate. For crystals grown at 3° C./h, the average dimensions were approximately 0.3-0.5 mm in width and 2-6 mm in length. In contrast, crystals grown at 1° C./h had dimensions of approximately 0.8-1.0 mm in width and 4.5-5.8 mm in length.

The Amount of Raw Material: To explore the possibility of growing larger MgSiP₂ crystals, the amount of raw materials was doubled while maintaining a cooling rate of 1.0° C./h and a centrifuge temperature of 900° C. For the reference sample, the total amount of Mg, Si, and P was 0.3664 g, whereas for the doubling sample, it was 0.7328 g. The results showed that while the crystal size remained almost the same between the two samples, the number of crystals significantly increased with the larger amount of raw materials. This suggests that increasing the raw material quantity promotes the nucleation of MgSiP₂ crystals, leading to a higher number of nuclei forming and growing simultaneously. However, the rate of crystal growth did not improve, indicating that this strategy primarily influences nucleation rather than growth.

### Example 10

Another promising method for growth of large single crystal is vertical Bridgman growth . . . MgSiP₂ presents unique challenges due to its higher melting point of approximately 1340° C., as determined from TGA-DSC results, and its gradual decomposition starting at 800° C. To address these challenges, a study was conducted which proposes a hybrid approach combining flux growth and vertical Bridgman growth. This technique is used for high melting point materials or incongruent compounds and could be suitable for MgSiP₂ since it can already be grown by flux growth.

Nucleation behavior of MgSiP₂ with Sb-flux Growth: Before applying the flux-vertical Bridgman growth technique to MgSiP₂, it is essential to identify the nucleation point to establish an appropriate temperature profile for vertical Bridgman growth. To achieve this, the nucleation point of the Mg—Si—P—Sb system was investigated by varying the centrifuge temperature during flux growth. The centrifuge temperature was adjusted from 1050° C. to 900° C. with a cooling rate of 1.0° C./h. At 1050° C., tiny red crystals were observed, indicating that 1050° C. is close to the nucleation point. At 1000° C., millimeter-sized crystals were obtained, suggesting significant crystal growth between 1050° C. and 1000° C. At centrifuge temperatures of 950° C. and 900° C., the crystals grew larger compared to the 1000° C. sample. However, the sizes of the crystals in the 950° C. and 900° C. samples were similar, indicating that the rate of crystal growth is highest between 1050° C. and 950° C.

The flux-vertical Bridgman growth has been conducted according to the following conditions.

Mg turnings, Si powder, and red P powder in an atomic ratio of 1:1:2 were weighed and Sb shots were added to achieve a flux ratio of 83.4 wt % Sb. The raw materials and flux were mixed using a mortar and pestle in the Ar-filled glove box before being loaded into the alumina crucible. This alumina crucible was placed inside a 14×16 mm quartz tube, which was vacuum-sealed to a pressure of 5×10⁻⁴ to 9×10⁻⁴ torr. To prevent the ampoule from contacting the quartz tube within the furnace, the ampoule was positioned in a larger alumina crucible and fixed in place using ceramic wool. The larger alumina crucible was then placed in the Bridgman furnace. The furnace was heated to 1170° C. in Zone 1, 880° C. in Zone 2, and 580° C. in Zone 3 over 48 hours, followed by a 6-hour hold to stabilize the temperature gradient. The ampoule was then lowered at a rate of 0.5 mm/h, corresponding to a cooling rate of 1.0° C./h near the solidification point of MgSiP₂. The translation was stopped when the ampoule reached a position corresponding to 900° C., followed by cooling to 30° C. over 24 hours. The ampoule was then removed from the furnace, the crucible was mechanically broken, and the sample was collected.

Result and Discussion of Flux-Vertical Bridgman Growth: The temperature gradient was controlled by adjusting the setpoints in the furnace zones: 1170° C. for Zone 1, 880° C. for Zone 2, and 580° C. for Zone 3. This configuration achieved a temperature gradient of approximately 18° C./cm at the nucleation temperature of 1050° C. The translation rate was calculated based on the temperature gradient to maintain a cooling rate of 1.0° C./h.

$$Coolong rate [ ° C . / h ] = Temperature gradient [ ° C . / cm ] \times Translation rate [ mm / h ] / 10$$

The sample was initially positioned at 1100° C., and the translation process stopped at around 900° C., consistent with the targeted range.

Translation began at 1070° C. and stopped at approximately 850° C., slightly below the target due to the position of the thermocouple. The bottom section of the sample contained red crystals, gray regions, and white regions. FIG. 31 shows the SEM-EDX result of red crystal from the bottom section of the sample. SEM-EDX analysis identified red crystals as MgSiP₂.

### Example 11

Unlike conventional flux growth, horizontal flux growth is characterized by a horizontal configuration, offering several advantages. One key benefit is the establishment of a stable temperature gradient, where the temperature at any point remains constant throughout the synthesis. This stability allows crystals to develop under consistent thermal conditions, leading to the formation of materials with highly uniform quality. Additionally, the unidirectional nature of the temperature gradient enables continuous supply of raw materials from the hot end to the cold end. This setup facilitates an extended growth process, making it possible to produce larger-sized crystals. Given these advantages, horizontal flux growth was applied to MgSiP₂ in an effort to achieve larger crystals and improved material quality.

Experimental Procedure: Mg turnings, Si powder, and red P powder, in an atomic ratio of 1:1:2 or 1.5:1:2, were weighed and thoroughly mixed using a mortar and pestle. The total mass of Mg, Si, and P was 0.2 g. The homogeneous powder mixture was pressed into a 6.35 mm pellet. This pellet, along with 15 g of Sb, was loaded into a carbon-coated quartz tube, which was sealed under a vacuum pressure ranging from 5×10⁻⁴ to 9×10⁻⁴ torr. The sealed tube was then placed inside a larger quartz tube and vacuum-sealed again for protection from rupture. The ampoule was positioned in a two-zone horizontal furnace, with the pellet placed in the hot zone at 1100° C. The cold zone was maintained at either 900° C. or 800° C. The furnace was heated to these set temperatures over 48 hours and maintained at these conditions for 8 days to allow for crystal growth. Afterward, the furnace was cooled to room temperature over 12 hours, and the ampoule was removed from the furnace. To separate the crystals from the Sb flux, a decanting process was carried out. The sample was transferred into a new quartz tube with a neck and placed upright in a crucible furnace. The furnace was heated to 800° C. over 12 hours, held at this temperature for 8 hours, and then cooled down naturally to room temperature. During this process, the excess Sb flowed through the neck to the empty side of the tube, leaving the crystals behind. The crystals were then collected from the quartz tube and evaluated using SEM-EDS.

Result and Discussion: For the first trial, the cold zone was set to 900° C. because MgSiP₂ crystals were successfully obtained at this centrifuge temperature during conventional flux growth. The quartz tube did not break during the process. Upon opening the tube, a bar-like sample was observed along nearly the entire length of the quartz tube, indicating the dispersion of Sb throughout the quartz tube. The pellet at the hot zone was not found, suggesting that the raw materials had dissolved in the Sb flux. However, no crystals were found on the cold zone side. To remove Sb, a decanting process was conducted at 800° C., a temperature just below the decomposition point of MgSiP₂. After decanting, some of the Sb flowed to the lower side (left in the image), but a significant portion remained trapped in the bar-like sample on the higher side. The bar was removed from the quartz tube. It was extremely fragile and easily crumbled by hand. Inside the bar, fiber-like crystals were observed. These fiber-like crystals appeared to form a network that trapped the Sb, preventing its complete removal of Sb through decanting. EDX analysis revealed that these fiber-like crystals were SiP. Although Mg was detected, it was found in the form of Mg—O, and no MgSiP₂ crystals were identified in the sample. There may be two reasons for the absence of MgSiP₂ crystals. First, there might have been insufficient Mg participation in the reaction, although the specific cause for this is unclear. Increasing the Mg content could potentially enhance its involvement in the reaction. Second, the atomic ratio of Sb may have affected the nucleation process. It was determined that the nucleation point of MgSiP₂ in Sb-flux is approximately 1050° C. for an 83.4 wt % Sb system. However, the horizontal flux growth used an excessive amount of Sb. Assuming a phase diagram for MgSiP₂ and Sb, the nucleation temperature likely decreases with higher Sb content. Lowering the cold zone temperature might promote the nucleation of MgSiP₂ under these conditions.

Building on the results of the first trial, the second trial was conducted with modifications. Two pellets were prepared, one with a stoichiometric atomic ratio of Mg:Si:P=1:1:2 and another with an Mg-rich ratio of Mg:Si:P=1.5:1:2. Additionally, the cold zone temperature was lowered to 800° C. from the previous 900° C. Apart from these changes, the experimental procedure remained identical to the first trial. For the stoichiometric sample, the results were similar to those of the first trial. Fiber-like SiP and Mg—O phases were observed in the elemental mappings, matching the findings of the first trial. In the Mg-rich sample, only a single tiny MgSiP₂ crystal was identified, measuring approximately 50 μm, while the majority of the sample consisted of SiP. Although the presence of a MgSiP₂ crystal in Mg-rich sample demonstrates the potential of horizontal flux growth for this material, the crystal was exceedingly small and rare.

Summary: In this study, various crystal growth methods to produce larger MgSiP₂ single crystals were explored.

The thermal stability of MgSiP₂ was investigated using TGA-DSC. It was found that MgSiP₂ begins to decompose around 800° C., with a melting point near 1340° C., making melt-growth a challenging approach. Optimization of flux growth conditions was also attempted, including variations in cooling rate and the quantity of raw materials. A slower cooling rate slightly improved crystal size. Increasing the amount of raw materials led to a higher number of nucleation events, resulting in more crystals but not necessarily larger ones.

Flux-vertical Bridgman growth was applied to MgSiP₂ with Sb-flux. This method successfully synthesized MgSiP₂, but the resulting samples were polycrystalline. Several modifications, such as improved sample setting and mixing the raw materials and flux, enhanced the homogeneity of the crystals. However, issues such as quartz tube rupture and the production of polycrystalline samples persisted. Nevertheless, the flux-vertical Bridgman method shows promise for scaling up MgSiP₂ crystal growth, provided further optimization and precise control of growth conditions.

Horizontal flux growth was also explored.

In conclusion, this study evaluated three growth techniques-flux growth, flux-vertical Bridgman growth, and horizontal flux growth—to achieve larger MgSiP₂ single crystals. Flux-vertical Bridgman growth showed the most potential, as it successfully produced polycrystalline MgSiP₂. With further optimization and tighter control of growth conditions, it may be possible to grow larger MgSiP₂ single crystals using this method.

### EXEMPLARY ASPECTS

Example 1. A single nonlinear optical crystal having a chemical formula of Mg—IV—V2, wherein IV is selected from Si, Ge, or Sn, and V is selected from P or As, wherein the single nonlinear optical crystal has a chalcopyrite and non-centrosymmetric crystal structure, with a space group of, wherein the non-centrosymmetric crystal structure is defined by unit cell parameters: a between about 5.5 to about 6 Å, c between about 9.5 to about 12.5 Å, and a unit cell volume of about 287 to about 450 Å³, wherein the single nonlinear optical crystal exhibits a refractive index of about 2.770 to about 2.780 and from about 2.800 to about 2.810 for no and ne respectively at a wavelength of 1,550 nm, and a nonlinear coefficient of d_{eff} of SHG from about 80 to about 95 pm/V, wherein the single crystal Mg—IV—V₂ is substantially free of impurities.
Example 2. The single nonlinear optical crystal of any examples herein, particularly example 1, wherein the single nonlinear optical crystal is MgSiP₂.
Example 3. The single nonlinear optical crystal of any examples herein, particularly example 1 or 2, exhibiting a transmittance from about 60% to less than 100% in a wavelength range from about 0.55 to about at least 20 μm.
Example 4. The single nonlinear optical crystal of any examples herein, particularly examples 1-3, wherein a d₁₄ coefficient is from about 80 pm/V to about 95 pm/V at a fundamental wavelength of 1,550 nm.
Example 5. The single nonlinear optical crystal of any examples herein, particularly examples 1-4, wherein a d₃₆ coefficient is from about 80 pm/V to about 95 pm/V at a fundamental wavelength of 1,550 nm.
Example 6. The single nonlinear optical crystal of any examples herein, particularly examples 1-5, exhibiting type I and type II phase matching, wherein |d_{eff,I}| at φ=0° is greater than about 75 pm/V to about 90 pm/V and |d_{eff,II}|=at ω=45° is greater than about 70 pm/V to about 80 pm/V at a fundamental wavelength of 3.5 μm.
Example 7. The single nonlinear optical crystal of any examples herein, particularly examples 1-6, wherein the single crystal Mg—IV—V₂ is uniaxial.
Example 8. The single nonlinear optical crystal of any examples herein, particularly examples 1-7, wherein the single crystal of Mg—IV—V₂ exhibits a substantially single phase.
Example 9. A method of forming the single nonlinear optical crystal of any one of clauses 1-8, wherein the method comprises: (a) providing a solution comprising a solute comprising a mixture of Mg, IV and V in a molar ratio from about 0.95:0.95:2 to about 1.05:1.05:2 and a solvent; wherein a mass ratio between the solvent and solute is from about 10:1 to about 4:1; (b) growing a crystalline composition comprising Mg—IV—V₂ at a first temperature from about 950° C. to about 1,200° C. for a first predetermined time; and (c) centrifugally separating the solvent to form a single crystal of Mg—IV—V₂ having a size from about 0.1 mm to about 10 mm in length, wherein the single crystal is substantially free of a solvent residue.
Example 10. The method of any examples herein, particularly example 9, wherein before step c) the crystalline composition is cooled to a temperature of about 640° C. to about 1,000° C. at a rate from about 0.5° C./h to about 35° C./h.
Example 11. The method any examples herein, particularly examples 9 or 10, wherein the step of centrifugally separating is performed at a second temperature and a speed of about 1,300 to about 1,500 rpm for a second predetermined time of about 1 min to about 15 min.
Example 12. The method of any examples herein, particularly examples 9-11, wherein the solvent comprises Sb, Sn, or a combination thereof.
Example 13. The method of any examples herein, particularly examples 9-12, wherein the solution is formed by mixing Mg, IV, V, and the solvent provided in a powdered form and heating to a temperature sufficient to homogeneously mix the solute and solvent.
Example 14. The method of any examples herein, particularly examples 9-13, wherein the single crystal Mg—IV—V₂ grows along [111] direction.
Example 15. A method of forming the single nonlinear optical crystal of any examples herein, particularly examples 1-8, wherein the method comprises: (a) sealing a polycrystalline material, comprising a Mg—IV—V₂ compound in a temperature-resistant container; (b) placing the temperature-resistant container in a rocking furnace; (c) heating the polycrystalline material to a third temperature at a rate of about 45° C./h to about 120° C./h and keeping the polycrystalline material at a third temperature for a third predetermined time; (d) placing the temperature-resistant container in a three-zone furnace, wherein the three-zone furnace exhibits a temperature profile defined by an upper/melt zone temperature, a middle/crystallization zone temperature; and a lower/annealing zone temperature; (e) translating the temperature-resistant container vertically or horizontally, thereby allowing the temperature-resistant container to arrive at a nucleating temperature to form a seeding crystal; (f) growing an ingot material from the seeding crystal; (g) annealing the ingot material at a temperature of about 700° C. to about 850° C. for a fourth predetermined time; and (h) forming the single nonlinear optical crystal Mg—IV—V₂, wherein the single nonlinear optical crystal is substantially free of impurities, defined by a single phase and has a size from about 0.1 mm to about 10 cm in length.
Example 16. The method of any examples herein, particularly example 15, wherein the polycrystalline material is ground prior to the step of sealing and wherein grinding is performed in an inert atmosphere.
Example 17. The method of any examples herein, particularly example 15 or 16, wherein the polycrystalline material is rocked within the rocking furnace at the third temperature to form a homogeneous mixture.
Example 18. The method of any examples herein, particularly examples 15-17, further comprising dwelling the polycrystalline material at the upper/melt zone temperature, the middle/crystallization zone temperature, and the lower/annealing zone temperature for a fifth predetermined time.
Example 19. The method of any examples herein, particularly examples 15-18, wherein prior to the annealing step, the upper/melt zone temperature, the middle/crystallization zone temperature, and the lower/annealing zone temperature are reduced to a fourth temperature at a first predetermined cooling rate.
Example 20. The method of any examples herein, particularly examples 15-19, wherein the polycrystalline material is cooled after annealing to a room temperature at a second predetermined cooling rate.
Example 21. The method of any examples herein, particularly examples 15-20, wherein the polycrystalline material comprising the Mg—IV—V₂ compound is formed by the steps comprising: (a) mixing Mg, IV, and V in a molar ratio of about 0.95:0.95:2 to about 1.05:1.05:2 to form a mixture; (b) placing the mixture into a sealed container in a furnace; (c) bringing the mixture to a first heating temperature of about 450° C. to about 550° C. at a rate of about 1° C./h to 55° C./h and keeping the mixture at the first heating temperature for about 60 to about 100 hours; (d) bringing the mixture to a second heating temperature of about 780° C. to about 850° C. at a rate of about 1° C./h to about 40° C./h and keeping the mixture at the second heating temperature for about 50 to about 100 hours; (e) bringing the mixture to a third heating temperature of about 1,100° C. to about 1,250° C. at a rate of about 20° C./h to about 40° C./h and keeping the mixture at the third heating temperature for about 50 to about 100 hours; (f) cooling the mixture to a room temperature at a rate of about 50° C./h to about 150° C./h; (g) recovering the polycrystalline material comprising Mg—IV—V₂, and wherein the polycrystalline material is substantially free of impurities and has a substantially single phase.
Example 22. An optical parametric oscillator comprising the single nonlinear optical crystal of any examples herein, particularly examples 1-8.
Example 23. The optical parametric oscillator of any examples herein, particularly example 22, further comprising a pump laser source having a pump beam in a range of about 1.1 to about 4 micrometers.
Example 24. The optical parametric oscillator of any examples herein, particularly example 23, wherein the pump laser source is a liquid laser, gas laser, or semiconductor laser.
Example 25. The optical parametric oscillator of any examples herein, particularly example 23 or 24, wherein the pump laser source is a pulse laser or a continuous laser.
Example 26. The optical parametric oscillator of any examples herein, particularly examples 22-25, further comprises an optical resonator comprising a plurality of mirrors.
Example 27. A laser comprising the single nonlinear optical crystal of any examples herein, particularly examples 1-8.
Example 28. A method of forming the single nonlinear optical crystal of any examples herein, particularly examples 1-8, wherein the method comprises: a) providing a solution comprising a solute comprising a mixture of Mg, IV and V in a molar ratio from about 0.95:0.95:2 to about 1.05:1.05:2 and a solvent; wherein a mass ratio between the solvent and solute is from about 10:1 to about 4:1; b) sealing the solution in a temperature-resistant container; c) placing the temperature-resistant container in a three-zone furnace, wherein the three-zone furnace exhibits a temperature profile defined by an upper/melt zone temperature, a middle/crystallization zone temperature; and a lower/annealing zone temperature; d) translating the temperature-resistant container vertically, thereby allowing the temperature-resistant container to arrive at a nucleating temperature to form a seeding crystal; e) growing an ingot material from the seeding crystal; and f) forming the single nonlinear optical crystal Mg—IV—V₂, wherein the single nonlinear optical crystal is substantially free of impurities, defined by a single phase and has a size from about 0.1 mm to about 10 cm in length.
Example 29. The method of any examples herein, particularly example 28, wherein the solvent comprises Sb, Sn or a combination thereof.
Example 30. The method of any examples herein, particularly example 28 or 29, wherein the upper/melt-zone temperature is from about 1,000° C. to about 1,200° C.
Example 31. The method of any examples herein, particularly examples 28-30, wherein the temperature profile is achieved with the required gradient temperature of about 10° C. to about 30° C.
Example 32. The method of any examples herein, particularly examples 28-31, wherein the temperature-resistant container is in each of the upper/melt zone, the middle/crystallization zone, and the lower/annealing zone for a predetermined time.
Example 33. The method of any examples herein, particularly examples 28-32, wherein the temperature-resistant container is vertically translated at a rate of from about 0.1 mm/h to about 1.0 mm/h.

### REFERENCES

1. Pushkarsky, M.; et al. Sub-Parts-per-Billion Level Detection of NO2 Using Room-Temperature Quantum Cascade Lasers. Proc. Natl. Acad. Sci. 2006, 103 (29), 10846-10849. Pushkarsky, M. B. et al. High-Sensitivity Detection of TNT. Proc. Natl. Acad. Sci. U.S.A. 2006, 103 (52), 19630-19634.
2. Jean, B.; Bende, T. Mid-IR Laser Applications in Medicine BT-Solid-State Mid-Infrared Laser Sources; Sorokina, I. T., Vodopyanov, K. L., Eds.; Springer Berlin Heidelberg: Berlin, Heidelberg, 2003; pp 530-565.
3. Chen, C. T.; et al. The Optical Properties and Growth of a New Type Ultraviolet SHG Crystal β-BaB₂O₄. Sci. Sin. B (Englisch Ed. 1984, 7, 595).
4. HAUSSÜHL, S. Elastische Und Thermoelastische Eigenschaften von KH₂PO₄, KH₂ASO₄, NH₄H₂PO₄, NH₄H₂AsO₄ Und RbH₂PO₄. Zeitschrift für Krist. Mater. 1964, 120 (1-6), 401-414.
5. Boyd, G. D.; et al. LiNbO₃: An Efficient Phase Matchable Nonlinear Optical Material. Appl. Phys. Lett. 1964, 5 (11), 234-236.
6. Ohmer, M. C.; Pandey, R. Emergence of Chalcopyrites as Nonlinear Optical Materials. MRS Bull. 1998, 23 (7), 16-22.
7. Schunemann, P. G.; et al. Nonlinear Frequency Conversion Performance of AgGaSe₂, ZnGeP₂, and CdGeAs₂. MRS Bull. 1998, 23 (7), 45-49.
8. Nikogosyan, D. N. Nonlinear Optical Crystals: A Complete Survey; Springer Science & Business Media, 2006.
9. Liang, F.; et al. Mid-Infrared Nonlinear Optical Materials Based on Metal Chalcogenides: Structure-Property Relationship. Cryst. Growth Des. 2017, 17 (4), 2254-2289.
10. Kang, L.; et al. Metal Thiophosphates with Good Mid-Infrared Nonlinear Optical Performances: A First-Principles Prediction and Analysis. J. Am. Chem. Soc. 2015, 137 (40), 13049-13059.
11. Chen, J.; et al. Mg₂In₃Si₂P₇: A Quaternary Diamond-like Phosphide Infrared Nonlinear Optical Material Derived from ZnGeP₂. J. Am. Chem. Soc. 2021, 143 (27), 10309-10316.
12. Li, M.-Y.; et al. HgCuPS₄: An Exceptional Infrared Nonlinear Optical Material with Defect Diamond-like Structure. Chem. Mater. 2020, 32 (10), 4331-4339.
13. Li, X.; et al. Li₂MnSnSe₄: A New Quaternary Diamond-Like Semiconductor with Nonlinear Optical Response and Antiferromagnetic Property. Chem.—An Asian J. 2017, 12 (24), 3172-3177.
14. Trykozko, R. T. On the Ternary Compound MgSiP₂ Grown from Antimony Solution. Mater. Res. Bull. 1975, 10 (6), 489-492.
15. Xiao, J.; et al. Computational Assessment of Promising Mid-Infrared Nonlinear Optical Materials Mg—IV—V₂ (IV=Si, Ge, Sn; V=P, As): A First-Principles Study. Mater. Res. Express 2018, 5 (3).
16. Springthorpe, A. J.; Harrison, J. G. MgSiP₂: A New Member of the II IV V2 Family of Semiconducting Compounds. Nature 1969, 222 (5197), 977.
17. Jaffe, J. E.; Zunger, A. Electronic Structure of the Ternary Chalcopyrite Semiconductors CuAlS₂, CuGaS₂, CuInS₂, CuAlSe₂, CuGaSe₂, and CuInSe2. Phys. Rev. B 1983, 28 (10), 5822.
18. Kleinman, D. A. Nonlinear Dielectric Polarization in Optical Media. Phys. Rev. 1962, 126 (6), 1977-1979.
19. Miller, R. C. OPTICAL SECOND HARMONIC GENERATION IN PIEZOELECTRIC CRYSTALS. Appl. Phys. Lett. 1964, 5 (1), 17-19.
20. Zhang, G.; et al. Vertical Bridgman Growth and Optical Properties of CdSiP2 Crystals. CrystEngComm 2013, 15 (21), 4255-4260.
21. P. A. Franken, et al., “Generation of Optical HarmonicsF,” Phys. Rev. Lett., vol. 7, no. 4, pp. 118-119, August 1961, doi: 10.1103/PhysRevLett.7.118.
22. J. A. Armstrong, et al., “Interactions between Light Waves in a Nonlinear Dielectric,” Phys. Rev., vol. 127, no. 6, pp. 1918-1939 September 1962, doi: 10.1103/PhysRev.127.1918.
23. N. Picqué and T. W. Hänsch, “Mid-IR spectroscopic sensing,” Opt. Photononics News, no. June, pp. 26-33, 2019.
24. H. Kaushal and G. Kaddoum, “Optical Communication in Space: Challenges and Mitigation Techniques,” IEEE Commun. Surv. Tutorials, vol. 19, no. 1, pp. 57-96, 2017, doi: 10.1109/COMST.2016.2603518.
25. G. L. Mansell et al., “Observation of Squeezed Light in the 2 mm Region,” Phys. Rev. Lett., vol. 120, no. 20, p. 203603, May 2018, doi: 10.1103/PhysRevLett.120.203603.
26. J. A. Fülöp, et al., “Laser-Driven Strong-Field Terahertz Sources,” Adv. Opt. Mater., vol. 8, no. 3, pp. 1-25, 2020, doi: 10.1002/adom.201900681.
27. F. Blanchard, et al., “Real-Time, Subwavelength Terahertz Imaging,” Annu. Rev. Mater. Res., vol. 43, no. 1, pp. 237-259, July 2013, doi: 10.1146/annurev-matsci-071312-121656.
28. H. J. Kimble, “The quantum internet,” Nature, vol. 453, no. 7198, pp. 1023-130 June 2008, doi: 10.1038/nature07127.
29. R. Wang, et al., “Data-driven prediction of diamond-like infrared nonlinear optical crystals with targeting performances,” Sci. Rep., vol. 10, no. 1, p. 3486 December 2020, doi: 10.1038/s41598-020-60410-x.
30. F. Liang, et al., “Mid-Infrared Nonlinear Optical Materials Based on Metal Chalcogenides: Structure-Property Relationship,” Cryst. Growth Des., vol. 17, no. 4, pp. 2254-2289 April 2017, doi: 10.1021/acs.cgd.7b00214.
31. L. Kang, et al., “First-Principles Design and Simulations Promote the Development of Nonlinear Optical Crystals,” Acc. Chem. Res., vol. 53, no. 1, pp. 209-217, 2020, doi: 10.1021/acs.accounts.9b00448.
32. I. Chung and M. G. Kanatzidis, “Metal Chalcogenides: A Rich Source of Nonlinear Optical Materials,” Chem. Mater., vol. 26, no. 1, pp. 849-869, January 2014, doi: 10.1021/cm401737s.
33. P. S. Halasyamani and K. R. Poeppelmeier, “Noncentrosymmetric Oxides,” Chem. Mater., vol. 10, no. 10, pp. 2753-2769 October 1998, doi: 10.1021/cm980140w.
34. P. S. Halasyamani and W. Zhang, “Viewpoint: Inorganic Materials for UV and Deep-UV Nonlinear-Optical Applications,” Inorg. Chem., vol. 56, no. 20, pp. 12077-12085, October 2017, doi: 10.1021/acs.inorgchem.7b02184.
35. M. C. Ohmer and R. Pandey, “Emergence of Chalcopyrites as Nonlinear Optical Materials,” MRS Bull., vol. 23, no. 7, pp. 16-22, July 1998, doi: 10.1557/S0883769400029031.
36. X. Luo, et al., “Recent progress on new infrared nonlinear optical materials with application prospect,” J. Solid State Chem., vol. 270, no. December 2018, pp. 674-687, 2019, doi: 10.1016/j.jssc.2018.12.036.
37. Z. Yang and S. Pan, “Computationally assisted multistage design and prediction driving the discovery of deep-ultraviolet nonlinear optical materials,” Mater. Chem. Front., vol. 5, no. 9, pp. 3507-3523, 2021, doi: 10.1039/D0QM01109F.
38. L. Kang, et al., “Metal Thiophosphates with Good Mid-infrared Nonlinear Optical Performances: A First-Principles Prediction and Analysis,” J. Am. Chem. Soc., vol. 137, no. 40, pp. 13049-13059, October 2015, doi: 10.1021/jacs.5b07920.
39. D. E. Chang, et al., “Quantum nonlinear optics-Photon by photon,” Nat. Photonics, vol. 8, no. 9, pp. 685-694, 2014, doi: 10.1038/nphoton.2014.192.
40. P. Lodahl, et al., “Interfacing single photons and single quantum dots with photonic nanostructures,” Rev. Mod. Phys., vol. 87, no. 2, pp. 347-400, May 2015, doi: 10.1103/RevModPhys.87.347.
41. A. Reiserer and G. Rempe, “Cavity-based quantum networks with single atoms and optical photons,” Rev. Mod. Phys., vol. 87, no. 4, pp. 1379-1418 December 2015, doi: 10.1103/RevModPhys.87.1379.
42. R. W. Boyd and B. R. Masters, Nonlinear Optics, 4th edition. New York: Academic Press, 2008.
43. P. G. Schunemann, et al., “Advances in nonlinear optical crystals for mid-infrared coherent sources,” J. Opt. Soc. Am. B, vol. 33, no. 11, p. D36, 2016, doi: 10.1364/josab.33.000d36.
44. M. C. Ohmer and R. Pandey, “Emergence of Chalcopyrites as Nonlinear Optical Materials,” MRS Bull., vol. 23, no. 7, pp. 16-22, July 1998, doi: 10.1557/S0883769400029031.
45. A. S. Solntsev and A. A. Sukhorukov, “Path-entangled photon sources on nonlinear chips,” Rev. Phys., vol. 2, pp. 19-31, 2017, doi: 10.1016/j.revip.2016.11.003.
46. S. Prabhakar et al., “Two-photon quantum interference and entanglement at 2.1 μm,” Sci. Adv., vol. 6, no. 13, p. eaay5195, March 2020, doi: 10.1126/sciadv.aay5195.
47. M. Mancinelli et al., “Mid-infrared coincidence measurements on twin photons at room temperature,” Nat. Commun., vol. 8, no. May 2017, doi: 10.1038/ncomms15184.
48. Y. Chu, et al., “A review on the development of infrared nonlinear optical materials with triangular anionic groups,” J. Solid State Chem., vol. 271, no. August 2018, pp. 266-272, 2019, doi: 10.1016/j.jssc.2018.10.051.
49. S. A. Denev, et al., “Probing Ferroelectrics Using Optical Second Harmonic Generation,” J. Am. Ceram. Soc., vol. 94, no. 9, pp. 2699-2727 September 2011, doi: 10.1111/j.1551-2916.2011.04740.x.
50. J. He et al., “Giant Non-Resonant Infrared Second Order Nonlinearity in γ-NaAsSe₂,” Adv. Opt. Mater., p. 2101729, November 2021, doi: 10.1002/adom.202101729.
51. J. Hayden et al., “Ferroelectricity in boron-substituted aluminum nitride thin films,” Phys. Rev. Mater., vol. 5, no. 4, p. 044412, April 2021, doi: 10.1103/PhysRevMaterials.5.044412.
52. K. Ferri et al., “Ferroelectrics everywhere: Ferroelectricity in magnesium substituted zinc oxide thin films,” J. Appl. Phys., vol. 130, no. 4, p. 044101, July 2021, doi: 10.1063/5.0053755.
53. J. Xiao, et al., “Computational assessment of promising mid-infrared nonlinear optical materials Mg—IV—V₂ (IV=Si, Ge, Sn; V=P, As): a first-principles study,” Mater. Res. Express, vol. 5, no. 3, p. 035907, March 2018, doi: 10.1088/2053-1591/aab5f4.
54. A. J. Springthorpe and J. G. Harrison, “MgSiP₂: A New Member of the II IV V₂ Family of Semiconducting Compounds,” Nature, vol. 222, no. 5197, p. 977, 1969, doi: 10.1038/222977a0.
55. F. Liang, et al., “Analysis and prediction of mid-IR nonlinear optical metal sulfides with diamond-like structures,” Coord. Chem. Rev., vol. 333, pp. 57-70, February 2017, doi: 10.1016/j.ccr.2016.11.012.
56. M.-C. Chen, et al., “Disconnection Enhances the Second Harmonic Generation Response: Synthesis and Characterization of Ba₂₃Ga₈Sb₂S₃₈,” J. Am. Chem. Soc., vol. 134, no. 14, pp. 6058-660 April 2012, doi: 10.1021/ja300249n.
57. Y. Kim et al., “Characterization of New Infrared Nonlinear Optical Material with High Laser Damage Threshold, Li₂Ga₂GeS₆,” Chem. Mater., vol. 20, no. 19, pp. 6048-652 October 2008, doi: 10.1021/cm8007304.
58. H. Lin, et al., “Functionalization Based on the Substitutional Flexibility: Strong Middle IR Nonlinear Optical Selenides AX^{II}₄X^{III}₅Se₁₂,” J. Am. Chem. Soc., vol. 135, no. 34, pp. 12914-12921, August 2013, doi: 10.1021/ja4074084.
59. L. I. Isaenko, et al., “Structure and optical properties of Li₂Ga₂GeS₆ nonlinear crystal,” Opt. Mater. (Amst)., vol. 47, pp. 413-419, September 2015, doi: 10.1016/j.optmat.2015.06.014.
60. L. Gao, et al., “Structure-property survey and computer-assisted screening of mid-infrared nonlinear optical chalcohalides,” Coord. Chem. Rev., vol. 421, p. 213379, October 2020, doi: 10.1016/j.ccr.2020.213379.
61. W. Zhang, et al., “Phase-Matching in Nonlinear Optical Compounds: A Materials Perspective,” Chem. Mater., vol. 29, no. 7, pp. 2655-2668 April 2017, doi: 10.1021/acs.chemmater.7b00243.
62. D. S. Hum and M. M. Fejer, “Quasi-phasematching,” Comptes Rendus Phys., vol. 8, no. 2, pp. 180-198, March 2007, doi: 10.1016/j.crhy.2006.10.022.
63. M. V. Hobden, “Phase-Matched Second-Harmonic Generation in Biaxial Crystals,” J. Appl. Phys., vol. 38, no. 11, pp. 4365-4372 October 1967, doi: 10.1063/1.1709130.
64. C. L. Tang, et al., “Optical parametric oscillators,” Proc. IEEE, vol. 80, no. 3, pp. 365-374, March 1992, doi: 10.1109/5.135353.
65. T. T. A. Lummen et al., “Thermotropic phase boundaries in classic ferroelectrics,” Nat. Commun., vol. 5, no. 1, p. 3172 May 2014, doi: 10.1038/ncomms4172.
66. J. A. Giacometti and O. N. Oliveira, “Corona charging of polymers,” IEEE Trans. Electr. Insul., vol. 27, no. 5, pp. 924-943, 1992, doi: 10.1109/14.256470.
67. V. Gopalan, et al., “Defect-Domain Wall Interactions in Trigonal Ferroelectrics,” Annu. Rev. Mater. Res., vol. 37, no. 1, pp. 449-489, August 2007, doi: 10.1146/annurev.matsci.37.052506.084247.
68. K. T. Gahagan, et al., “Integrated high-power electro-optic lens and large-angle deflector,” Appl. Opt., vol. 40, no. 31, p. 5638 November 2001, doi: 10.1364/AO.40.005638.
69. Y. Chiu, et al., “Integrated Optical Device with Second-Harmonic Generator, Electrooptic Lens, and Electrooptic Scanner in LiTaO₃,” J. Light. Technol., vol. 17, p. 462, 1999.
70. K. J. Vahala, “Optical microcavities,” Nature, vol. 424, no. 6950, pp. 839-846, August 2003, doi: 10.1038/nature01939.
71. R. Luo, et al., “Optical Parametric Generation in a Lithium Niobate Microring with Modal Phase Matching,” Phys. Rev. Appl., vol. 11, no. 3, p. 034026, March 2019, doi: 10.1103/PhysRevApplied.11.034026.
72. B. K. Vanleeuwen, et al., “The affine and Euclidean normalizers of the subperiodic groups,” Acta Crystallogr. Sect. A Found. Adv., vol. 71, pp. 150-160, 2015, doi: 10.1107/S2053273314024395.
73. H. Padmanabhan, et al., “Antisymmetry: Fundamentals and Applications,” Annu. Rev. Mater. Res., vol. 50, no. 1, pp. 255-281, July 2020, doi: 10.1146/annurev-matsci-100219-101404.
74. B. K. Vanleeuwen and V. Gopalan, “The antisymmetry of distortions,” Nat. Commun., vol. 6, pp. 1-10, 2015, doi: 10.1038/ncomms9818.
75. J. M. Munro, et al., “Implementation of distortion symmetry for the nudged elastic band method with DiSPy,” npj Comput. Mater., vol. 5, no. 1, p. 52, 2019, doi: 10.1038/s41524-019-0188-x.
76. J. M. Munro et al., “Discovering minimum energy pathways via distortion symmetry groups,” Phys. Rev. B, vol. 98, no. 8, pp. 1-11, 2018, doi: 10.1103/PhysRevB.98.085107.
77. V. Gopalan, “Wedge Reversion Antisymmetry and 41 Types of Multivectors,” 2019.
78. V. Gopalan, “Relativistic Spacetime Crystals,” 2020.
79. M. Bojowald and A. Saxena, “From crystal color symmetry to quantum spacetime,” Acta Crystallogr. Sect. A Found. Adv., vol. 77, no. 4, July 2021, doi: 10.1107/S2053273321005234.
80. H. Akamatsu et al., “A-site cation size effect on oxygen octahedral rotations in acentric Ruddlesden-Popper alkali rare-earth titanates,” Phys. Rev. Mater., vol. 3, no. 6, p. 065001, June 2019, doi: 10.1103/PhysRevMaterials.3.065001.
81. D. Akbarian et al., “Understanding the influence of defects and surface chemistry on ferroelectric switching: a ReaxFF investigation of BaTiO₃,” Phys. Chem. Chem. Phys., vol. 21, no. 33, pp. 18240-18249, 2019, doi: 10.1039/C9CP02955A.
82. Q. Qian et al., “Chirality-Dependent Second Harmonic Generation of MoS₂ Nanoscroll with Enhanced Efficiency,” ACS Nano, vol. 14, no. 10, pp. 13333-13342, October 2020, doi: 10.1021/acsnano.0c05189.
83. I. Chae et al., “Shear-induced unidirectional deposition of bacterial cellulose microfibrils using rising bubble stream cultivation,” Carbohydr. Polym., vol. 255, p. 117328, March 2021, doi: 10.1016/j.carbpol.2020.117328.
84. I. Chae et al., “Electric Field-Induced Polarization Responses of Noncentrosymmetric Crystalline Biopolymers in Different Frequency Regimes—A Case Study on Unidirectionally Aligned β-Chitin Crystals,” Biomacromolecules, vol. 22, no. 5, pp. 1901-1909 May 2021, doi: 10.1021/acs.biomac.0c01799.
85. J. F. Khoury et al., “Ir₆In₃₂S₂₁, a polar, metal-rich semiconducting subchalcogenide,” Chem. Sci., vol. 11, no. 3, pp. 870-878, 2020, doi: 10.1039/C9SC05609B.
86. H. L. Feng et al., “High-Pressure Synthesis and Ferrimagnetism of Ni₃TeO₆-Type Mn₂ScMO₆ (M=Nb, Ta),” Inorg. Chem., vol. 58, no. 23, pp. 15953-15961, December 2019, doi: 10.1021/acs.inorgchem.9b02468.
87. S. Yoshida et al., “Hybrid Improper Ferroelectricity in (Sr, Ca)₃Sn₂O₇ and Beyond: Universal Relationship between Ferroelectric Transition Temperature and Tolerance Factor in n=2 Ruddlesden-Popper Phases,” J. Am. Chem. Soc., vol. 140, no. 46, pp. 15690-15700, November 2018, doi: 10.1021/jacs.8b07998.
88. M. O. Ramirez et al., “Emergent room temperature polar phase in CaTiO₃ nanoparticles and single crystals,” APL Mater., vol. 7, no. 1, p. 011103, January 2019, doi: 10.1063/1.5078706.
89. S. Li and T. Birol, “Suppressing the ferroelectric switching barrier in hybrid improper ferroelectrics,” npj Comput. Mater., vol. 6, no. 1, p. 168, December 2020, doi: 10.1038/s41524-020-00436-x.
90. V. S. Liu et al., “Spatio-temporal symmetry—crystallographic point groups with time translations and time inversion,” Acta Crystallogr. Sect. A Found. Adv., vol. 74, no. 4, pp. 399-402, July 2018, doi: 10.1107/S2053273318004667.
91. J. M. Munro, et al., “Implementation of distortion symmetry for the nudged elastic band method with DiSPy,” npj Comput. Mater., vol. 5, no. 1, p. 52, 2019, doi: 10.1038/s41524-019-0188-x.
92. Y. Park et al., “SrNbO₃ as a transparent conductor in the visible and ultraviolet spectra,” Commun. Phys., vol. 3, no. 1, p. 102, December 2020, doi: 10.1038/s42005-020-0372-9.
93. D. Abhat, “From Theory to Application: How the DMREF Program Helps Accelerate Advanced Materials Research,” 2021.
94. R. T. Trykozko, Materials Research Bulletin 10, 489 (1975).
95. F. Liang, et al., Cryst. Growth Des. 2017, 17, 2254.
96. B. M. Oxley, et al., J. Am. Chem. Soc. 2022, DOI 10.1021/jacs.2c05447.
97. J. He, et al., Adv. Opt. Mater. 2022, 10, 2101729.
98. I. Chung, et al., Chem. Mater. 2014, 26, 849.
99. J. He, et al., ACS Photonics 2022, 9, 1724.
100. A. K. Iyer, et al., Adv. Funct. Mater. 2022, n/a, 2211969.
101. C. T. Chen, et al., Sci. Sin. B (Englisch Ed. 1984, 7, 595.
102. G. D. Boyd, et al., Appl. Phys. Lett. 1964, 5, 234.
103. C. Chen, et al., J. Opt. Soc. Am. B 1989, 6, 616.
104. M. C. Ohmer, R. Pandey, MRS Bull. 1998, 23, 16.
105. P. G. Schunemann, et al., MRS Bull. 1998, 23, 45.
106. H. J. Krause, W. Daum, Appl. Phys. B Photophysics Laser Chem. 1993, 56, 8.
107. Y. Kim, et al., Chem. Mater. 2008, 20, 6048.
108. U. Simon, et al., Appl. Opt. 1993, 32, 6650.
109. V. Petrov, et al., Opt. Lett. 1999, 24, 414.
110. D. N. Nikogosyan, Nonlinear Optical Crystals: A Complete Survey, Springer Science & Business Media, 2006.
111. K. T. Zawilski, et al., J. Cryst. Growth 2010, 312, 1127.
112. R. L. Byer, et al., Appl. Phys. Lett. 1971, 19, 237.
113. K. E. Woo, et al., Adv. Funct. Mater. 2018, 28.
114. J. Xiao, et al., Mater. Res. Express 2018, 5, DOI 10.1088/2053-1591/aab5f4.
115. A. Petukhov, et al., Phys. Rev. B 1994, 49, 4549.
116. B. Kocak, et al., J. Electron. Mater. 2017, 46, 247.
117. J. Chen, et al., Adv. Sci. 2022, 9, 1.
118. G. C. Catella, D. Burlage, MRS Bull. 1998, 23, 28.
119. J. Wei, et al., Opt. InfoBase Conf. Pap. 2017, Part F54-N, 235.
120. A. J. Springthorpe, J. G. Harrison, Nature 1969, 222, 977.
121. R. T. Trykozko, Mater. Res. Bull. 1975, 10, 489.
122. A. E. Kokh, et al., Laser Mater. Cryst. Growth Nonlinear Mater. Devices 1999, 3610, 139.
123. J. E. Jaffe, A. Zunger, Phys. Rev. B 1984, 29, 1882.
124. V. L. Shaposhnikov, et al., Phys. Rev. B 2012, 85, 205201.
125. G. Ambrazevičius, et al., Phys. status solidi 1981, 106, 85.
126. G. C. Bhar, R. C. Smith, Phys. Status Solidi 1972, 13, 157.
127. B. Ray, et al., Phys. status solidi 1969, 35, 197.
128. F. Urbach, Phys. Rev. 1953, 92, 1324.
129. N. Itoh, et al., Jpn. J. Appl. Phys. 1978, 17, DOI 10.1143/JJAP.17.951.
130. R. Zu, et al., npj Comput. Mater. 2022, 8, 246.
131. D. A. Kleinman, Phys. Rev. 1962, 126, 1977.
132. G. Boyd, et al., IEEE J. Quantum Electron. 1972, 8, 900.
133. R. C. Miller, Appl. Phys. Lett. 1964, 5, 17.
134. J. E. Sipe, E. Ghahramani, Phys. Rev. B 1993, 48, 11705.
135. J. E. Sipe, E. Ghahramani, Phys. Rev. B 1993, 48, 11705.
136. S. Sharma, et al., Phys. Rev. B 2003, 67, 165332.
137. V. N. Genkin, P. M. Mednis, Sov. Phys. JETP 1968, 27, 609.
138. J. L. P. Hughes, J. E. Sipe, Phys. Rev. B 1996, 53, 10751.
139. W. R. L. Lambrecht, S. N. Rashkeev, Phys. status solidi 2000, 217, 599.
140. M.-H. Lee, et al., Phys. Rev. B 2004, 70, 235110.
141. W. Zhang, et al., Chem. Mater. 2017, 29, 2655.
142. X. Gonze, et al., Comput. Phys. Commun. 2016, 205, 106.
143. X. Gonze, et al., Comput. Phys. Commun. 2020, 248, 107042.
144. A. H. Romero, et al., J. Chem. Phys. 2020, 152, 124102.
145. X. Gonze, C. Lee, Phys. Rev. B 1997, 55, 10355.
146. D. R. Hamann, Phys. Rev. B 2013, 88, 85117.
147. M. J. van Setten, et al., Comput. Phys. Commun. 2018, 226, 39.
148. J. P. Perdew, Y. Wang, Phys. Rev. B 1992, 45, 13244.
149. J. P. Perdew, et al., Phys. Rev. Lett. 1996, 77, 3865.
150. H. J. Monkhorst, J. D. Pack, Phys. Rev. B 1976, 13, 5188.
151. J. D. Pack, H. J. Monkhorst, Phys. Rev. B 1977, 16, 1748.
152. R. T. Trykozko, Mater. Res. Bull. 1975, 10, 489.
153. R. Zu, et al., npj Comput. Mater. 2022, 8, 246.
154. J. D. Beasley, Appl. Opt. 1994, 33, 1000.
155. K. T. Zawilski, et al., J. Cryst. Growth 2010, 312, 1127.
156. Y. Guo, et al., J. Cryst. Growth 2012, 346, 1.

1. A single nonlinear optical crystal having a chemical formula of Mg—IV—V₂, wherein IV is selected from Si, Ge, or Sn, and V is selected from P or As, wherein the single nonlinear optical crystal has a chalcopyrite and non-centrosymmetric crystal structure, with a space group of 14̅2d, wherein the non-centrosymmetric crystal structure is defined by unit cell parameters: a between about 5.5 to about 6 Å, c between about 9.5 to about 12.5 Å, and a unit cell volume of about 287 to about 450 Å³, wherein the single nonlinear optical crystal exhibits a refractive index of about 2.770 to about 2.780 and from about 2.800 to about 2.810 for nₒ and nₑ respectively at a wavelength of 1,550 nm, and a nonlinear coefficient of d_{eff} of SHG from about 80 to about 95 pm/V, wherein the single crystal Mg—IV—V₂ is substantially free of impurities.

2. The single nonlinear optical crystal of claim 1, wherein the single nonlinear optical crystal is MgSiP₂.

3. The single nonlinear optical crystal of claim 1, exhibiting a transmittance from about 60% to less than 100% in a wavelength range from about 0.55 to about at least 20 μm.

4. The single nonlinear optical crystal of claim 1, wherein a d₁₄ coefficient is from about 80 pm/V to about 95 pm/V at a fundamental wavelength of 1,550 nm; and
wherein a d₃₆ coefficient is from about 80 pm/V to about 95 pm/V at a fundamental wavelength of 1,550 nm.

5. The single nonlinear optical crystal of claim 1, exhibiting type I and type II phase matching, wherein |d_{eff,I}| at φ=0° is greater than about 75 pm/V to about 90 pm/V and |d_{eff,II}| at φ=45° is greater than about 70 pm/V to about 80 pm/V at a fundamental wavelength of 3.5 μm.

6. The single nonlinear optical crystal of claim 1, wherein the single crystal Mg—IV-V₂ is uniaxial and/or exhibits a substantially single phase.

7. A method of forming the single nonlinear optical crystal of claim 1, wherein the method comprises:
a) providing a solution comprising a solute comprising a mixture of Mg, IV and V in a molar ratio from about 0.95:0.95:2 to about 1.05:1.05:2 and a solvent; wherein a mass ratio between the solvent and solute is from about 10:1 to about 4:1;
b) growing a crystalline composition comprising Mg—IV—V₂ at a first temperature from about 950° C. to about 1,200° C. for a first predetermined time; and
c) centrifugally separating the solvent to form a single crystal of Mg—IV—V₂ having a size from about 0.01 mm to about 10 mm in length, wherein the single crystal is substantially free of a solvent residue.

8. The method of claim 7, wherein before step c) the crystalline composition is cooled to a temperature of about 640° C. to about 1,000° C. at a rate from about 0.5° C./h to about 35° C./h.

9. The method of claim 7, wherein the solvent comprises Sb, Sn, or a combination thereof.

10. The method of claim 7, wherein the solution is formed by mixing Mg, IV, V, and the solvent provided in a powdered form and heating to a temperature sufficient to homogeneously mix the solute and the solvent.

11. The method of claim 7, wherein the single crystal Mg—IV—V₂ grows along [111] direction.

12. A method of forming the single nonlinear optical crystal of claim 1, wherein the method comprises:
a) sealing a polycrystalline material, comprising a Mg—IV—V₂ compound in a temperature-resistant container;
b) placing the temperature-resistant container in a rocking furnace;
c) heating the polycrystalline material to a third temperature at a rate of about 45° C./h to about 120° C./h and keeping the polycrystalline material at a third temperature for a third predetermined time;
d) placing the temperature-resistant container in a three-zone furnace, wherein the three-zone furnace exhibits a temperature profile defined by an upper/melt zone temperature, a middle/crystallization zone temperature; and a lower/annealing zone temperature;
e) translating the temperature-resistant container vertically or horizontally, thereby allowing the temperature-resistant container to arrive at a nucleating temperature to form a seeding crystal;
f) growing an ingot material from the seeding crystal;
g) annealing the ingot material at a temperature of about 700° C. to about 850° C. for a fourth predetermined time; and
h) forming the single nonlinear optical crystal Mg—IV—V₂, wherein the single nonlinear optical crystal is substantially free of impurities, defined by a single phase and has a size from about 0.1 mm to about 10 cm in length.

13. The method of claim 12, wherein prior to the annealing step, the upper/melt zone temperature, the middle/crystallization zone temperature, and the lower/annealing zone temperature are reduced to a fourth temperature at a first predetermined cooling rate; and
wherein the polycrystalline material is cooled after annealing to a room temperature at a second predetermined cooling rate.

14. The method of claim 12, wherein the polycrystalline material comprising the Mg—IV—V₂ compound is formed by the steps comprising:
a) mixing Mg, IV, and V in a molar ratio of about 0.95:0.95:2 to about 1.05:1.05:2 to form a mixture;
b) placing the mixture into a sealed container in a furnace;
c) bringing the mixture to a first heating temperature of about 450° C. to about 550° C. at a rate of about 1° C./h to 55° C./h and keeping the mixture at the first heating temperature for about 60 to about 100 hours;
d) bringing the mixture to a second heating temperature of about 780° C. to about 850° C. at a rate of about 1° C./h to about 40° C./h and keeping the mixture at the second heating temperature for about 50 to about 100 hours;
e) bringing the mixture to a third heating temperature of about 1,100° C. to about 1,250° C. at a rate of about 20° C./h to about 40° C./h and keeping the mixture at the third heating temperature for about 50 to about 100 hours;
f) cooling the mixture to a room temperature at a rate of about 50° C./h to about 150° C./h;
g) recovering the polycrystalline material comprising Mg—IV—V₂, and wherein the polycrystalline material is substantially free of impurities and has a substantially single phase.

15. An optical parametric oscillator comprising the single nonlinear optical crystal of claim 1.

16. A laser comprising the single nonlinear optical crystal of claim 1.

17. A method of forming the single nonlinear optical crystal of claim 1, wherein the method comprises:
a) providing a solution comprising a solute comprising a mixture of Mg, IV and V in a molar ratio from about 0.95:0.95:2 to about 1.05:1.05:2 and a solvent; wherein a mass ratio between the solvent and solute is from about 10:1 to about 4:1;
b) sealing the solution in a temperature-resistant container;
c) placing the temperature-resistant container in a three-zone furnace, wherein the three-zone furnace exhibits a temperature profile defined by an upper/melt zone temperature, a middle/crystallization zone temperature; and a lower/annealing zone temperature;
d) translating the temperature-resistant container vertically, thereby allowing the temperature-resistant container to arrive at a nucleating temperature to form a seeding crystal;
e) growing an ingot material from the seeding crystal; and
f) forming the single nonlinear optical crystal Mg—IV—V₂, wherein the single nonlinear optical crystal is substantially free of impurities, defined by a single phase and has a size from about 0.1 mm to about 10 cm in length.

18. The method of claim 17, wherein the solvent comprises Sb, Sn or a combination thereof.

19. The method of claim 17, wherein the upper/melt-zone temperature is from about 1,000° C. to about 1,200° C.; and
wherein the temperature profile is achieved with the required gradient temperature of about 10° C. to about 30° C.

20. The method of claim 17, wherein the temperature-resistant container is vertically translated at a rate of from about 0.1 mm/h to about 1.0 mm/h.
